(19) United States
(12) Patent Application Publication
(10) Pub. No.: US 2023/0409615 A1
(43) Pub. Date: Dec. 21, 2023

(54) Systems and Methods for Providing User Experiences on Smart Assistant Systems

(71) Applicant: Meta Platforms, Inc., Menlo Park, CA (US)

(72) Inventors: Piyush Khemka, New York, NY (US); Brandon Ramos, San Leandro, CA (US); Ryan Wolff, San Francisco, CA (US); Stephen Chee-Ching Wu, Redmond, WA (US); Ashley Gustafson, Surprise, AZ (US); Gabrielle Catherine Moskey, San Mateo, CA (US); Hyundong Cho, San Jose, CA (US); Andrea Madotto, San Francisco, CA (US); Zhaojiang Lin, Mountain View, CA (US); Satwik Kottur, Sunnyvale, CA (US); Chinnadhurai Sankar, Menlo Park, CA (US); Ashish Vishwanath Shenoy, Bothell, WA (US); Jiangning Chen, Lexington, MA (US); Rahim Manji, Redwood City, CA (US); Bing Liu, Sunnyvale, CA (US); Xin Liu, South San Francisco, CA (US); Ziyun Zhang, Pasadena, CA (US)

(21) Appl. No.: 18/334,235

(22) Filed: Jun. 13, 2023

Related U.S. Application Data
(60) Provisional application No. 63/352,768, filed on Jun. 16, 2022.
(60) Provisional application No. 63/380,993, filed on Oct. 26, 2022.
(60) Provisional application No. 63/493,291, filed on Mar. 30, 2023.
(60) Provisional application No. 63/496,283, filed on Apr. 14, 2023.
(60) Provisional application No. 63/498,192, filed on Apr. 25, 2023.

(51) Int. Cl. G06F 16/332; G06F 9/451; G06V 20/68; G10L 15/18

(52) U.S. Cl. CPC G06F 16/3329; G06F 9/451; G06V 20/68; G10L 15/1822

(57) ABSTRACT

In one embodiment, a system includes an automatic speech recognition (ASR) module, a natural-language understanding (NLU) module, a dialog manager, one or more agents, an arbitrator, a delivery system, one or more processors, and a non-transitory memory coupled to the processors comprising instructions executable by the processors, the processors operable when executing the instructions to receive a user input, process the user input using the ASR module, the NLU module, the dialog manager, one or more of the agents, the arbitrator, and the delivery system, and provide a response to the user input.

### PRIORITY

This application claims the benefit under 35 U.S.C. § 119(e) of U.S. Provisional Patent Application No. 63/352,768, filed 16 Jun. 2022, U.S. Provisional Patent Application No. 63/380,993, filed 26 Oct. 2022, U.S. Provisional Patent Application No. 63/493,291, filed 30 Mar. 2023, U.S. Provisional Patent Application No. 63/496,283, filed 14 Apr. 2023, and U.S. Provisional Patent Application No. 63/498,192, filed 25 Apr. 2023, each of which is incorporated herein by reference.

### TECHNICAL FIELD

This disclosure generally relates to databases and file management within network environments, and in particular relates to hardware and software for smart assistant systems.

### BACKGROUND

An assistant system can provide information or services on behalf of a user based on a combination of user input, location awareness, and the ability to access information from a variety of online sources (such as weather conditions, traffic congestion, news, stock prices, user schedules, retail prices, etc.). The user input may include text (e.g., online chat), especially in an instant messaging application or other applications, voice, images, motion, or a combination of them. The assistant system may perform concierge-type services (e.g., making dinner reservations, purchasing event tickets, making travel arrangements) or provide information based on the user input. The assistant system may also perform management or data-handling tasks based on online information and events without user initiation or interaction. Examples of those tasks that may be performed by an assistant system may include schedule management (e.g., sending an alert to a dinner date that a user is running late due to traffic conditions, update schedules for both parties, and change the restaurant reservation time). The assistant system may be enabled by the combination of computing devices, application programming interfaces (APIs), and the proliferation of applications on user devices.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. profile/news feed posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### BRIEF DESCRIPTION OF THE DRAWINGS

FIG. 1 illustrates an example network environment associated with an assistant system.

FIG. 2 illustrates an example architecture of the assistant system.

FIG. 3 illustrates an example flow diagram of the assistant system.

FIG. 4 illustrates an example task-centric flow diagram of processing a user input.

FIG. 5 illustrates an example flow diagram associated with the assistant design system.

FIG. 6 illustrates an example diagram representing two frameworks for assistant interactions on smart tablets.

FIG. 7 illustrates an example answers handoff interaction.

FIG. 8 illustrates an example natural-language task handoff interaction.

FIG. 9 illustrates an example flow diagram of the interaction model.

FIGS. 10A-10I illustrate example guide on how to sequence each pattern.

FIG. 11 illustrates example assistant-related native experiences.

FIG. 12 illustrates an example AR overlay suggesting healthy food.

FIG. 13 illustrates an example comparison between previous work and the embodiments disclosed herein for continual learning for DST.

FIG. 14 illustrates an example comparison for task consistency between previous work and the embodiments disclosed herein.

FIG. 15 illustrates an example overview of DST-EGQA.

FIG. 16 illustrates an example overview of the query expansion system.

FIG. 17 illustrates example types of synthetic mentions.

FIG. 18 illustrates an example two-stage filtering strategy.

FIG. 19 illustrates an example computer system.

### DESCRIPTION OF EXAMPLE EMBODIMENTS

### System Overview

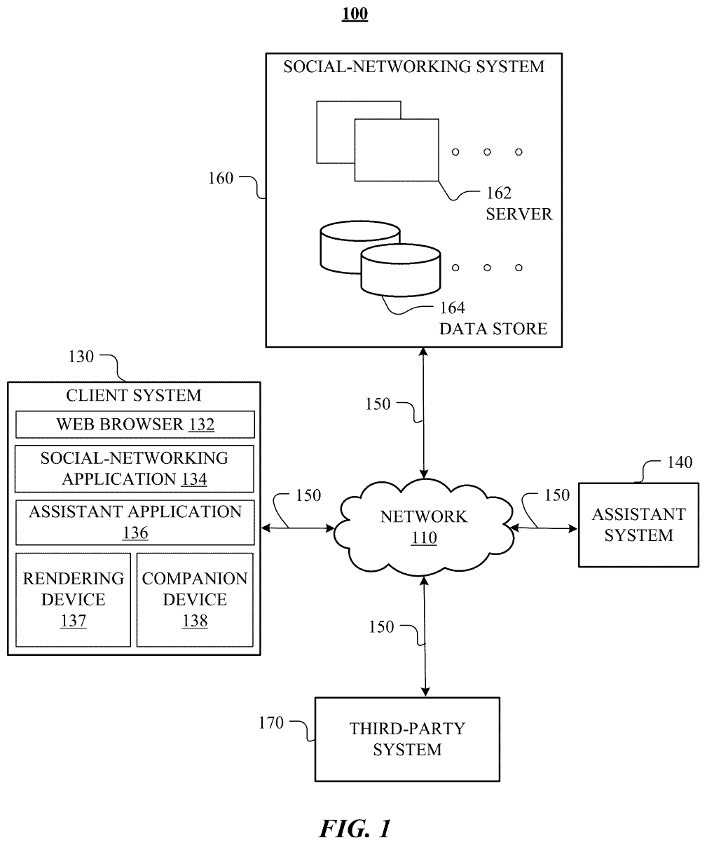

FIG. 1 illustrates an example network environment 100 associated with an assistant system. Network environment 100 includes a client system 130, an assistant system 140, a social-networking system 160, and a third-party system 170 connected to each other by a network 110. Although FIG. 1 illustrates a particular arrangement of a client system 130, an assistant system 140, a social-networking system 160, a third-party system 170, and a network 110, this disclosure contemplates any suitable arrangement of a client system 130, an assistant system 140, a social-networking system 160, a third-party system 170, and a network 110. As an example and not by way of limitation, two or more of a client system 130, a social-networking system 160, an assistant system 140, and a third-party system 170 may be connected to each other directly, bypassing a network 110. As another example, two or more of a client system 130, an assistant system 140, a social-networking system 160, and a third-party system 170 may be physically or logically co-located with each other in whole or in part. Moreover, although FIG. 1 illustrates a particular number of client systems 130, assistant systems 140, social-networking systems 160, third-party systems 170, and networks 110, this disclosure contemplates any suitable number of client systems 130, assistant systems 140, social-networking systems 160, third-party systems 170, and networks 110. As an example and not by way of limitation, network environment 100 may include multiple client systems 130, assistant systems 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect a client system 130, an assistant system 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be any suitable electronic device including hardware, software, or embedded logic components, or a combination of two or more such components, and may be capable of carrying out the functionalities implemented or supported by a client system 130. As an example and not by way of limitation, the client system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. In particular embodiments, the client system 130 may be a smart assistant device. More information on smart assistant devices may be found in U.S. patent application Ser. No. 15/949,011, filed 9 Apr. 2018, U.S. patent application Ser. No. 16/153,574, filed 5 Oct. 2018, U.S. Design patent application Ser. No. 29/631,910, filed 3 Jan. 2018, U.S. Design patent application Ser. No. 29/631,747, filed 2 Jan. 2018, U.S. Design patent application Ser. No. 29/631,913, filed 3 Jan. 2018, and U.S. Design patent application Ser. No. 29/631,914, filed 3 Jan. 2018, each of which is incorporated by reference. This disclosure contemplates any suitable client systems 130. In particular embodiments, a client system 130 may enable a network user at a client system 130 to access a network 110. The client system 130 may also enable the user to communicate with other users at other client systems 130.

In particular embodiments, a client system 130 may include a web browser 132, and may have one or more add-ons, plug-ins, or other extensions. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, a client system 130 may include a social-networking application 134 installed on the client system 130. A user at a client system 130 may use the social-networking application 134 to access on online social network. The user at the client system 130 may use the social-networking application 134 to communicate with the user's social connections (e.g., friends, followers, followed accounts, contacts, etc.). The user at the client system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, a client system 130 may include an assistant application 136. A user at a client system 130 may use the assistant application 136 to interact with the assistant system 140. In particular embodiments, the assistant application 136 may include an assistant xbot functionality as a front-end interface for interacting with the user of the client system 130, including receiving user inputs and presenting outputs. In particular embodiments, the assistant application 136 may comprise a stand-alone application. In particular embodiments, the assistant application 136 may be integrated into the social-networking application 134 or another suitable application (e.g., a messaging application). In particular embodiments, the assistant application 136 may be also integrated into the client system 130, an assistant hardware device, or any other suitable hardware devices. In particular embodiments, the assistant application 136 may be also part of the assistant system 140. In particular embodiments, the assistant application 136 may be accessed via the web browser 132. In particular embodiments, the user may interact with the assistant system 140 by providing user input to the assistant application 136 via various modalities (e.g., audio, voice, text, vision, image, video, gesture, motion, activity, location, orientation). The assistant application 136 may communicate the user input to the assistant system 140 (e.g., via the assistant xbot). Based on the user input, the assistant system 140 may generate responses. The assistant system 140 may send the generated responses to the assistant application 136. The assistant application 136 may then present the responses to the user at the client system 130 via various modalities (e.g., audio, text, image, and video). As an example and not by way of limitation, the user may interact with the assistant system 140 by providing a user input (e.g., a verbal request for information regarding a current status of nearby vehicle traffic) to the assistant xbot via a microphone of the client system 130. The assistant application 136 may then communicate the user input to the assistant system 140 over network 110. The assistant system 140 may accordingly analyze the user input, generate a response based on the analysis of the user input (e.g., vehicle traffic information obtained from a third-party source), and communicate the generated response back to the assistant application 136. The assistant application 136 may then present the generated response to the user in any suitable manner (e.g., displaying a text-based push notification and/or image(s) illustrating a local map of nearby vehicle traffic on a display of the client system 130).

In particular embodiments, a client system 130 may implement wake-word detection techniques to allow users to conveniently activate the assistant system 140 using one or more wake-words associated with assistant system 140. As an example and not by way of limitation, the system audio API on client system 130 may continuously monitor user input comprising audio data (e.g., frames of voice data) received at the client system 130. In this example, a wake-word associated with the assistant system 140 may be the voice phrase “hey assistant.” In this example, when the system audio API on client system 130 detects the voice phrase “hey assistant” in the monitored audio data, the assistant system 140 may be activated for subsequent interaction with the user. In alternative embodiments, similar detection techniques may be implemented to activate the assistant system 140 using particular non-audio user inputs associated with the assistant system 140. For example, the non-audio user inputs may be specific visual signals detected by a low-power sensor (e.g., camera) of client system 130. As an example and not by way of limitation, the visual signals may be a static image (e.g., barcode, QR code, universal product code (UPC)), a position of the user (e.g., the user's gaze towards client system 130), a user motion (e.g., the user pointing at an object), or any other suitable visual signal.

In particular embodiments, a client system 130 may include a rendering device 137 and, optionally, a companion device 138. The rendering device 137 may be configured to render outputs generated by the assistant system 140 to the user. The companion device 138 may be configured to perform computations associated with particular tasks (e.g., communications with the assistant system 140) locally (i.e., on-device) on the companion device 138 in particular circumstances (e.g., when the rendering device 137 is unable to perform said computations). In particular embodiments, the client system 130, the rendering device 137, and/or the companion device 138 may each be a suitable electronic device including hardware, software, or embedded logic components, or a combination of two or more such components, and may be capable of carrying out, individually or cooperatively, the functionalities implemented or supported by the client system 130 described herein. As an example and not by way of limitation, the client system 130, the rendering device 137, and/or the companion device 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, one or more of the client system 130, the rendering device 137, and the companion device 138 may operate as a smart assistant device. As an example and not by way of limitation, the rendering device 137 may comprise smart glasses and the companion device 138 may comprise a smart phone. As another example and not by way of limitation, the rendering device 137 may comprise a smart watch and the companion device 138 may comprise a smart phone. As yet another example and not by way of limitation, the rendering device 137 may comprise smart glasses and the companion device 138 may comprise a smart remote for the smart glasses. As yet another example and not by way of limitation, the rendering device 137 may comprise a VR/AR headset and the companion device 138 may comprise a smart phone.

In particular embodiments, a user may interact with the assistant system 140 using the rendering device 137 or the companion device 138, individually or in combination. In particular embodiments, one or more of the client system 130, the rendering device 137, and the companion device 138 may implement a multi-stage wake-word detection model to enable users to conveniently activate the assistant system 140 by continuously monitoring for one or more wake-words associated with assistant system 140. At a first stage of the wake-word detection model, the rendering device 137 may receive audio user input (e.g., frames of voice data). If a wireless connection between the rendering device 137 and the companion device 138 is available, the application on the rendering device 137 may communicate the received audio user input to the companion application on the companion device 138 via the wireless connection. At a second stage of the wake-word detection model, the companion application on the companion device 138 may process the received audio user input to detect a wake-word associated with the assistant system 140. The companion application on the companion device 138 may then communicate the detected wake-word to a server associated with the assistant system 140 via wireless network 110. At a third stage of the wake-word detection model, the server associated with the assistant system 140 may perform a keyword verification on the detected wake-word to verify whether the user intended to activate and receive assistance from the assistant system 140. In alternative embodiments, any of the processing, detection, or keyword verification may be performed by the rendering device 137 and/or the companion device 138. In particular embodiments, when the assistant system 140 has been activated by the user, an application on the rendering device 137 may be configured to receive user input from the user, and a companion application on the companion device 138 may be configured to handle user inputs (e.g., user requests) received by the application on the rendering device 137. In particular embodiments, the rendering device 137 and the companion device 138 may be associated with each other (i.e., paired) via one or more wireless communication protocols (e.g., Bluetooth).

The following example workflow illustrates how a rendering device 137 and a companion device 138 may handle a user input provided by a user. In this example, an application on the rendering device 137 may receive a user input comprising a user request directed to the rendering device 137. The application on the rendering device 137 may then determine a status of a wireless connection (i.e., tethering status) between the rendering device 137 and the companion device 138. If a wireless connection between the rendering device 137 and the companion device 138 is not available, the application on the rendering device 137 may communicate the user request (optionally including additional data and/or contextual information available to the rendering device 137) to the assistant system 140 via the network 110. The assistant system 140 may then generate a response to the user request and communicate the generated response back to the rendering device 137. The rendering device 137 may then present the response to the user in any suitable manner. Alternatively, if a wireless connection between the rendering device 137 and the companion device 138 is available, the application on the rendering device 137 may communicate the user request (optionally including additional data and/or contextual information available to the rendering device 137) to the companion application on the companion device 138 via the wireless connection. The companion application on the companion device 138 may then communicate the user request (optionally including additional data and/or contextual information available to the companion device 138) to the assistant system 140 via the network 110. The assistant system 140 may then generate a response to the user request and communicate the generated response back to the companion device 138. The companion application on the companion device 138 may then communicate the generated response to the application on the rendering device 137. The rendering device 137 may then present the response to the user in any suitable manner. In the preceding example workflow, the rendering device 137 and the companion device 138 may each perform one or more computations and/or processes at each respective step of the workflow. In particular embodiments, performance of the computations and/or processes disclosed herein may be adaptively switched between the rendering device 137 and the companion device 138 based at least in part on a device state of the rendering device 137 and/or the companion device 138, a task associated with the user input, and/or one or more additional factors. As an example and not by way of limitation, one factor may be signal strength of the wireless connection between the rendering device 137 and the companion device 138. For example, if the signal strength of the wireless connection between the rendering device 137 and the companion device 138 is strong, the computations and processes may be adaptively switched to be substantially performed by the companion device 138 in order to, for example, benefit from the greater processing power of the CPU of the companion device 138. Alternatively, if the signal strength of the wireless connection between the rendering device 137 and the companion device 138 is weak, the computations and processes may be adaptively switched to be substantially performed by the rendering device 137 in a standalone manner. In particular embodiments, if the client system 130 does not comprise a companion device 138, the aforementioned computations and processes may be performed solely by the rendering device 137 in a standalone manner.

In particular embodiments, an assistant system 140 may assist users with various assistant-related tasks. The assistant system 140 may interact with the social-networking system 160 and/or the third-party system 170 when executing these assistant-related tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, an assistant system 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes-which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow, for example, an assistant system 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a user input comprising a user request received from a client system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Assistant Systems

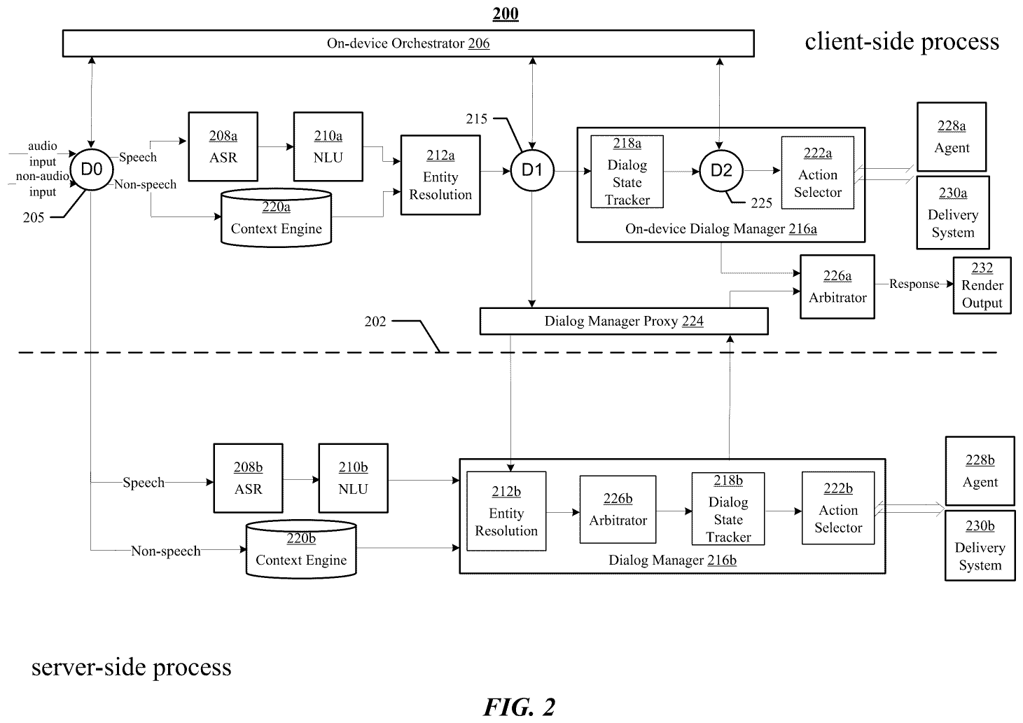

FIG. 2 illustrates an example architecture 200 of the assistant system 140. In particular embodiments, the assistant system 140 may assist a user to obtain information or services. The assistant system 140 may enable the user to interact with the assistant system 140 via user inputs of various modalities (e.g., audio, voice, text, vision, image, video, gesture, motion, activity, location, orientation) in stateful and multi-turn conversations to receive assistance from the assistant system 140. As an example and not by way of limitation, a user input may comprise an audio input based on the user's voice (e.g., a verbal command), which may be processed by a system audio API (application programming interface) on client system 130. The system audio API may perform techniques including echo cancellation, noise removal, beam forming, self-user voice activation, speaker identification, voice activity detection (VAD), and/or any other suitable acoustic technique in order to generate audio data that is readily processable by the assistant system 140. In particular embodiments, the assistant system 140 may support mono-modal inputs (e.g., only voice inputs), multi-modal inputs (e.g., voice inputs and text inputs), hybrid/multi-modal inputs, or any combination thereof. In particular embodiments, a user input may be a user-generated input that is sent to the assistant system 140 in a single turn. User inputs provided by a user may be associated with particular assistant-related tasks, and may include, for example, user requests (e.g., verbal requests for information or performance of an action), user interactions with the assistant application 136 associated with the assistant system 140 (e.g., selection of UI elements via touch or gesture), or any other type of suitable user input that may be detected and understood by the assistant system 140 (e.g., user movements detected by the client device 130 of the user).

In particular embodiments, the assistant system 140 may create and store a user profile comprising both personal and contextual information associated with the user. In particular embodiments, the assistant system 140 may analyze the user input using natural-language understanding (NLU) techniques. The analysis may be based at least in part on the user profile of the user for more personalized and context-aware understanding. The assistant system 140 may resolve entities associated with the user input based on the analysis. In particular embodiments, the assistant system 140 may interact with different agents to obtain information or services that are associated with the resolved entities. The assistant system 140 may generate a response for the user regarding the information or services by using natural-language generation (NLG). Through the interaction with the user, the assistant system 140 may use dialog management techniques to manage and forward the conversation flow with the user. In particular embodiments, the assistant system 140 may further assist the user to effectively and efficiently digest the obtained information by summarizing the information. The assistant system 140 may also assist the user to be more engaging with an online social network by providing tools that help the user interact with the online social network (e.g., creating posts, comments, messages). The assistant system 140 may additionally assist the user to manage different tasks such as keeping track of events. In particular embodiments, the assistant system 140 may proactively execute, without a user input, pre-authorized tasks that are relevant to user interests and preferences based on the user profile, at a time relevant for the user. In particular embodiments, the assistant system 140 may check privacy settings to ensure that accessing a user's profile or other user information and executing different tasks are permitted subject to the user's privacy settings. More information on assisting users subject to privacy settings may be found in U.S. patent application Ser. No. 16/182,542, filed 6 Nov. 2018, which is incorporated by reference.

In particular embodiments, the assistant system 140 may assist a user via an architecture built upon client-side processes and server-side processes which may operate in various operational modes. In FIG. 2, the client-side process is illustrated above the dashed line 202 whereas the server-side process is illustrated below the dashed line 202. A first operational mode (i.e., on-device mode) may be a workflow in which the assistant system 140 processes a user input and provides assistance to the user by primarily or exclusively performing client-side processes locally on the client system 130. For example, if the client system 130 is not connected to a network 110 (i.e., when client system 130 is offline), the assistant system 140 may handle a user input in the first operational mode utilizing only client-side processes. A second operational mode (i.e., cloud mode) may be a workflow in which the assistant system 140 processes a user input and provides assistance to the user by primarily or exclusively performing server-side processes on one or more remote servers (e.g., a server associated with assistant system 140). As illustrated in FIG. 2, a third operational mode (i.e., blended mode) may be a parallel workflow in which the assistant system 140 processes a user input and provides assistance to the user by performing client-side processes locally on the client system 130 in conjunction with server-side processes on one or more remote servers (e.g., a server associated with assistant system 140). For example, the client system 130 and the server associated with assistant system 140 may both perform automatic speech recognition (ASR) and natural-language understanding (NLU) processes, but the client system 130 may delegate dialog, agent, and natural-language generation (NLG) processes to be performed by the server associated with assistant system 140.

In particular embodiments, selection of an operational mode may be based at least in part on a device state, a task associated with a user input, and/or one or more additional factors. As an example and not by way of limitation, as described above, one factor may be a network connectivity status for client system 130. For example, if the client system 130 is not connected to a network 110 (i.e., when client system 130 is offline), the assistant system 140 may handle a user input in the first operational mode (i.e., on-device mode). As another example and not by way of limitation, another factor may be based on a measure of available battery power (i.e., battery status) for the client system 130. For example, if there is a need for client system 130 to conserve battery power (e.g., when client system 130 has minimal available battery power or the user has indicated a desire to conserve the battery power of the client system 130), the assistant system 140 may handle a user input in the second operational mode (i.e., cloud mode) or the third operational mode (i.e., blended mode) in order to perform fewer power-intensive operations on the client system 130. As yet another example and not by way of limitation, another factor may be one or more privacy constraints (e.g., specified privacy settings, applicable privacy policies). For example, if one or more privacy constraints limits or precludes particular data from being transmitted to a remote server (e.g., a server associated with the assistant system 140), the assistant system 140 may handle a user input in the first operational mode (i.e., on-device mode) in order to protect user privacy. As yet another example and not by way of limitation, another factor may be desynchronized context data between the client system 130 and a remote server (e.g., the server associated with assistant system 140). For example, the client system 130 and the server associated with assistant system 140 may be determined to have inconsistent, missing, and/or unreconciled context data, the assistant system 140 may handle a user input in the third operational mode (i.e., blended mode) to reduce the likelihood of an inadequate analysis associated with the user input. As yet another example and not by way of limitation, another factor may be a measure of latency for the connection between client system 130 and a remote server (e.g., the server associated with assistant system 140). For example, if a task associated with a user input may significantly benefit from and/or require prompt or immediate execution (e.g., photo capturing tasks), the assistant system 140 may handle the user input in the first operational mode (i.e., on-device mode) to ensure the task is performed in a timely manner. As yet another example and not by way of limitation, another factor may be, for a feature relevant to a task associated with a user input, whether the feature is only supported by a remote server (e.g., the server associated with assistant system 140). For example, if the relevant feature requires advanced technical functionality (e.g., high-powered processing capabilities, rapid update cycles) that is only supported by the server associated with assistant system 140 and is not supported by client system 130 at the time of the user input, the assistant system 140 may handle the user input in the second operational mode (i.e., cloud mode) or the third operational mode (i.e., blended mode) in order to benefit from the relevant feature.

In particular embodiments, an on-device orchestrator 206 on the client system 130 may coordinate receiving a user input and may determine, at one or more decision points in an example workflow, which of the operational modes described above should be used to process or continue processing the user input. As discussed above, selection of an operational mode may be based at least in part on a device state, a task associated with a user input, and/or one or more additional factors. As an example and not by way of limitation, with reference to the workflow architecture illustrated in FIG. 2, after a user input is received from a user, the on-device orchestrator 206 may determine, at decision point (DO) 205, whether to begin processing the user input in the first operational mode (i.e., on-device mode), the second operational mode (i.e., cloud mode), or the third operational mode (i.e., blended mode). For example, at decision point (DO) 205, the on-device orchestrator 206 may select the first operational mode (i.e., on-device mode) if the client system 130 is not connected to network 110 (i.e., when client system 130 is offline), if one or more privacy constraints expressly require on-device processing (e.g., adding or removing another person to a private call between users), or if the user input is associated with a task which does not require or benefit from server-side processing (e.g., setting an alarm or calling another user). As another example, at decision point (DO) 205, the on-device orchestrator 206 may select the second operational mode (i.e., cloud mode) or the third operational mode (i.e., blended mode) if the client system 130 has a need to conserve battery power (e.g., when client system 130 has minimal available battery power or the user has indicated a desire to conserve the battery power of the client system 130) or has a need to limit additional utilization of computing resources (e.g., when other processes operating on client device 130 require high CPU utilization (e.g., SMS messaging applications)).

In particular embodiments, if the on-device orchestrator 206 determines at decision point (DO) 205 that the user input should be processed using the first operational mode (i.e., on-device mode) or the third operational mode (i.e., blended mode), the client-side process may continue as illustrated in FIG. 2. As an example and not by way of limitation, if the user input comprises speech data, the speech data may be received at a local automatic speech recognition (ASR) module 208a on the client system 130. The ASR module 208a may allow a user to dictate and have speech transcribed as written text, have a document synthesized as an audio stream, or issue commands that are recognized as such by the system.

In particular embodiments, the output of the ASR module 208a may be sent to a local natural-language understanding (NLU) module 210a. The NLU module 210a may perform named entity resolution (NER), or named entity resolution may be performed by the entity resolution module 212a, as described below. In particular embodiments, one or more of an intent, a slot, or a domain may be an output of the NLU module 210a.

In particular embodiments, the user input may comprise non-speech data, which may be received at a local context engine 220a. As an example and not by way of limitation, the non-speech data may comprise locations, visuals, touch, gestures, world updates, social updates, contextual information, information related to people, activity data, and/or any other suitable type of non-speech data. The non-speech data may further comprise sensory data received by client system 130 sensors (e.g., microphone, camera), which may be accessed subject to privacy constraints and further analyzed by computer vision technologies. In particular embodiments, the computer vision technologies may comprise object detection, scene recognition, hand tracking, eye tracking, and/or any other suitable computer vision technologies. In particular embodiments, the non-speech data may be subject to geometric constructions, which may comprise constructing objects surrounding a user using any suitable type of data collected by a client system 130. As an example and not by way of limitation, a user may be wearing AR glasses, and geometric constructions may be utilized to determine spatial locations of surfaces and items (e.g., a floor, a wall, a user's hands). In particular embodiments, the non-speech data may be inertial data captured by AR glasses or a VR headset, and which may be data associated with linear and angular motions (e.g., measurements associated with a user's body movements). In particular embodiments, the context engine 220a may determine various types of events and context based on the non-speech data.

In particular embodiments, the outputs of the NLU module 210a and/or the context engine 220a may be sent to an entity resolution module 212a. The entity resolution module 212a may resolve entities associated with one or more slots output by NLU module 210a. In particular embodiments, each resolved entity may be associated with one or more entity identifiers. As an example and not by way of limitation, an identifier may comprise a unique user identifier (ID) corresponding to a particular user (e.g., a unique username or user ID number for the social-networking system 160). In particular embodiments, each resolved entity may also be associated with a confidence score. More information on resolving entities may be found in U.S. Pat. No. 10,803,050, filed 27 Jul. 2018, and U.S. patent application Ser. No. 16/048,072, filed 27 Jul. 2018, each of which is incorporated by reference.

In particular embodiments, at decision point (DO) 205, the on-device orchestrator 206 may determine that a user input should be handled in the second operational mode (i.e., cloud mode) or the third operational mode (i.e., blended mode). In these operational modes, the user input may be handled by certain server-side modules in a similar manner as the client-side process described above.

In particular embodiments, if the user input comprises speech data, the speech data of the user input may be received at a remote automatic speech recognition (ASR) module 208b on a remote server (e.g., the server associated with assistant system 140). The ASR module 208b may allow a user to dictate and have speech transcribed as written text, have a document synthesized as an audio stream, or issue commands that are recognized as such by the system.

In particular embodiments, the output of the ASR module 208b may be sent to a remote natural-language understanding (NLU) module 210b. In particular embodiments, the NLU module 210b may perform named entity resolution (NER) or named entity resolution may be performed by entity resolution module 212b of dialog manager module 216b as described below. In particular embodiments, one or more of an intent, a slot, or a domain may be an output of the NLU module 210b.

In particular embodiments, the user input may comprise non-speech data, which may be received at a remote context engine 220b. In particular embodiments, the remote context engine 220b may determine various types of events and context based on the non-speech data. In particular embodiments, the output of the NLU module 210b and/or the context engine 220b may be sent to a remote dialog manager 216b.

In particular embodiments, as discussed above, an on-device orchestrator 206 on the client system 130 may coordinate receiving a user input and may determine, at one or more decision points in an example workflow, which of the operational modes described above should be used to process or continue processing the user input. As further discussed above, selection of an operational mode may be based at least in part on a device state, a task associated with a user input, and/or one or more additional factors. As an example and not by way of limitation, with continued reference to the workflow architecture illustrated in FIG. 2, after the entity resolution module 212a generates an output or a null output, the on-device orchestrator 206 may determine, at decision point (D1) 215, whether to continue processing the user input in the first operational mode (i.e., on-device mode), the second operational mode (i.e., cloud mode), or the third operational mode (i.e., blended mode). For example, at decision point (D1) 215, the on-device orchestrator 206 may select the first operational mode (i.e., on-device mode) if an identified intent is associated with a latency sensitive processing task (e.g., taking a photo, pausing a stopwatch). As another example and not by way of limitation, if a messaging task is not supported by on-device processing on the client system 130, the on-device orchestrator 206 may select the third operational mode (i.e., blended mode) to process the user input associated with a messaging request. As yet another example, at decision point (D1) 215, the on-device orchestrator 206 may select the second operational mode (i.e., cloud mode) or the third operational mode (i.e., blended mode) if the task being processed requires access to a social graph, a knowledge graph, or a concept graph not stored on the client system 130. Alternatively, the on-device orchestrator 206 may instead select the first operational mode (i.e., on-device mode) if a sufficient version of an informational graph including requisite information for the task exists on the client system 130 (e.g., a smaller and/or bootstrapped version of a knowledge graph).

In particular embodiments, if the on-device orchestrator 206 determines at decision point (D1) 215 that processing should continue using the first operational mode (i.e., on-device mode) or the third operational mode (i.e., blended mode), the client-side process may continue as illustrated in FIG. 2. As an example and not by way of limitation, the output from the entity resolution module 212a may be sent to an on-device dialog manager 216a. In particular embodiments, the on-device dialog manager 216a may comprise a dialog state tracker 218a and an action selector 222a. The on-device dialog manager 216a may have complex dialog logic and product-related business logic to manage the dialog state and flow of the conversation between the user and the assistant system 140. The on-device dialog manager 216a may include full functionality for end-to-end integration and multi-turn support (e.g., confirmation, disambiguation). The on-device dialog manager 216a may also be lightweight with respect to computing limitations and resources including memory, computation (CPU), and binary size constraints. The on-device dialog manager 216a may also be scalable to improve developer experience. In particular embodiments, the on-device dialog manager 216a may benefit the assistant system 140, for example, by providing offline support to alleviate network connectivity issues (e.g., unstable or unavailable network connections), by using client-side processes to prevent privacy-sensitive information from being transmitted off of client system 130, and by providing a stable user experience in high-latency sensitive scenarios.

In particular embodiments, the on-device dialog manager 216a may further conduct false trigger mitigation. Implementation of false trigger mitigation may detect and prevent false triggers from user inputs which would otherwise invoke the assistant system 140 (e.g., an unintended wake-word) and may further prevent the assistant system 140 from generating data records based on the false trigger that may be inaccurate and/or subject to privacy constraints. As an example and not by way of limitation, if a user is in a voice call, the user's conversation during the voice call may be considered private, and the false trigger mitigation may limit detection of wake-words to audio user inputs received locally by the user's client system 130. In particular embodiments, the on-device dialog manager 216a may implement false trigger mitigation based on a nonsense detector. If the nonsense detector determines with a high confidence that a received wake-word is not logically and/or contextually sensible at the point in time at which it was received from the user, the on-device dialog manager 216a may determine that the user did not intend to invoke the assistant system 140.

In particular embodiments, due to a limited computing power of the client system 130, the on-device dialog manager 216a may conduct on-device learning based on learning algorithms particularly tailored for client system 130. As an example and not by way of limitation, federated learning techniques may be implemented by the on-device dialog manager 216a. Federated learning is a specific category of distributed machine learning techniques which may train machine-learning models using decentralized data stored on end devices (e.g., mobile phones). In particular embodiments, the on-device dialog manager 216a may use federated user representation learning model to extend existing neural-network personalization techniques to implementation of federated learning by the on-device dialog manager 216a. Federated user representation learning may personalize federated learning models by learning task-specific user representations (i.e., embeddings) and/or by personalizing model weights. Federated user representation learning is a simple, scalable, privacy-preserving, and resource-efficient. Federated user representation learning may divide model parameters into federated and private parameters. Private parameters, such as private user embeddings, may be trained locally on a client system 130 instead of being transferred to or averaged by a remote server (e.g., the server associated with assistant system 140). Federated parameters, by contrast, may be trained remotely on the server. In particular embodiments, the on-device dialog manager 216a may use an active federated learning model, which may transmit a global model trained on the remote server to client systems 130 and calculate gradients locally on the client systems 130. Active federated learning may enable the on-device dialog manager 216a to minimize the transmission costs associated with downloading models and uploading gradients. For active federated learning, in each round, client systems 130 may be selected in a semi-random manner based at least in part on a probability conditioned on the current model and the data on the client systems 130 in order to optimize efficiency for training the federated learning model.

In particular embodiments, the dialog state tracker 218a may track state changes over time as a user interacts with the world and the assistant system 140 interacts with the user. As an example and not by way of limitation, the dialog state tracker 218a may track, for example, what the user is talking about, whom the user is with, where the user is, what tasks are currently in progress, and where the user's gaze is at subject to applicable privacy policies.

In particular embodiments, at decision point (D1) 215, the on-device orchestrator 206 may determine to forward the user input to the server for either the second operational mode (i.e., cloud mode) or the third operational mode (i.e., blended mode). As an example and not by way of limitation, if particular functionalities or processes (e.g., messaging) are not supported by on the client system 130, the on-device orchestrator 206 may determine at decision point (D1) 215 to use the third operational mode (i.e., blended mode). In particular embodiments, the on-device orchestrator 206 may cause the outputs from the NLU module 210a, the context engine 220a, and the entity resolution module 212a, via a dialog manager proxy 224, to be forwarded to an entity resolution module 212b of the remote dialog manager 216b to continue the processing. The dialog manager proxy 224 may be a communication channel for information/events exchange between the client system 130 and the server. In particular embodiments, the dialog manager 216b may additionally comprise a remote arbitrator 226b, a remote dialog state tracker 218b, and a remote action selector 222b. In particular embodiments, the assistant system 140 may have started processing a user input with the second operational mode (i.e., cloud mode) at decision point (DO) 205 and the on-device orchestrator 206 may determine to continue processing the user input based on the second operational mode (i.e., cloud mode) at decision point (D1) 215. Accordingly, the output from the NLU module 210b and the context engine 220b may be received at the remote entity resolution module 212b. The remote entity resolution module 212b may have similar functionality as the local entity resolution module 212a, which may comprise resolving entities associated with the slots. In particular embodiments, the entity resolution module 212b may access one or more of the social graph, the knowledge graph, or the concept graph when resolving the entities. The output from the entity resolution module 212b may be received at the arbitrator 226b.

In particular embodiments, the remote arbitrator 226b may be responsible for choosing between client-side and server-side upstream results (e.g., results from the NLU module 210a/b, results from the entity resolution module 212a/b, and results from the context engine 220a/b). The arbitrator 226b may send the selected upstream results to the remote dialog state tracker 218b. In particular embodiments, similarly to the local dialog state tracker 218a, the remote dialog state tracker 218b may convert the upstream results into candidate tasks using task specifications and resolve arguments with entity resolution.

In particular embodiments, at decision point (D2) 225, the on-device orchestrator 206 may determine whether to continue processing the user input based on the first operational mode (i.e., on-device mode) or forward the user input to the server for the third operational mode (i.e., blended mode). The decision may depend on, for example, whether the client-side process is able to resolve the task and slots successfully, whether there is a valid task policy with a specific feature support, and/or the context differences between the client-side process and the server-side process. In particular embodiments, decisions made at decision point (D2) 225 may be for multi-turn scenarios. In particular embodiments, there may be at least two possible scenarios. In a first scenario, the assistant system 140 may have started processing a user input in the first operational mode (i.e., on-device mode) using client-side dialog state. If at some point the assistant system 140 decides to switch to having the remote server process the user input, the assistant system 140 may create a programmatic/predefined task with the current task state and forward it to the remote server. For subsequent turns, the assistant system 140 may continue processing in the third operational mode (i.e., blended mode) using the server-side dialog state. In another scenario, the assistant system 140 may have started processing the user input in either the second operational mode (i.e., cloud mode) or the third operational mode (i.e., blended mode) and may substantially rely on server-side dialog state for all subsequent turns. If the on-device orchestrator 206 determines to continue processing the user input based on the first operational mode (i.e., on-device mode), the output from the dialog state tracker 218a may be received at the action selector 222a.

In particular embodiments, at decision point (D2) 225, the on-device orchestrator 206 may determine to forward the user input to the remote server and continue processing the user input in either the second operational mode (i.e., cloud mode) or the third operational mode (i.e., blended mode). The assistant system 140 may create a programmatic/predefined task with the current task state and forward it to the server, which may be received at the action selector 222b. In particular embodiments, the assistant system 140 may have started processing the user input in the second operational mode (i.e., cloud mode), and the on-device orchestrator 206 may determine to continue processing the user input in the second operational mode (i.e., cloud mode) at decision point (D2) 225. Accordingly, the output from the dialog state tracker 218b may be received at the action selector 222b.

In particular embodiments, the action selector 222a/b may perform interaction management. The action selector 222a/b may determine and trigger a set of general executable actions. The actions may be executed either on the client system 130 or at the remote server. As an example and not by way of limitation, these actions may include providing information or suggestions to the user. In particular embodiments, the actions may interact with agents 228a/b, users, and/or the assistant system 140 itself. These actions may comprise actions including one or more of a slot request, a confirmation, a disambiguation, or an agent execution. The actions may be independent of the underlying implementation of the action selector 222a/b. For more complicated scenarios such as, for example, multi-turn tasks or tasks with complex business logic, the local action selector 222a may call one or more local agents 228a, and the remote action selector 222b may call one or more remote agents 228b to execute the actions. Agents 228a/b may be invoked via task ID, and any actions may be routed to the correct agent 228a/b using that task ID. In particular embodiments, an agent 228a/b may be configured to serve as a broker across a plurality of content providers for one domain. A content provider may be an entity responsible for carrying out an action associated with an intent or completing a task associated with the intent. In particular embodiments, agents 228a/b may provide several functionalities for the assistant system 140 including, for example, native template generation, task specific business logic, and querying external APIs. When executing actions for a task, agents 228a/b may use context from the dialog state tracker 218a/b, and may also update the dialog state tracker 218a/b. In particular embodiments, agents 228a/b may also generate partial payloads from a dialog act.

In particular embodiments, the local agents 228a may have different implementations to be compiled/registered for different platforms (e.g., smart glasses versus a VR headset). In particular embodiments, multiple device-specific implementations (e.g., real-time calls for a client system 130 or a messaging application on the client system 130) may be handled internally by a single agent 228a. Alternatively, device-specific implementations may be handled by multiple agents 228a associated with multiple domains. As an example and not by way of limitation, calling an agent 228a on smart glasses may be implemented in a different manner than calling an agent 228a on a smart phone. Different platforms may also utilize varying numbers of agents 228a. The agents 228a may also be cross-platform (i.e., different operating systems on the client system 130). In addition, the agents 228a may have minimized startup time or binary size impact. Local agents 228a may be suitable for particular use cases. As an example and not by way of limitation, one use case may be emergency calling on the client system 130. As another example and not by way of limitation, another use case may be responding to a user input without network connectivity. As yet another example and not by way of limitation, another use case may be that particular domains/tasks may be privacy sensitive and may prohibit user inputs being sent to the remote server.

In particular embodiments, the local action selector 222a may call a local delivery system 230a for executing the actions, and the remote action selector 222b may call a remote delivery system 230b for executing the actions. The delivery system 230a/b may deliver a predefined event upon receiving triggering signals from the dialog state tracker 218a/b by executing corresponding actions. The delivery system 230a/b may ensure that events get delivered to a host with a living connection. As an example and not by way of limitation, the delivery system 230a/b may broadcast to all online devices that belong to one user. As another example and not by way of limitation, the delivery system 230a/b may deliver events to target-specific devices. The delivery system 230a/b may further render a payload using up-to-date device context.

In particular embodiments, the on-device dialog manager 216a may additionally comprise a separate local action execution module, and the remote dialog manager 216b may additionally comprise a separate remote action execution module. The local execution module and the remote action execution module may have similar functionality. In particular embodiments, the action execution module may call the agents 228a/b to execute tasks. The action execution module may additionally perform a set of general executable actions determined by the action selector 222a/b. The set of executable actions may interact with agents 228a/b, users, and the assistant system 140 itself via the delivery system 230a/b.

In particular embodiments, if the user input is handled using the first operational mode (i.e., on-device mode), results from the agents 228a and/or the delivery system 230a may be returned to the on-device dialog manager 216a. The on-device dialog manager 216a may then instruct a local arbitrator 226a to generate a final response based on these results. The arbitrator 226a may aggregate the results and evaluate them. As an example and not by way of limitation, the arbitrator 226a may rank and select a best result for responding to the user input. If the user request is handled in the second operational mode (i.e., cloud mode), the results from the agents 228b and/or the delivery system 230b may be returned to the remote dialog manager 216b. The remote dialog manager 216b may instruct, via the dialog manager proxy 224, the arbitrator 226a to generate the final response based on these results. Similarly, the arbitrator 226a may analyze the results and select the best result to provide to the user. If the user input is handled based on the third operational mode (i.e., blended mode), the client-side results and server-side results (e.g., from agents 228a/b and/or delivery system 230a/b) may both be provided to the arbitrator 226a by the on-device dialog manager 216a and remote dialog manager 216b, respectively. The arbitrator 226 may then choose between the client-side and server-side side results to determine the final result to be presented to the user. In particular embodiments, the logic to decide between these results may depend on the specific use-case.

In particular embodiments, the local arbitrator 226a may generate a response based on the final result and send it to a render output module 232. The render output module 232 may determine how to render the output in a way that is suitable for the client system 130. As an example and not by way of limitation, for a VR headset or AR smart glasses, the render output module 232 may determine to render the output using a visual-based modality (e.g., an image or a video clip) that may be displayed via the VR headset or AR smart glasses. As another example, the response may be rendered as audio signals that may be played by the user via a VR headset or AR smart glasses. As yet another example, the response may be rendered as augmented-reality data for enhancing user experience.

In particular embodiments, in addition to determining an operational mode to process the user input, the on-device orchestrator 206 may also determine whether to process the user input on the rendering device 137, process the user input on the companion device 138, or process the user request on the remote server. The rendering device 137 and/or the companion device 138 may each use the assistant stack in a similar manner as disclosed above to process the user input. As an example and not by, the on-device orchestrator 206 may determine that part of the processing should be done on the rendering device 137, part of the processing should be done on the companion device 138, and the remaining processing should be done on the remote server.

In particular embodiments, the assistant system 140 may have a variety of capabilities including audio cognition, visual cognition, signals intelligence, reasoning, and memories. In particular embodiments, the capability of audio cognition may enable the assistant system 140 to, for example, understand a user's input associated with various domains in different languages, understand and summarize a conversation, perform on-device audio cognition for complex commands, identify a user by voice, extract topics from a conversation and auto-tag sections of the conversation, enable audio interaction without a wake-word, filter and amplify user voice from ambient noise and conversations, and/or understand which client system 130 a user is talking to if multiple client systems 130 are in vicinity.

In particular embodiments, the capability of visual cognition may enable the assistant system 140 to, for example, recognize interesting objects in the world through a combination of existing machine-learning models and one-shot learning, recognize an interesting moment and auto-capture it, achieve semantic understanding over multiple visual frames across different episodes of time, provide platform support for additional capabilities in places or objects recognition, recognize a full set of settings and micro-locations including personalized locations, recognize complex activities, recognize complex gestures to control a client system 130, handle images/videos from egocentric cameras (e.g., with motion, capture angles, resolution), accomplish similar levels of accuracy and speed regarding images with lower resolution, conduct one-shot registration and recognition of places and objects, and/or perform visual recognition on a client system 130.

In particular embodiments, the assistant system 140 may leverage computer vision techniques to achieve visual cognition. Besides computer vision techniques, the assistant system 140 may explore options that may supplement these techniques to scale up the recognition of objects. In particular embodiments, the assistant system 140 may use supplemental signals such as, for example, optical character recognition (OCR) of an object's labels, GPS signals for places recognition, and/or signals from a user's client system 130 to identify the user. In particular embodiments, the assistant system 140 may perform general scene recognition (e.g., home, work, public spaces) to set a context for the user and reduce the computer-vision search space to identify likely objects or people. In particular embodiments, the assistant system 140 may guide users to train the assistant system 140. For example, crowdsourcing may be used to get users to tag objects and help the assistant system 140 recognize more objects over time. As another example, users may register their personal objects as part of an initial setup when using the assistant system 140. The assistant system 140 may further allow users to provide positive/negative signals for objects they interact with to train and improve personalized models for them.

In particular embodiments, the capability of signals intelligence may enable the assistant system 140 to, for example, determine user location, understand date/time, determine family locations, understand users' calendars and future desired locations, integrate richer sound understanding to identify setting/context through sound alone, and/or build signals intelligence models at runtime which may be personalized to a user's individual routines.

In particular embodiments, the capability of reasoning may enable the assistant system 140 to, for example, pick up previous conversation threads at any point in the future, synthesize all signals to understand micro and personalized context, learn interaction patterns and preferences from users' historical behavior and accurately suggest interactions that they may value, generate highly predictive proactive suggestions based on micro-context understanding, understand what content a user may want to see at what time of a day, and/or understand the changes in a scene and how that may impact the user's desired content.

In particular embodiments, the capabilities of memories may enable the assistant system 140 to, for example, remember which social connections a user previously called or interacted with, write into memory and query memory at will (i.e., open dictation and auto tags), extract richer preferences based on prior interactions and long-term learning, remember a user's life history, extract rich information from egocentric streams of data and auto catalog, and/or write to memory in structured form to form rich short, episodic and long-term memories.

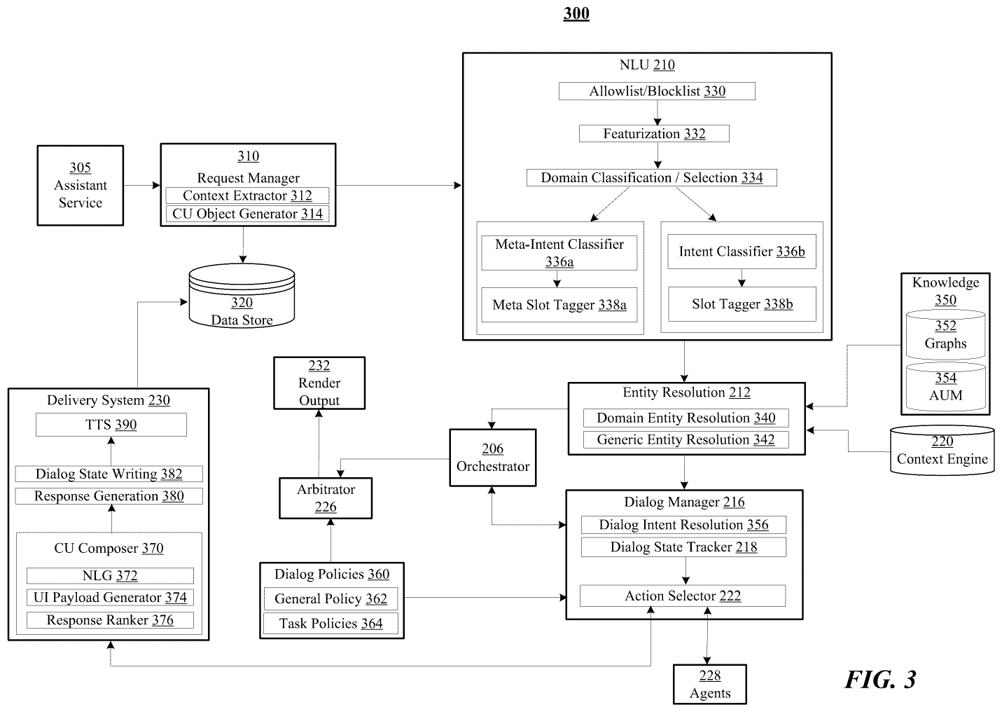

FIG. 3 illustrates an example flow diagram 300 of the assistant system 140. In particular embodiments, an assistant service module 305 may access a request manager 310 upon receiving a user input. In particular embodiments, the request manager 310 may comprise a context extractor 312 and a conversational understanding object generator (CU object generator) 314. The context extractor 312 may extract contextual information associated with the user input. The context extractor 312 may also update contextual information based on the assistant application 136 executing on the client system 130. As an example and not by way of limitation, the update of contextual information may comprise content items are displayed on the client system 130. As another example and not by way of limitation, the update of contextual information may comprise whether an alarm is set on the client system 130. As another example and not by way of limitation, the update of contextual information may comprise whether a song is playing on the client system 130. The CU object generator 314 may generate particular CU objects relevant to the user input. The CU objects may comprise dialog-session data and features associated with the user input, which may be shared with all the modules of the assistant system 140. In particular embodiments, the request manager 310 may store the contextual information and the generated CU objects in a data store 320 which is a particular data store implemented in the assistant system 140.

In particular embodiments, the request manger 310 may send the generated CU objects to the NLU module 210. The NLU module 210 may perform a plurality of steps to process the CU objects. The NLU module 210 may first run the CU objects through an allowlist/blocklist 330. In particular embodiments, the allowlist/blocklist 330 may comprise interpretation data matching the user input. The NLU module 210 may then perform a featurization 332 of the CU objects. The NLU module 210 may then perform domain classification/selection 334 on user input based on the features resulted from the featurization 332 to classify the user input into predefined domains. In particular embodiments, a domain may denote a social context of interaction (e.g., education), or a namespace for a set of intents (e.g., music). The domain classification/selection results may be further processed based on two related procedures. In one procedure, the NLU module 210 may process the domain classification/selection results using a meta-intent classifier 336a. The meta-intent classifier 336a may determine categories that describe the user's intent. An intent may be an element in a pre-defined taxonomy of semantic intentions, which may indicate a purpose of a user interaction with the assistant system 140. The NLU module 210a may classify a user input into a member of the pre-defined taxonomy. For example, the user input may be “Play Beethoven's 5th,” and the NLU module 210a may classify the input as having the intent [IN:play_music]. In particular embodiments, intents that are common to multiple domains may be processed by the meta-intent classifier 336a. As an example and not by way of limitation, the meta-intent classifier 336a may be based on a machine-learning model that may take the domain classification/selection results as input and calculate a probability of the input being associated with a particular predefined meta-intent. The NLU module 210 may then use a meta slot tagger 338a to annotate one or more meta slots for the classification result from the meta-intent classifier 336a. A slot may be a named sub-string corresponding to a character string within the user input representing a basic semantic entity. For example, a slot for “pizza” may be [SL:dish]. In particular embodiments, a set of valid or expected named slots may be conditioned on the classified intent. As an example and not by way of limitation, for the intent [IN:play_music], a valid slot may be [SL:song_name]. In particular embodiments, the meta slot tagger 338a may tag generic slots such as references to items (e.g., the first), the type of slot, the value of the slot, etc. In particular embodiments, the NLU module 210 may process the domain classification/selection results using an intent classifier 336b. The intent classifier 336b may determine the user's intent associated with the user input. In particular embodiments, there may be one intent classifier 336b for each domain to determine the most possible intents in a given domain. As an example and not by way of limitation, the intent classifier 336b may be based on a machine-learning model that may take the domain classification/selection results as input and calculate a probability of the input being associated with a particular predefined intent. The NLU module 210 may then use a slot tagger 338b to annotate one or more slots associated with the user input. In particular embodiments, the slot tagger 338b may annotate the one or more slots for the n-grams of the user input. As an example and not by way of limitation, a user input may comprise “change 500 dollars in my account to Japanese yen.” The intent classifier 336b may take the user input as input and formulate it into a vector. The intent classifier 336b may then calculate probabilities of the user input being associated with different predefined intents based on a vector comparison between the vector representing the user input and the vectors representing different predefined intents. In a similar manner, the slot tagger 338b may take the user input as input and formulate each word into a vector. The slot tagger 338b may then calculate probabilities of each word being associated with different predefined slots based on a vector comparison between the vector representing the word and the vectors representing different predefined slots. The intent of the user may be classified as “changing money”. The slots of the user input may comprise “500”, “dollars”, “account”, and “Japanese yen”. The meta-intent of the user may be classified as “financial service”. The meta slot may comprise “finance”.

In particular embodiments, the natural-language understanding (NLU) module 210 may additionally extract information from one or more of a social graph, a knowledge graph, or a concept graph, and may retrieve a user's profile stored locally on the client system 130. The NLU module 210 may additionally consider contextual information when analyzing the user input. The NLU module 210 may further process information from these different sources by identifying and aggregating information, annotating n-grams of the user input, ranking the n-grams with confidence scores based on the aggregated information, and formulating the ranked n-grams into features that may be used by the NLU module 210 for understanding the user input. In particular embodiments, the NLU module 210 may identify one or more of a domain, an intent, or a slot from the user input in a personalized and context-aware manner. As an example and not by way of limitation, a user input may comprise “show me how to get to the coffee shop.” The NLU module 210 may identify a particular coffee shop that the user wants to go to based on the user's personal information and the associated contextual information. In particular embodiments, the NLU module 210 may comprise a lexicon of a particular language, a parser, and grammar rules to partition sentences into an internal representation. The NLU module 210 may also comprise one or more programs that perform naive semantics or stochastic semantic analysis, and may further use pragmatics to understand a user input. In particular embodiments, the parser may be based on a deep learning architecture comprising multiple long-short term memory (LSTM) networks. As an example and not by way of limitation, the parser may be based on a recurrent neural network grammar (RNNG) model, which is a type of recurrent and recursive LSTM algorithm. More information on natural-language understanding (NLU) may be found in U.S. patent application Ser. No. 16/011,062, filed 18 Jun. 2018, U.S. patent application Ser. No. 16/025,317, filed 2 Jul. 2018, and U.S. patent application Ser. No. 16/038,120, filed 17 Jul. 2018, each of which is incorporated by reference.

In particular embodiments, the output of the NLU module 210 may be sent to the entity resolution module 212 to resolve relevant entities. Entities may include, for example, unique users or concepts, each of which may have a unique identifier (ID). The entities may include one or more of a real-world entity (from general knowledge base), a user entity (from user memory), a contextual entity (device context/dialog context), or a value resolution (numbers, datetime, etc.). In particular embodiments, the entity resolution module 212 may comprise domain entity resolution 340 and generic entity resolution 342. The entity resolution module 212 may execute generic and domain-specific entity resolution. The generic entity resolution 342 may resolve the entities by categorizing the slots and meta slots into different generic topics. The domain entity resolution 340 may resolve the entities by categorizing the slots and meta slots into different domains. As an example and not by way of limitation, in response to the input of an inquiry of the advantages of a particular brand of electric car, the generic entity resolution 342 may resolve the referenced brand of electric car as vehicle and the domain entity resolution 340 may resolve the referenced brand of electric car as electric car.

In particular embodiments, entities may be resolved based on knowledge 350 about the world and the user. The assistant system 140 may extract ontology data from the graphs 352. As an example and not by way of limitation, the graphs 352 may comprise one or more of a knowledge graph, a social graph, or a concept graph. The ontology data may comprise the structural relationship between different slots/meta-slots and domains. The ontology data may also comprise information of how the slots/meta-slots may be grouped, related within a hierarchy where the higher level comprises the domain, and subdivided according to similarities and differences. For example, the knowledge graph may comprise a plurality of entities. Each entity may comprise a single record associated with one or more attribute values. The particular record may be associated with a unique entity identifier. Each record may have diverse values for an attribute of the entity. Each attribute value may be associated with a confidence probability and/or a semantic weight. A confidence probability for an attribute value represents a probability that the value is accurate for the given attribute. A semantic weight for an attribute value may represent how the value semantically appropriate for the given attribute considering all the available information. For example, the knowledge graph may comprise an entity of a book titled “BookName”, which may include information extracted from multiple content sources (e.g., an online social network, online encyclopedias, book review sources, media databases, and entertainment content sources), which may be deduped, resolved, and fused to generate the single unique record for the knowledge graph. In this example, the entity titled “BookName” may be associated with a “fantasy” attribute value for a “genre” entity attribute. More information on the knowledge graph may be found in U.S. patent application Ser. No. 16/048,049, filed 27 Jul. 2018, and U.S. patent application Ser. No. 16/048,101, filed 27 Jul. 2018, each of which is incorporated by reference.

In particular embodiments, the assistant user memory (AUM) 354 may comprise user episodic memories which help determine how to assist a user more effectively. The AUM 354 may be the central place for storing, retrieving, indexing, and searching over user data. As an example and not by way of limitation, the AUM 354 may store information such as contacts, photos, reminders, etc. Additionally, the AUM 354 may automatically synchronize data to the server and other devices (only for non-sensitive data). As an example and not by way of limitation, if the user sets a nickname for a contact on one device, all devices may synchronize and get that nickname based on the AUM 354. In particular embodiments, the AUM 354 may first prepare events, user state, reminder, and trigger state for storing in a data store. Memory node identifiers (ID) may be created to store entry objects in the AUM 354, where an entry may be some piece of information about the user (e.g., photo, reminder, etc.) As an example and not by way of limitation, the first few bits of the memory node ID may indicate that this is a memory node ID type, the next bits may be the user ID, and the next bits may be the time of creation. The AUM 354 may then index these data for retrieval as needed. Index ID may be created for such purpose. In particular embodiments, given an “index key” (e.g., PHOTO_LOCATION) and “index value” (e.g., “San Francisco”), the AUM 354 may get a list of memory IDs that have that attribute (e.g., photos in San Francisco). As an example and not by way of limitation, the first few bits may indicate this is an index ID type, the next bits may be the user ID, and the next bits may encode an “index key” and “index value”. The AUM 354 may further conduct information retrieval with a flexible query language. Relation index ID may be created for such purpose. In particular embodiments, given a source memory node and an edge type, the AUM 354 may get memory IDs of all target nodes with that type of outgoing edge from the source. As an example and not by way of limitation, the first few bits may indicate this is a relation index ID type, the next bits may be the user ID, and the next bits may be a source node ID and edge type. In particular embodiments, the AUM 354 may help detect concurrent updates of different events. More information on episodic memories may be found in U.S. patent application Ser. No. 16/552,559, filed 27 Aug. 2019, which is incorporated by reference.

In particular embodiments, the entity resolution module 212 may use different techniques to resolve different types of entities. For real-world entities, the entity resolution module 212 may use a knowledge graph to resolve the span to the entities, such as “music track”, “movie”, etc. For user entities, the entity resolution module 212 may use user memory or some agents to resolve the span to user-specific entities, such as “contact”, “reminders”, or “relationship”. For contextual entities, the entity resolution module 212 may perform coreference based on information from the context engine 220 to resolve the references to entities in the context, such as “him”, “her”, “the first one”, or “the last one”. In particular embodiments, for coreference, the entity resolution module 212 may create references for entities determined by the NLU module 210. The entity resolution module 212 may then resolve these references accurately. As an example and not by way of limitation, a user input may comprise “find me the nearest grocery store and direct me there”. Based on coreference, the entity resolution module 212 may interpret “there” as “the nearest grocery store”. In particular embodiments, coreference may depend on the information from the context engine 220 and the dialog manager 216 so as to interpret references with improved accuracy. In particular embodiments, the entity resolution module 212 may additionally resolve an entity under the context (device context or dialog context), such as, for example, the entity shown on the screen or an entity from the last conversation history. For value resolutions, the entity resolution module 212 may resolve the mention to exact value in standardized form, such as numerical value, date time, address, etc.

In particular embodiments, the entity resolution module 212 may first perform a check on applicable privacy constraints in order to guarantee that performing entity resolution does not violate any applicable privacy policies. As an example and not by way of limitation, an entity to be resolved may be another user who specifies in their privacy settings that their identity should not be searchable on the online social network. In this case, the entity resolution module 212 may refrain from returning that user's entity identifier in response to a user input. By utilizing the described information obtained from the social graph, the knowledge graph, the concept graph, and the user profile, and by complying with any applicable privacy policies, the entity resolution module 212 may resolve entities associated with a user input in a personalized, context-aware, and privacy-protected manner.

In particular embodiments, the entity resolution module 212 may work with the ASR module 208 to perform entity resolution. The following example illustrates how the entity resolution module 212 may resolve an entity name. The entity resolution module 212 may first expand names associated with a user into their respective normalized text forms as phonetic consonant representations which may be phonetically transcribed using a double metaphone algorithm. The entity resolution module 212 may then determine an n-best set of candidate transcriptions and perform a parallel comprehension process on all of the phonetic transcriptions in the n-best set of candidate transcriptions. In particular embodiments, each transcription that resolves to the same intent may then be collapsed into a single intent. Each intent may then be assigned a score corresponding to the highest scoring candidate transcription for that intent. During the collapse, the entity resolution module 212 may identify various possible text transcriptions associated with each slot, correlated by boundary timing offsets associated with the slot's transcription. The entity resolution module 212 may then extract a subset of possible candidate transcriptions for each slot from a plurality (e.g., 1000) of candidate transcriptions, regardless of whether they are classified to the same intent. In this manner, the slots and intents may be scored lists of phrases. In particular embodiments, a new or running task capable of handling the intent may be identified and provided with the intent (e.g., a message composition task for an intent to send a message to another user). The identified task may then trigger the entity resolution module 212 by providing it with the scored lists of phrases associated with one of its slots and the categories against which it should be resolved. As an example and not by way of limitation, if an entity attribute is specified as “friend,” the entity resolution module 212 may run every candidate list of terms through the same expansion that may be run at matcher compilation time. Each candidate expansion of the terms may be matched in the precompiled trie matching structure. Matches may be scored using a function based at least in part on the transcribed input, matched form, and friend name. As another example and not by way of limitation, if an entity attribute is specified as “celebrity/notable person,” the entity resolution module 212 may perform parallel searches against the knowledge graph for each candidate set of terms for the slot output from the ASR module 208. The entity resolution module 212 may score matches based on matched person popularity and ASR-provided score signal. In particular embodiments, when the memory category is specified, the entity resolution module 212 may perform the same search against user memory. The entity resolution module 212 may crawl backward through user memory and attempt to match each memory (e.g., person recently mentioned in conversation, or seen and recognized via visual signals, etc.). For each entity, the entity resolution module 212 may employ matching similarly to how friends are matched (i.e., phonetic). In particular embodiments, scoring may comprise a temporal decay factor associated with a recency with which the name was previously mentioned. The entity resolution module 212 may further combine, sort, and dedupe all matches. In particular embodiments, the task may receive the set of candidates. When multiple high scoring candidates are present, the entity resolution module 212 may perform user-facilitated disambiguation (e.g., getting real-time user feedback from users on these candidates).

In particular embodiments, the context engine 220 may help the entity resolution module 212 improve entity resolution. The context engine 220 may comprise offline aggregators and an online inference service. The offline aggregators may process a plurality of data associated with the user that are collected from a prior time window. As an example and not by way of limitation, the data may include news feed posts/comments, interactions with news feed posts/comments, search history, etc., that are collected during a predetermined timeframe (e.g., from a prior 90-day window). The processing result may be stored in the context engine 220 as part of the user profile. The user profile of the user may comprise user profile data including demographic information, social information, and contextual information associated with the user. The user profile data may also include user interests and preferences on a plurality of topics, aggregated through conversations on news feed, search logs, messaging platforms, etc. The usage of a user profile may be subject to privacy constraints to ensure that a user's information can be used only for his/her benefit, and not shared with anyone else. More information on user profiles may be found in U.S. patent application Ser. No. 15/967,239, filed 30 Apr. 2018, which is incorporated by reference. In particular embodiments, the online inference service may analyze the conversational data associated with the user that are received by the assistant system 140 at a current time. The analysis result may be stored in the context engine 220 also as part of the user profile. In particular embodiments, both the offline aggregators and online inference service may extract personalization features from the plurality of data. The extracted personalization features may be used by other modules of the assistant system 140 to better understand user input. In particular embodiments, the entity resolution module 212 may process the information from the context engine 220 (e.g., a user profile) in the following steps based on natural-language processing (NLP). In particular embodiments, the entity resolution module 212 may tokenize text by text normalization, extract syntax features from text, and extract semantic features from text based on NLP. The entity resolution module 212 may additionally extract features from contextual information, which is accessed from dialog history between a user and the assistant system 140. The entity resolution module 212 may further conduct global word embedding, domain-specific embedding, and/or dynamic embedding based on the contextual information. The processing result may be annotated with entities by an entity tagger. Based on the annotations, the entity resolution module 212 may generate dictionaries. In particular embodiments, the dictionaries may comprise global dictionary features which can be updated dynamically offline. The entity resolution module 212 may rank the entities tagged by the entity tagger. In particular embodiments, the entity resolution module 212 may communicate with different graphs 352 including one or more of the social graph, the knowledge graph, or the concept graph to extract ontology data that is relevant to the retrieved information from the context engine 220. In particular embodiments, the entity resolution module 212 may further resolve entities based on the user profile, the ranked entities, and the information from the graphs 352.

In particular embodiments, the entity resolution module 212 may be driven by the task (corresponding to an agent 228). This inversion of processing order may make it possible for domain knowledge present in a task to be applied to pre-filter or bias the set of resolution targets when it is obvious and appropriate to do so. As an example and not by way of limitation, for the utterance “who is John?” no clear category is implied in the utterance. Therefore, the entity resolution module 212 may resolve “John” against everything. As another example and not by way of limitation, for the utterance “send a message to John”, the entity resolution module 212 may easily determine “John” refers to a person that one can message. As a result, the entity resolution module 212 may bias the resolution to a friend. As another example and not by way of limitation, for the utterance “what is John's most famous album?” To resolve “John”, the entity resolution module 212 may first determine the task corresponding to the utterance, which is finding a music album. The entity resolution module 212 may determine that entities related to music albums include singers, producers, and recording studios. Therefore, the entity resolution module 212 may search among these types of entities in a music domain to resolve “John.”

In particular embodiments, the output of the entity resolution module 212 may be sent to the dialog manager 216 to advance the flow of the conversation with the user. The dialog manager 216 may be an asynchronous state machine that repeatedly updates the state and selects actions based on the new state. The dialog manager 216 may additionally store previous conversations between the user and the assistant system 140. In particular embodiments, the dialog manager 216 may conduct dialog optimization. Dialog optimization relates to the challenge of understanding and identifying the most likely branching options in a dialog with a user. As an example and not by way of limitation, the assistant system 140 may implement dialog optimization techniques to obviate the need to confirm who a user wants to call because the assistant system 140 may determine a high confidence that a person inferred based on context and available data is the intended recipient. In particular embodiments, the dialog manager 216 may implement reinforcement learning frameworks to improve the dialog optimization. The dialog manager 216 may comprise dialog intent resolution 356, the dialog state tracker 218, and the action selector 222. In particular embodiments, the dialog manager 216 may execute the selected actions and then call the dialog state tracker 218 again until the action selected requires a user response, or there are no more actions to execute. Each action selected may depend on the execution result from previous actions. In particular embodiments, the dialog intent resolution 356 may resolve the user intent associated with the current dialog session based on dialog history between the user and the assistant system 140. The dialog intent resolution 356 may map intents determined by the NLU module 210 to different dialog intents. The dialog intent resolution 356 may further rank dialog intents based on signals from the NLU module 210, the entity resolution module 212, and dialog history between the user and the assistant system 140.

In particular embodiments, the dialog state tracker 218 may use a set of operators to track the dialog state. The operators may comprise necessary data and logic to update the dialog state. Each operator may act as delta of the dialog state after processing an incoming user input. In particular embodiments, the dialog state tracker 218 may a comprise a task tracker, which may be based on task specifications and different rules. The dialog state tracker 218 may also comprise a slot tracker and coreference component, which may be rule based and/or recency based. The coreference component may help the entity resolution module 212 to resolve entities. In alternative embodiments, with the coreference component, the dialog state tracker 218 may replace the entity resolution module 212 and may resolve any references/mentions and keep track of the state. In particular embodiments, the dialog state tracker 218 may convert the upstream results into candidate tasks using task specifications and resolve arguments with entity resolution. Both user state (e.g., user's current activity) and task state (e.g., triggering conditions) may be tracked. Given the current state, the dialog state tracker 218 may generate candidate tasks the assistant system 140 may process and perform for the user. As an example and not by way of limitation, candidate tasks may include “show suggestion,” “get weather information,” or “take photo.” In particular embodiments, the dialog state tracker 218 may generate candidate tasks based on available data from, for example, a knowledge graph, a user memory, and a user task history. In particular embodiments, the dialog state tracker 218 may then resolve the triggers object using the resolved arguments. As an example and not by way of limitation, a user input “remind me to call mom when she's online and I'm home tonight” may perform the conversion from the NLU output to the triggers representation by the dialog state tracker 218 as illustrated in Table 1 below:

TABLE 1
Example Conversion from NLU Output to Triggers Representation

| NLU Ontology Representation: | | Triggers Representation: |
|---|---|---|
| [IN:CREATE_SMART_REMINDER | → | Triggers: { |
| Remind me to | | andTriggers: [ |
| [SL:TODO call mom] when | | condition: {ContextualEvent(mom is |
| [SL:TRIGGER_CONJUNCTION | | online)}, |
| [IN:GET_TRIGGER | | condition: {ContextualEvent(location is |
| [SL:TRIGGER_SOCIAL_UPDATE | | home)}, |
| she's online] and I'm | | condition: {ContextualEvent(time is |
| [SL:TRIGGER_LOCATION home] | | tonight)}]))]} |
| [SL:DATE_TIME tonight] | | |
| ] | | |
| ] | | |
| ] | | |

In the above example, “mom,” “home,” and “tonight” are represented by their respective entities: personEntity, locationEntity, datetimeEntity.

In particular embodiments, the dialog manager 216 may map events determined by the context engine 220 to actions. As an example and not by way of limitation, an action may be a natural-language generation (NLG) action, a display or overlay, a device action, or a retrieval action. The dialog manager 216 may also perform context tracking and interaction management. Context tracking may comprise aggregating real-time stream of events into a unified user state. Interaction management may comprise selecting optimal action in each state. In particular embodiments, the dialog state tracker 218 may perform context tracking (i.e., tracking events related to the user). To support processing of event streams, the dialog state tracker 218a may use an event handler (e.g., for disambiguation, confirmation, request) that may consume various types of events and update an internal assistant state. Each event type may have one or more handlers. Each event handler may be modifying a certain slice of the assistant state. In particular embodiments, the event handlers may be operating on disjoint subsets of the state (i.e., only one handler may have write-access to a particular field in the state). In particular embodiments, all event handlers may have an opportunity to process a given event. As an example and not by way of limitation, the dialog state tracker 218 may run all event handlers in parallel on every event, and then may merge the state updates proposed by each event handler (e.g., for each event, most handlers may return a NULL update).

In particular embodiments, the dialog state tracker 218 may work as any programmatic handler (logic) that requires versioning. In particular embodiments, instead of directly altering the dialog state, the dialog state tracker 218 may be a side-effect free component and generate n-best candidates of dialog state update operators that propose updates to the dialog state. The dialog state tracker 218 may comprise intent resolvers containing logic to handle different types of NLU intent based on the dialog state and generate the operators. In particular embodiments, the logic may be organized by intent handler, such as a disambiguation intent handler to handle the intents when the assistant system 140 asks for disambiguation, a confirmation intent handler that comprises the logic to handle confirmations, etc. Intent resolvers may combine the turn intent together with the dialog state to generate the contextual updates for a conversation with the user. A slot resolution component may then recursively resolve the slots in the update operators with resolution providers including the knowledge graph and domain agents. In particular embodiments, the dialog state tracker 218 may update/rank the dialog state of the current dialog session. As an example and not by way of limitation, the dialog state tracker 218 may update the dialog state as “completed” if the dialog session is over. As another example and not by way of limitation, the dialog state tracker 218 may rank the dialog state based on a priority associated with it.

In particular embodiments, the dialog state tracker 218 may communicate with the action selector 222 about the dialog intents and associated content objects. In particular embodiments, the action selector 222 may rank different dialog hypotheses for different dialog intents. The action selector 222 may take candidate operators of dialog state and consult the dialog policies 360 to decide what actions should be executed. In particular embodiments, a dialog policy 360 may a tree-based policy, which is a pre-constructed dialog plan. Based on the current dialog state, a dialog policy 360 may choose a node to execute and generate the corresponding actions. As an example and not by way of limitation, the tree-based policy may comprise topic grouping nodes and dialog action (leaf) nodes. In particular embodiments, a dialog policy 360 may also comprise a data structure that describes an execution plan of an action by an agent 228. A dialog policy 360 may further comprise multiple goals related to each other through logical operators. In particular embodiments, a goal may be an outcome of a portion of the dialog policy and it may be constructed by the dialog manager 216. A goal may be represented by an identifier (e.g., string) with one or more named arguments, which parameterize the goal. As an example and not by way of limitation, a goal with its associated goal argument may be represented as {confirm_artist, args:{artist: “Madonna” }}. In particular embodiments, goals may be mapped to leaves of the tree of the tree-structured representation of the dialog policy 360.

In particular embodiments, the assistant system 140 may use hierarchical dialog policies 360 with general policy 362 handling the cross-domain business logic and task policies 364 handling the task/domain specific logic. The general policy 362 may be used for actions that are not specific to individual tasks. The general policy 362 may be used to determine task stacking and switching, proactive tasks, notifications, etc. The general policy 362 may comprise handling low-confidence intents, internal errors, unacceptable user response with retries, and/or skipping or inserting confirmation based on ASR or NLU confidence scores. The general policy 362 may also comprise the logic of ranking dialog state update candidates from the dialog state tracker 218 output and pick the one to update (such as picking the top ranked task intent). In particular embodiments, the assistant system 140 may have a particular interface for the general policy 362, which allows for consolidating scattered cross-domain policy/business-rules, especial those found in the dialog state tracker 218, into a function of the action selector 222. The interface for the general policy 362 may also allow for authoring of self-contained sub-policy units that may be tied to specific situations or clients (e.g., policy functions that may be easily switched on or off based on clients, situation). The interface for the general policy 362 may also allow for providing a layering of policies with back-off, i.e., multiple policy units, with highly specialized policy units that deal with specific situations being backed up by more general policies 362 that apply in wider circumstances. In this context the general policy 362 may alternatively comprise intent or task specific policy.

In particular embodiments, a task policy 364 may comprise the logic for action selector 222 based on the task and current state. The task policy 364 may be dynamic and ad-hoc. In particular embodiments, the types of task policies 364 may include one or more of the following types: (1) manually crafted tree-based dialog plans; (2) coded policy that directly implements the interface for generating actions; (3) configurator-specified slot-filling tasks; or (4) machine-learning model based policy learned from data. In particular embodiments, the assistant system 140 may bootstrap new domains with rule-based logic and later refine the task policies 364 with machine-learning models. In particular embodiments, the general policy 362 may pick one operator from the candidate operators to update the dialog state, followed by the selection of a user facing action by a task policy 364. Once a task is active in the dialog state, the corresponding task policy 364 may be consulted to select right actions.

In particular embodiments, the action selector 222 may select an action based on one or more of the event determined by the context engine 220, the dialog intent and state, the associated content objects, and the guidance from dialog policies 360. Each dialog policy 360 may be subscribed to specific conditions over the fields of the state. After an event is processed and the state is updated, the action selector 222 may run a fast search algorithm (e.g., similarly to the Boolean satisfiability) to identify which policies should be triggered based on the current state. In particular embodiments, if multiple policies are triggered, the action selector 222 may use a tie-breaking mechanism to pick a particular policy. Alternatively, the action selector 222 may use a more sophisticated approach which may dry-run each policy and then pick a particular policy which may be determined to have a high likelihood of success. In particular embodiments, mapping events to actions may result in several technical advantages for the assistant system 140. One technical advantage may include that each event may be a state update from the user or the user's physical/digital environment, which may or may not trigger an action from assistant system 140. Another technical advantage may include possibilities to handle rapid bursts of events (e.g., user enters a new building and sees many people) by first consuming all events to update state, and then triggering action(s) from the final state. Another technical advantage may include consuming all events into a single global assistant state.

In particular embodiments, the action selector 222 may take the dialog state update operators as part of the input to select the dialog action. The execution of the dialog action may generate a set of expectations to instruct the dialog state tracker 218 to handle future turns. In particular embodiments, an expectation may be used to provide context to the dialog state tracker 218 when handling the user input from next turn. As an example and not by way of limitation, slot request dialog action may have the expectation of proving a value for the requested slot. In particular embodiments, both the dialog state tracker 218 and the action selector 222 may not change the dialog state until the selected action is executed. This may allow the assistant system 140 to execute the dialog state tracker 218 and the action selector 222 for processing speculative ASR results and to do n-best ranking with dry runs.

In particular embodiments, the action selector 222 may call different agents 228 for task execution. Meanwhile, the dialog manager 216 may receive an instruction to update the dialog state. As an example and not by way of limitation, the update may comprise awaiting agents' 228 response. An agent 228 may select among registered content providers to complete the action. The data structure may be constructed by the dialog manager 216 based on an intent and one or more slots associated with the intent. In particular embodiments, the agents 228 may comprise first-party agents and third-party agents. In particular embodiments, first-party agents may comprise internal agents that are accessible and controllable by the assistant system 140 (e.g. agents associated with services provided by the online social network, such as messaging services or photo-share services). In particular embodiments, third-party agents may comprise external agents that the assistant system 140 has no control over (e.g., third-party online music application agents, ticket sales agents). The first-party agents may be associated with first-party providers that provide content objects and/or services hosted by the social-networking system 160. The third-party agents may be associated with third-party providers that provide content objects and/or services hosted by the third-party system 170. In particular embodiments, each of the first-party agents or third-party agents may be designated for a particular domain. As an example and not by way of limitation, the domain may comprise weather, transportation, music, shopping, social, videos, photos, events, locations, and/or work. In particular embodiments, the assistant system 140 may use a plurality of agents 228 collaboratively to respond to a user input. As an example and not by way of limitation, the user input may comprise “direct me to my next meeting.” The assistant system 140 may use a calendar agent to retrieve the location of the next meeting. The assistant system 140 may then use a navigation agent to direct the user to the next meeting.

In particular embodiments, the dialog manager 216 may support multi-turn compositional resolution of slot mentions. For a compositional parse from the NLU module 210, the resolver may recursively resolve the nested slots. The dialog manager 216 may additionally support disambiguation for the nested slots. As an example and not by way of limitation, the user input may be “remind me to call Alex”. The resolver may need to know which Alex to call before creating an actionable reminder to-do entity. The resolver may halt the resolution and set the resolution state when further user clarification is necessary for a particular slot. The general policy 362 may examine the resolution state and create corresponding dialog action for user clarification. In dialog state tracker 218, based on the user input and the last dialog action, the dialog manager 216 may update the nested slot. This capability may allow the assistant system 140 to interact with the user not only to collect missing slot values but also to reduce ambiguity of more complex/ambiguous utterances to complete the task. In particular embodiments, the dialog manager 216 may further support requesting missing slots in a nested intent and multi-intent user inputs (e.g., “take this photo and send it to Dad”). In particular embodiments, the dialog manager 216 may support machine-learning models for more robust dialog experience. As an example and not by way of limitation, the dialog state tracker 218 may use neural network based models (or any other suitable machine-learning models) to model belief over task hypotheses. As another example and not by way of limitation, for action selector 222, highest priority policy units may comprise white-list/black-list overrides, which may have to occur by design; middle priority units may comprise machine-learning models designed for action selection; and lower priority units may comprise rule-based fallbacks when the machine-learning models elect not to handle a situation. In particular embodiments, machine-learning model based general policy unit may help the assistant system 140 reduce redundant disambiguation or confirmation steps, thereby reducing the number of turns to execute the user input.

In particular embodiments, the determined actions by the action selector 222 may be sent to the delivery system 230. The delivery system 230 may comprise a CU composer 370, a response generation component 380, a dialog state writing component 382, and a text-to-speech (TTS) component 390. Specifically, the output of the action selector 222 may be received at the CU composer 370. In particular embodiments, the output from the action selector 222 may be formulated as a <k,c,u,d> tuple, in which k indicates a knowledge source, c indicates a communicative goal, u indicates a user model, and d indicates a discourse model.

In particular embodiments, the CU composer 370 may generate a communication content for the user using a natural-language generation (NLG) component 372. In particular embodiments, the NLG component 372 may use different language models and/or language templates to generate natural-language outputs. The generation of natural-language outputs may be application specific. The generation of natural-language outputs may be also personalized for each user. In particular embodiments, the NLG component 372 may comprise a content determination component, a sentence planner, and a surface realization component. The content determination component may determine the communication content based on the knowledge source, communicative goal, and the user's expectations. As an example and not by way of limitation, the determining may be based on a description logic. The description logic may comprise, for example, three fundamental notions which are individuals (representing objects in the domain), concepts (describing sets of individuals), and roles (representing binary relations between individuals or concepts). The description logic may be characterized by a set of constructors that allow the natural-language generator to build complex concepts/roles from atomic ones. In particular embodiments, the content determination component may perform the following tasks to determine the communication content. The first task may comprise a translation task, in which the input to the NLG component 372 may be translated to concepts. The second task may comprise a selection task, in which relevant concepts may be selected among those resulted from the translation task based on the user model. The third task may comprise a verification task, in which the coherence of the selected concepts may be verified. The fourth task may comprise an instantiation task, in which the verified concepts may be instantiated as an executable file that can be processed by the NLG component 372. The sentence planner may determine the organization of the communication content to make it human understandable. The surface realization component may determine specific words to use, the sequence of the sentences, and the style of the communication content.

In particular embodiments, the CU composer 370 may also determine a modality of the generated communication content using the UI payload generator 374. Since the generated communication content may be considered as a response to the user input, the CU composer 370 may additionally rank the generated communication content using a response ranker 376. As an example and not by way of limitation, the ranking may indicate the priority of the response. In particular embodiments, the CU composer 370 may comprise a natural-language synthesis (NLS) component that may be separate from the NLG component 372. The NLS component may specify attributes of the synthesized speech generated by the CU composer 370, including gender, volume, pace, style, or register, in order to customize the response for a particular user, task, or agent. The NLS component may tune language synthesis without engaging the implementation of associated tasks. In particular embodiments, the CU composer 370 may check privacy constraints associated with the user to make sure the generation of the communication content follows the privacy policies. More information on customizing natural-language generation (NLG) may be found in U.S. patent application Ser. No. 15/967,279, filed 30 Apr. 2018, and U.S. patent application Ser. No. 15/966,455, filed 30 Apr. 2018, which is incorporated by reference.

In particular embodiments, the delivery system 230 may perform different tasks based on the output of the CU composer 370. These tasks may include writing (i.e., storing/updating) the dialog state into the data store 330 using the dialog state writing component 382 and generating responses using the response generation component 380. In particular embodiments, the output of the CU composer 370 may be additionally sent to the TTS component 390 if the determined modality of the communication content is audio. In particular embodiments, the output from the delivery system 230 comprising one or more of the generated responses, the communication content, or the speech generated by the TTS component 390 may be then sent back to the dialog manager 216.

In particular embodiments, the orchestrator 206 may determine, based on the output of the entity resolution module 212, whether to processing a user input on the client system 130 or on the server, or in the third operational mode (i.e., blended mode) using both. Besides determining how to process the user input, the orchestrator 206 may receive the results from the agents 228 and/or the results from the delivery system 230 provided by the dialog manager 216. The orchestrator 206 may then forward these results to the arbitrator 226. The arbitrator 226 may aggregate these results, analyze them, select the best result, and provide the selected result to the render output module 232. In particular embodiments, the arbitrator 226 may consult with dialog policies 360 to obtain the guidance when analyzing these results. In particular embodiments, the render output module 232 may generate a response that is suitable for the client system 130.

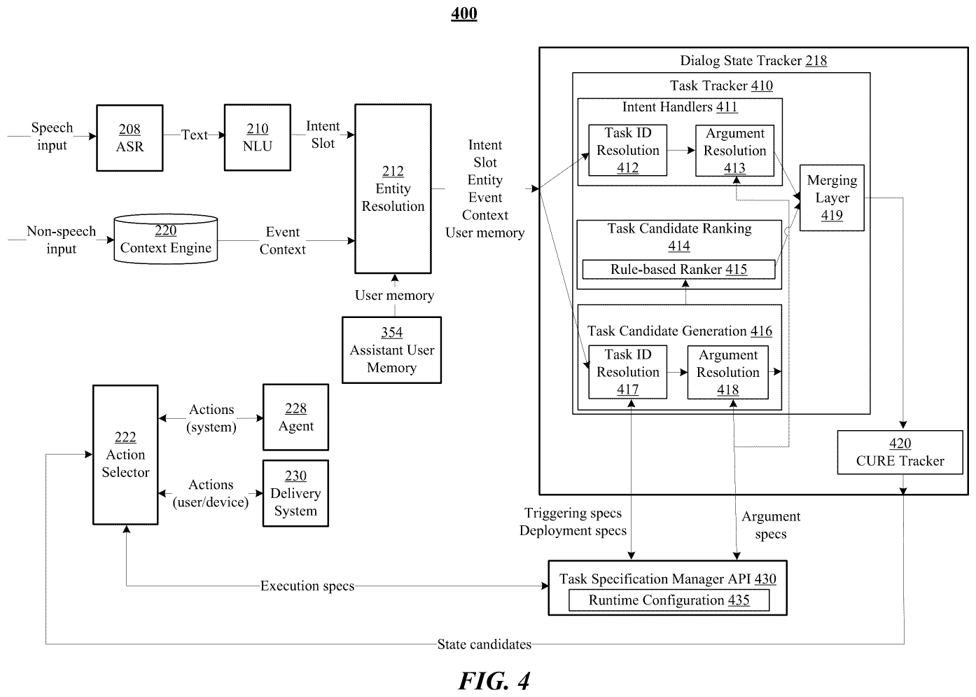

FIG. 4 illustrates an example task-centric flow diagram 400 of processing a user input. In particular embodiments, the assistant system 140 may assist users not only with voice-initiated experiences but also more proactive, multi-modal experiences that are initiated on understanding user context. In particular embodiments, the assistant system 140 may rely on assistant tasks for such purpose. An assistant task may be a central concept that is shared across the whole assistant stack to understand user intention, interact with the user and the world to complete the right task for the user. In particular embodiments, an assistant task may be the primitive unit of assistant capability. It may comprise data fetching, updating some state, executing some command, or complex tasks composed of a smaller set of tasks. Completing a task correctly and successfully to deliver the value to the user may be the goal that the assistant system 140 is optimized for. In particular embodiments, an assistant task may be defined as a capability or a feature. The assistant task may be shared across multiple product surfaces if they have exactly the same requirements so it may be easily tracked. It may also be passed from device to device, and easily picked up mid-task by another device since the primitive unit is consistent. In addition, the consistent format of the assistant task may allow developers working on different modules in the assistant stack to more easily design around it. Furthermore, it may allow for task sharing. As an example and not by way of limitation, if a user is listening to music on smart glasses, the user may say “play this music on my phone.” In the event that the phone hasn't been woken or has a task to execute, the smart glasses may formulate a task that is provided to the phone, which may then be executed by the phone to start playing music. In particular embodiments, the assistant task may be retained by each surface separately if they have different expected behaviors. In particular embodiments, the assistant system 140 may identify the right task based on user inputs in different modality or other signals, conduct conversation to collect all necessary information, and complete that task with action selector 222 implemented internally or externally, on server or locally product surfaces. In particular embodiments, the assistant stack may comprise a set of processing components from wake-up, recognizing user inputs, understanding user intention, reasoning about the tasks, fulfilling a task to generate natural-language response with voices.

In particular embodiments, the user input may comprise speech input. The speech input may be received at the ASR module 208 for extracting the text transcription from the speech input. The ASR module 208 may use statistical models to determine the most likely sequences of words that correspond to a given portion of speech received by the assistant system 140 as audio input. The models may include one or more of hidden Markov models, neural networks, deep learning models, or any combination thereof. The received audio input may be encoded into digital data at a particular sampling rate (e.g., 16, 44.1, or 96 kHz) and with a particular number of bits representing each sample (e.g., 8, 16, of 24 bits).

In particular embodiments, the ASR module 208 may comprise one or more of a grapheme-to-phoneme (G2P) model, a pronunciation learning model, a personalized acoustic model, a personalized language model (PLM), or an end-pointing model. In particular embodiments, the grapheme-to-phoneme (G2P) model may be used to determine a user's grapheme-to-phoneme style (i.e., what it may sound like when a particular user speaks a particular word). In particular embodiments, the personalized acoustic model may be a model of the relationship between audio signals and the sounds of phonetic units in the language. Therefore, such personalized acoustic model may identify how a user's voice sounds. The personalized acoustical model may be generated using training data such as training speech received as audio input and the corresponding phonetic units that correspond to the speech. The personalized acoustical model may be trained or refined using the voice of a particular user to recognize that user's speech. In particular embodiments, the personalized language model may then determine the most likely phrase that corresponds to the identified phonetic units for a particular audio input. The personalized language model may be a model of the probabilities that various word sequences may occur in the language. The sounds of the phonetic units in the audio input may be matched with word sequences using the personalized language model, and greater weights may be assigned to the word sequences that are more likely to be phrases in the language. The word sequence having the highest weight may be then selected as the text that corresponds to the audio input. In particular embodiments, the personalized language model may also be used to predict what words a user is most likely to say given a context. In particular embodiments, the end-pointing model may detect when the end of an utterance is reached. In particular embodiments, based at least in part on a limited computing power of the client system 130, the assistant system 140 may optimize the personalized language model at runtime during the client-side process. As an example and not by way of limitation, the assistant system 140 may pre-compute a plurality of personalized language models for a plurality of possible subjects a user may talk about. When a user input is associated with a request for assistance, the assistant system 140 may promptly switch between and locally optimize the pre-computed language models at runtime based on user activities. As a result, the assistant system 140 may preserve computational resources while efficiently identifying a subject matter associated with the user input. In particular embodiments, the assistant system 140 may also dynamically re-learn user pronunciations at runtime.

In particular embodiments, the user input may comprise non-speech input. The non-speech input may be received at the context engine 220 for determining events and context from the non-speech input. The context engine 220 may determine multi-modal events comprising voice/text intents, location updates, visual events, touch, gaze, gestures, activities, device/application events, and/or any other suitable type of events. The voice/text intents may depend on the ASR module 208 and the NLU module 210. The location updates may be consumed by the dialog manager 216 to support various proactive/reactive scenarios. The visual events may be based on person or object appearing in the user's field of view. These events may be consumed by the dialog manager 216 and recorded in transient user state to support visual co-reference (e.g., resolving “that” in “how much is that shirt?” and resolving “him” in “send him my contact”). The gaze, gesture, and activity may result in flags being set in the transient user state (e.g., user is running) which may condition the action selector 222. For the device/application events, if an application makes an update to the device state, this may be published to the assistant system 140 so that the dialog manager 216 may use this context (what is currently displayed to the user) to handle reactive and proactive scenarios. As an example and not by way of limitation, the context engine 220 may cause a push notification message to be displayed on a display screen of the user's client system 130. The user may interact with the push notification message, which may initiate a multi-modal event (e.g., an event workflow for replying to a message received from another user). Other example multi-modal events may include seeing a friend, seeing a landmark, being at home, running, starting a call with touch, taking a photo with touch, opening an application, etc. In particular embodiments, the context engine 220 may also determine world/social events based on world/social updates (e.g., weather changes, a friend getting online). The social updates may comprise events that a user is subscribed to, (e.g., friend's birthday, posts, comments, other notifications). These updates may be consumed by the dialog manager 216 to trigger proactive actions based on context (e.g., suggesting a user call a friend on their birthday, but only if the user is not focused on something else). As an example and not by way of limitation, receiving a message may be a social event, which may trigger the task of reading the message to the user.

In particular embodiments, the text transcription from the ASR module 208 may be sent to the NLU module 210. The NLU module 210 may process the text transcription and extract the user intention (i.e., intents) and parse the slots or parsing result based on the linguistic ontology. In particular embodiments, the intents and slots from the NLU module 210 and/or the events and contexts from the context engine 220 may be sent to the entity resolution module 212. In particular embodiments, the entity resolution module 212 may resolve entities associated with the user input based on the output from the NLU module 210 and/or the context engine 220. The entity resolution module 212 may use different techniques to resolve the entities, including accessing user memory from the assistant user memory (AUM) 354. In particular embodiments, the AUM 354 may comprise user episodic memories helpful for resolving the entities by the entity resolution module 212. The AUM 354 may be the central place for storing, retrieving, indexing, and searching over user data.

In particular embodiments, the entity resolution module 212 may provide one or more of the intents, slots, entities, events, context, or user memory to the dialog state tracker 218. The dialog state tracker 218 may identify a set of state candidates for a task accordingly, conduct interaction with the user to collect necessary information to fill the state, and call the action selector 222 to fulfill the task. In particular embodiments, the dialog state tracker 218 may comprise a task tracker 410. The task tracker 410 may track the task state associated with an assistant task. In particular embodiments, a task state may be a data structure persistent cross interaction turns and updates in real time to capture the state of the task during the whole interaction. The task state may comprise all the current information about a task execution status, such as arguments, confirmation status, confidence score, etc. Any incorrect or outdated information in the task state may lead to failure or incorrect task execution. The task state may also serve as a set of contextual information for many other components such as the ASR module 208, the NLU module 210, etc.

In particular embodiments, the task tracker 410 may comprise intent handlers 411, task candidate ranking module 414, task candidate generation module 416, and merging layer 419. In particular embodiments, a task may be identified by its ID name. The task ID may be used to associate corresponding component assets if it is not explicitly set in the task specification, such as dialog policy 360, agent execution, NLG dialog act, etc. Therefore, the output from the entity resolution module 212 may be received by a task ID resolution component 417 of the task candidate generation module 416 to resolve the task ID of the corresponding task. In particular embodiments, the task ID resolution component 417 may call a task specification manager API 430 to access the triggering specifications and deployment specifications for resolving the task ID. Given these specifications, the task ID resolution component 417 may resolve the task ID using intents, slots, dialog state, context, and user memory.

In particular embodiments, the technical specification of a task may be defined by a task specification. The task specification may be used by the assistant system 140 to trigger a task, conduct dialog conversation, and find a right execution module (e.g., agents 228) to execute the task. The task specification may be an implementation of the product requirement document. It may serve as the general contract and requirements that all the components agreed on. It may be considered as an assembly specification for a product, while all development partners deliver the modules based on the specification. In particular embodiments, an assistant task may be defined in the implementation by a specification. As an example and not by way of limitation, the task specification may be defined as the following categories. One category may be a basic task schema which comprises the basic identification information such as ID, name, and the schema of the input arguments. Another category may be a triggering specification, which is about how a task can be triggered, such as intents, event message ID, etc. Another category may be a conversational specification, which is for dialog manager 216 to conduct the conversation with users and systems. Another category may be an execution specification, which is about how the task will be executed and fulfilled. Another category may be a deployment specification, which is about how a feature will be deployed to certain surfaces, local, and group of users.

In particular embodiments, the task specification manager API 430 may be an API for accessing a task specification manager. The task specification manager may be a module in the runtime stack for loading the specifications from all the tasks and providing interfaces to access all the tasks specifications for detailed information or generating task candidates. In particular embodiments, the task specification manager may be accessible for all components in the runtime stack via the task specification manager API 430. The task specification manager may comprise a set of static utility functions to manage tasks with the task specification manager, such as filtering task candidates by platform. Before landing the task specification, the assistant system 140 may also dynamically load the task specifications to support end-to-end development on the development stage.

In particular embodiments, the task specifications may be grouped by domains and stored in runtime configurations 435. The runtime stack may load all the task specifications from the runtime configurations 435 during the building time. In particular embodiments, in the runtime configurations 435, for a domain, there may be a cconf file and a cinc file (e.g., sidechef_task.cconf and sidechef_task.inc). As an example and not by way of limitation, <domain>_tasks.cconf may comprise all the details of the task specifications. As another example and not by way of limitation, <domain>_tasks.cinc may provide a way to override the generated specification if there is no support for that feature yet.

In particular embodiments, a task execution may require a set of arguments to execute. Therefore, an argument resolution component 418 may resolve the argument names using the argument specifications for the resolved task ID. These arguments may be resolved based on NLU outputs (e.g., slot [SL:contact]), dialog state (e.g., short-term calling history), user memory (such as user preferences, location, long-term calling history, etc.), or device context (such as timer states, screen content, etc.). In particular embodiments, the argument modality may be text, audio, images or other structured data. The slot to argument mapping may be defined by a filling strategy and/or language ontology. In particular embodiments, given the task triggering specifications, the task candidate generation module 416 may look for the list of tasks to be triggered as task candidates based on the resolved task ID and arguments.

In particular embodiments, the generated task candidates may be sent to the task candidate ranking module 414 to be further ranked. The task candidate ranking module 414 may use a rule-based ranker 415 to rank them. In particular embodiments, the rule-based ranker 415 may comprise a set of heuristics to bias certain domain tasks. The ranking logic may be described as below with principles of context priority. In particular embodiments, the priority of a user specified task may be higher than an on-foreground task. The priority of the on-foreground task may be higher than a device-domain task when the intent is a meta intent. The priority of the device-domain task may be higher than a task of a triggering intent domain. As an example and not by way of limitation, the ranking may pick the task if the task domain is mentioned or specified in the utterance, such as “create a timer in TIMER app”. As another example and not by way of imitation, the ranking may pick the task if the task domain is on foreground or active state, such as “stop the timer” to stop the timer while the TIMER app is on foreground and there is an active timer. As yet another example and not by way of imitation, the ranking may pick the task if the intent is general meta intent, and the task is device control while there is no other active application or active state. As yet another example and not by way of imitation, the ranking may pick the task if the task is the same as the intent domain. In particular embodiments, the task candidate ranking module 414 may customize some more logic to check the match of intent/slot/entity types. The ranked task candidates may be sent to the merging layer 419.

In particular embodiments, the output from the entity resolution module 212 may also sent to a task ID resolution component 412 of the intent handlers 411. The task ID resolution component 412 may resolve the task ID of the corresponding task similarly to the task ID resolution component 417. In particular embodiments, the intent handlers 411 may additionally comprise an argument resolution component 413. The argument resolution component 413 may resolve the argument names using the argument specifications for the resolved task ID similarly to the argument resolution component 418. In particular embodiments, intent handlers 411 may deal with task agnostic features and may not be expressed within the task specifications which are task specific. Intent handlers 411 may output state candidates other than task candidates such as argument update, confirmation update, disambiguation update, etc. In particular embodiments, some tasks may require very complex triggering conditions or very complex argument filling logic that may not be reusable by other tasks even if they were supported in the task specifications (e.g., in-call voice commands, media tasks via [IN:PLAY_MEDIA], etc.). Intent handlers 411 may be also suitable for such type of tasks. In particular embodiments, the results from the intent handlers 411 may take precedence over the results from the task candidate ranking module 414. The results from the intent handlers 411 may be also sent to the merging layer 419.

In particular embodiments, the merging layer 419 may combine the results from the intent handlers 411 and the results from the task candidate ranking module 414. The dialog state tracker 218 may suggest each task as a new state for the dialog policies 360 to select from, thereby generating a list of state candidates. The merged results may be further sent to a conversational understanding reinforcement engine (CURE) tracker 420. In particular embodiments, the CURE tracker 420 may be a personalized learning process to improve the determination of the state candidates by the dialog state tracker 218 under different contexts using real-time user feedback. More information on conversational understanding reinforcement engine may be found in U.S. patent application Ser. No. 17/186,459, filed 26 Feb. 2021, which is incorporated by reference.

In particular embodiments, the state candidates generated by the CURE tracker 420 may be sent to the action selector 222. The action selector 222 may consult with the task policies 364, which may be generated from execution specifications accessed via the task specification manager API 430. In particular embodiments, the execution specifications may describe how a task should be executed and what actions the action selector 222 may need to take to complete the task.

In particular embodiments, the action selector 222 may determine actions associated with the system. Such actions may involve the agents 228 to execute. As a result, the action selector 222 may send the system actions to the agents 228 and the agents 228 may return the execution results of these actions. In particular embodiments, the action selector may determine actions associated with the user or device. Such actions may need to be executed by the delivery system 230. As a result, the action selector 222 may send the user/device actions to the delivery system 230 and the delivery system 230 may return the execution results of these actions.

The embodiments disclosed herein may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### Delivering Cohesive Assistant Experience Across Devices

In particular embodiments, the assistant system 140 may provide an assistant design system that is responsible for delivering a cohesive assistant experience across devices. The assistant product may be device-agnostic, which is being implemented across multiple types of devices. The assistant system 140 may make sure the assistant system 140 shows continuity consistently across all devices, while still staying balanced and harmonious with each device's form factor, environment, and experiences. In particular embodiments, implementing the assistant design system across devices may require updating the attention system, including brand expression (colors, avatar states, animation) and positioning and transcription components. Implementing the assistant design system may also require implementing the assistant layer (AL) logic, including adaptability and layout, behaviors and properties, interaction model, interaction patterns, leveraging native device components, and implementing capability to use operation system (OS) interface builder so user interface (UI) implementation can be shared across devices. Implementing the assistant design system may further require updating native experiences (e.g., reminders, weather, timers, alarms, communities), and leveraging native device components. Although this disclosure describes particular design systems in a particular manner, this disclosure contemplates any suitable design system in any suitable manner.

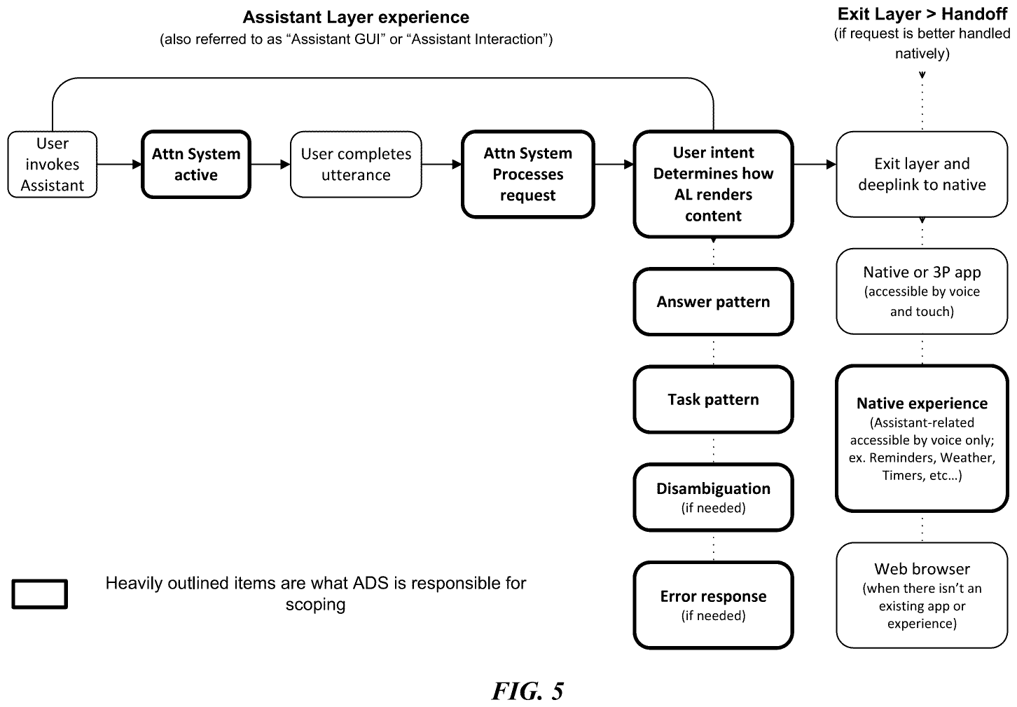

FIG. 5 illustrates an example flow diagram associated with the assistant design system. In particular embodiments, the assistant design system may be responsible for scoping the attention system active, attention system processing request, user intent determining how AL renders content, answer pattern, task pattern, disambiguation, error response, and native experience.

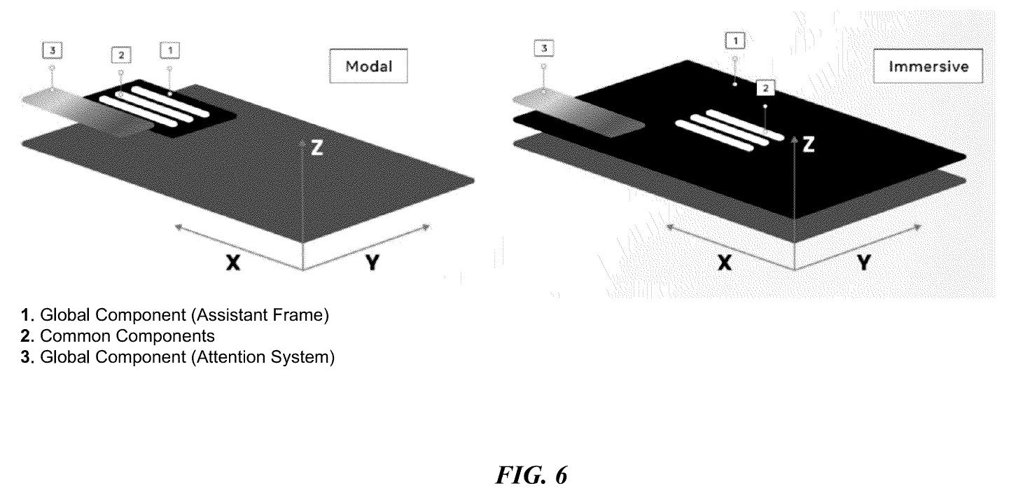

In particular embodiments, the assistant layer may comprise user experience (UX) guidelines for how the assistant system 140 expects users to interact with the assistant system 140, and provide rules, patterns, and components for how the assistant system 140 should be interacted with across devices. FIG. 6 illustrates an example diagram representing two frameworks for assistant interactions on smart tablets. From a design/user perspective, the assistant layer may be considered a distinct spatial layer that lives on top of all native UI in the z-layer of smart watches, VR devices, and smart tablets. The assistant layer may also include logic for how the assistant system 140 renders its output within four scalable frameworks, including interaction model and patterns. All assistant-layer capabilities and components may be inherited from experiences (pre-existing apps, services provided by an entity associated with the assistant system 140, and third-party providers). The assistant layer may never offer hidden functionality or use system components not already available in the device.

From an engineering perspective, as part of implementation, the capability of the assistant layer to use OS interface builder may be added, so UI implementation may be shared across devices. Leveraging the interface builder may allow the assistant system 140 to export XML files that can be reused on all devices, so we can design once and export once instead of design n times and implement n times (n represents the number of devices).

Much like responsive design, the assistant layer may scale layout according to context, device, and modality. There may be the following “snap points” of assistant layer framework across all devices. First may be headless, indicating voice-only and no visuals. When there is no screen (i.e., only a speaker) and showing UI may only serve as a distraction. For example, this may be used on smart glasses. Another may be bodiless, indicating voice-first and minimal visuals (widgets). When the user is in VR, and minimal visuals may allow for less disruption to the user's current fully immersive activity. GUI may appear as a widget, providing only the simplest information necessary in that moment. For example, this may be used on VR devices. Another may be modal, indicating voice-first and minimal visuals (cards). When the user is multi-tasking on a screen and simple visuals may assist in faster task completion. GUI may appear in card format, accommodating any information needed at the moment without interrupting the current task. For example, this may be used on smart tablets and mobile apps. Another may be immersive, indicating voice-first and full-screen visuals. When the user is far field, the screen size may be small, or the scenario may require focus. For example, this may be used on smart watches and smart tablets.

In particular embodiments, headless mode may always serve as the reference design. Visual UI in assistant layer may exist solely to complement voice experiences and empower users to make quick, informed decision which leads to saving time and steps. If a product has a screen, all UI rendered by assistant may follow a pre-existing interaction pattern already used in headless mode, and all assistant layer interactions may support end-to-end task completion via voice.

In particular embodiments, comparing modal with immersive, they may have same content and flow, but may be optimized for user context. The following criteria may inform when to use modal versus immersive. The first criteria may be perspective scale, i.e., what is the screen size and the user's distance to the screen? Another criteria may be user intent and disruption, i.e., does the user want to stay in their current context, or shift focus? Another criteria may be domain dependency, i.e., is a domain considered universal, surface specific, or surface agnostic? For example, the following scenarios describe when to use modal. When the app needs focus, modal may be well suited for on-screen multitasking while the user is interacting close up or with touch. When interruptions are disruptive, modal may be well suited for on-screen multitasking while the user is interacting close up or with touch. When context switching isn't ideal, modal may be built in mind for scenarios where the user might not want to leave their current context. As another example, the following scenarios describe when to use immersive. If the user is far field, immersive may scale full screen to improve legibility from a distance. If the screen size is small, immersive may optimize for pixel density since on-screen multitasking isn't possible on small displays. When the assistant needs complete focus, immersive may takeover interrupt contexts to draw attention to the screen in order to make decisions and improve legibility.

In particular embodiments, the assistant design system may use an app model to determine how assistant behaves with apps and environments. Any scenario that requires the user to switch from voice to another input may indicate a point of failure. The assistant design system may adopt an interaction model that embraces the limitations to strengthen the role as a horizontal “relationship enabler” that spans across a broader ecosystem of “expert apps.” Therefore, assistant may be considered fundamentally a voice-first delegation layer.

Given its role as an operator and delegator, all assistant capabilities may be inherited either from pre-existing apps, services provided by an entity associated with the assistant system 140, or third-party domain providers. The assistant system 140 may never offer hidden functionality or properties that aren't already afforded to the user by a native experience. For answers, the assistant system 140 may always provide lightweight responses to the user in the assistant layer, with affordances to see more in a native experience. For company knowledge, if no native experience exists, that domain may support a web fallback (i.e., URL destinations). When the assistant system 140 can't resolve a task end-to-end with voice, the assistant system 140 may either provide explicit links to send users to a native app, or implicitly confirm the request and hand off to a native app. If an app doesn't exist, the assistant system 140 may serve an unsupported error state.

In particular embodiments, the app handoff criteria may be as follows. When to handle in assistant layer, the criteria may include if completing scenario doesn't require complex touch interaction and focus and if using voice saves time and steps. When to hand off to an app instead, the criteria may include that the task requires more immersive touch UI, more complex interaction is required, and the intent is to open the app. The examples for app handoff may include “Remind me to water the plants tonight”, “What's the weather today?” “Set an alarm for 8 AM”, “Navigate to Sara's house”, “Play The Last Dance on Netflix”, and “Call Hilary”.

In particular embodiments, the assistant design system may use an answers app model. There may be a few classifications of answer domains within assistant layer. Each may have its own rules and requirements. For every domain, the assistant system 140 may provide a more immersive GUI experience beyond assistant layer, but the rules may vary below. For universal knowledge, these may be answers that exist outside the family of apps associated with the assistant system 140. It may be recommended, but not required, for universal domains to provide web fallbacks in the event that the surface does not have a related first party native experience. Examples for universal knowledge may include weather, facts, and math. For company knowledge, if the answer relates to the assistant ecosystem, the presentation may be similar to world knowledge but there may be a requirement for the domain to support a dedicated destination that can either manifest on the web or through the native layer. Examples for company knowledge may include calendar, reminders, and communities. For device knowledge, if the answer relates directly to a domain unique to the native surface, there may be a requirement to support a dedicated app outside of the assistant layer. If no app exists, the assistant system may not support the domain on that surface. Examples for device knowledge may include alarms, timers, and settings.

FIG. 7 illustrates an example answers handoff interaction. The assistant system 140 may find the best response in the background and then draw that knowledge to the assistant layer in the form of a small, bite-sized artifact. As a principle, the assistant system 140 may only focus on directly answering the specific question the user asked and offer a link to exit the layer and “see more” from the provider source.

In particular embodiments, the assistant design system may use a task app model. When the user wants to complete a task with their voice, it may generally fall into one of the following categories, with each having different rules relating to app handoff. One category may be object creation and management. The user may want to save time and effort by completing a multi-step task with voice. As assistant system 140 disambiguates and confirms information with the user, the assistant system 140 may provide supplementary links for the user to exit to the native experience. Examples for this may include reminders, alarms, timers, and messages. Another category may be device control. The user may want to save time and steps by “flipping a switch” that exists within the native experience, but without leaving their context. The assistant system 140 may complete the task and quickly exit the layer without rendering cards or visualizations. Examples for this may include volume and settings. Another category may be navigation. The user may want to save time and steps by quickly traversing into a native experience to complete a task. When necessary, the assistant system 140 may disambiguate in the layer, and then immediately hand off to the native calling app without further visualization. Examples for this may include calling, music, and video.

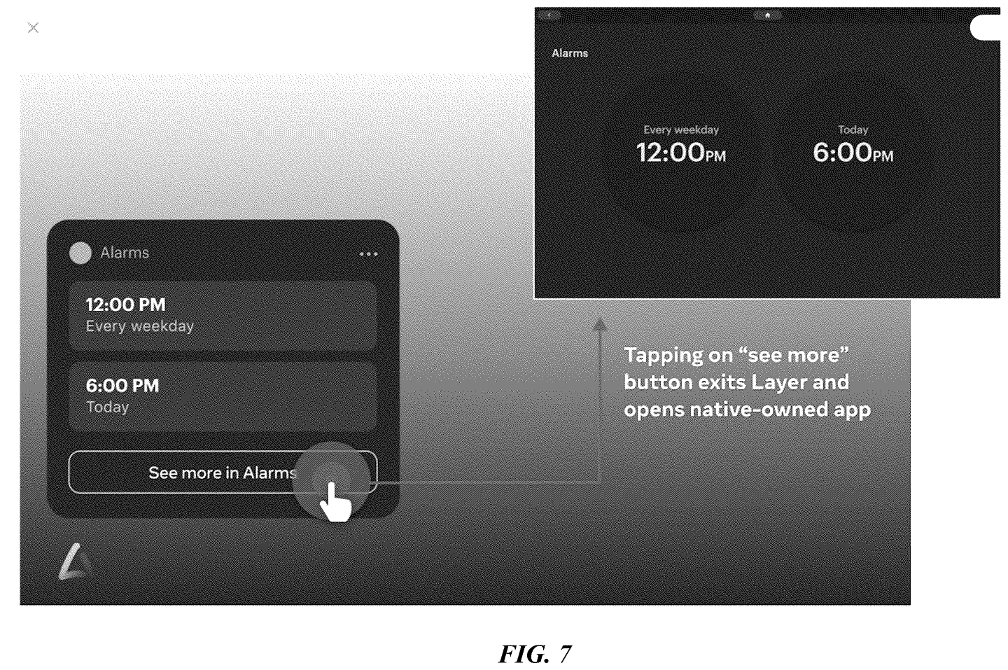

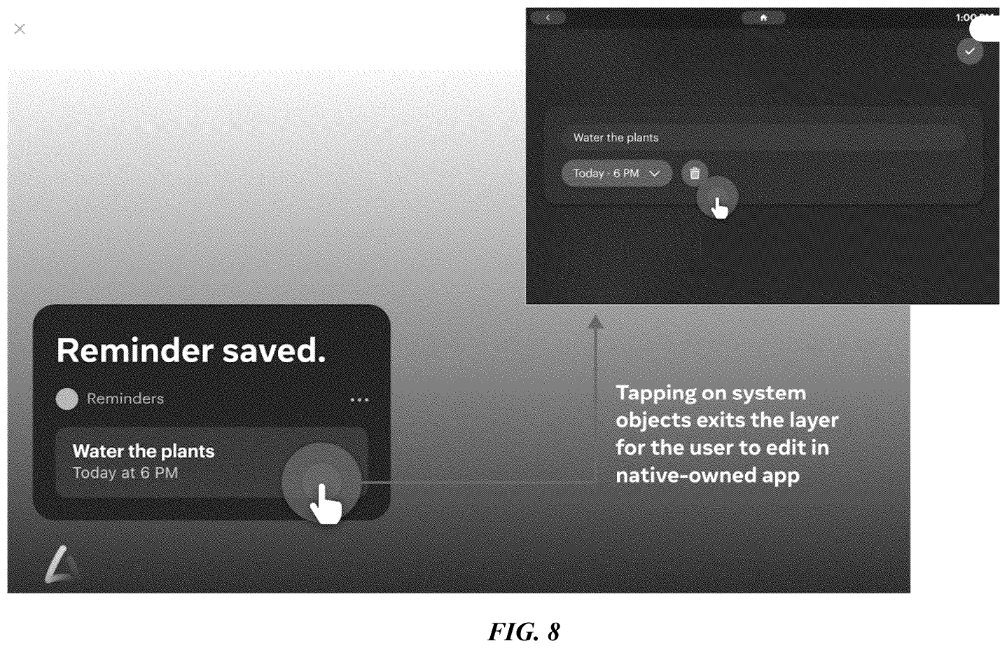

FIG. 8 illustrates an example natural-language task handoff interaction. As the user creates and manages objects in the system with their voice, at various stages in the voice flow, the assistant system 140 may offer affordances to perform deeper editing functions in a native app.

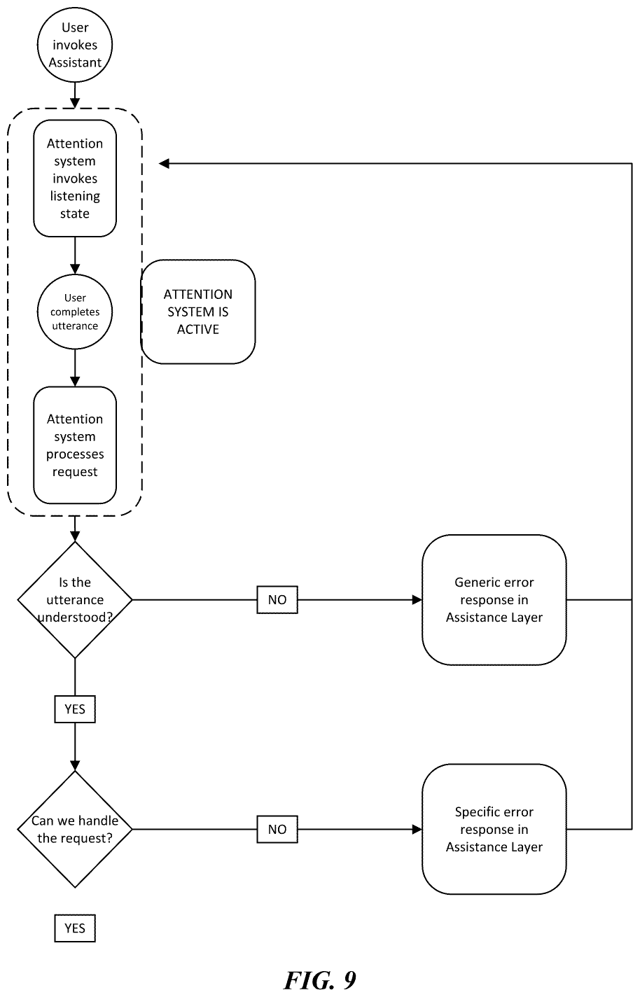

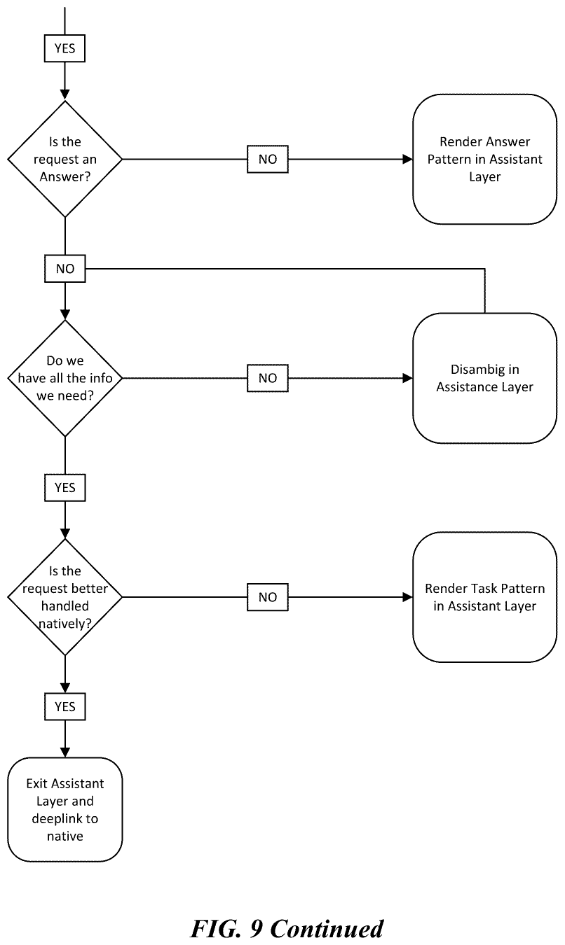

In particular embodiments, the assistant design system may utilize an interaction model. FIG. 9 illustrates an example flow diagram of the interaction model. It may all start with the attention system. Once invoked, the assistant system 140 may always appear on-screen via the attention system. If the assistant system 140 doesn't understand or support the request, the user may be re-prompted or referred to a service that can better help them. User intent may determine how assistant layer appears on-screen. Depending on the scenario, the assistant system 140 may either try to complete the task in the assistant layer, or hand the user off to an app. In particular embodiments, disambiguation may always happen in assistant layer. Any time the user needs to make a selection from a set of choices, the user may be asked to disambiguate via the assistant layer, even if said choice results in a handoff to a native app. Once in layer, all content may be rendered in patterns. No matter what domain a use case belongs to, if it happens in assistant layer, it may align to either an answer or task pattern. As soon as the scenario is complete, the assistant system 140 may exit layer. While there are numerous ways for the user to interrupt and exit assistant layer, the assistant system 140 may also exit automatically upon completion or timeout of any given scenario.

As described above, in assistant layer, all domains may use the same interaction patterns. These patterns may determine what UI will be rendered on screen. Assistant interaction patterns may fit into two categories: answers and tasks. Answers may not require follow-up questions, may not require explicit confirmation, and may not take action on behalf of the user. Tasks may gather required information from the user, support (but don't require) multiple turns, and take directed action on behalf of the user.

All answers in assistant layer may belong to one of the following patterns. One pattern may be answer presentation. When the user wants bite sized information quickly delivered from a single domain (e.g., “What's the weather today?”), the assistant system 140 may provide TTS. Another pattern may be summary presentation. The assistant system 140 may summarize key pieces of information from a list, while employing TTS response tapering, e.g., for a user request “Read my messages”. Another pattern may be object recall. The assistant system 140 may quickly find system objects a user is looking for and support re-query and filtering via voice but does not have TTS, e.g., for a user request “Show me my alarms”. In particular embodiments, every answer pattern may use on the following states to present content. One state may be simple answer state for presenting domain knowledge. Another state may be list answer state for presenting system objects and knowledge.

In particular embodiments, all end-to-end voice tasks in assistant layer may belong to one of these patterns. One pattern may be creation (multiturn), e.g., “Set an alarm”. The assistant system 140 may ask questions (and possibly disambiguates) via voice in order to create a new system object. Another pattern may be creation (one shot), e.g., “Set an alarm today for 1 PM”. The assistant system 140 may have all the required information to complete the task on behalf of the user, resulting in a new system object. Another pattern may be change, e.g., “Change it to 2 PM”. The assistant system 140 may make changes to a pre-existing system object that is either surface-agnostic or surface-specific. Another pattern may be deletion, e.g., “Delete my 1 PM alarm”. The assistant system 140 may delete a pre-existing system object that is either surface-agnostic or surface-specific. Another pattern may be device control, e.g., “Turn up the volume”. The assistant system 140 may change the settings of a device and then goes away. No further assistant output may be required. Another pattern may be navigation, e.g., “Open streaming channel”. The assistant system 140 may disambiguate via assistant layer (if necessary), and then exit and hand off to the app.

In particular embodiments, task patterns may use the following states. One state may be disambiguation when the assistant system 140 is unsure of what entity the user intended. Another state may be prompt when the assistant system 140 needs a missing piece of information to continue. Another state may be explicit confirmation when the user needs to review what action will be taken. Another state may be implicit confirmation when the assistant system 140 has completed a task or is about to complete a task.

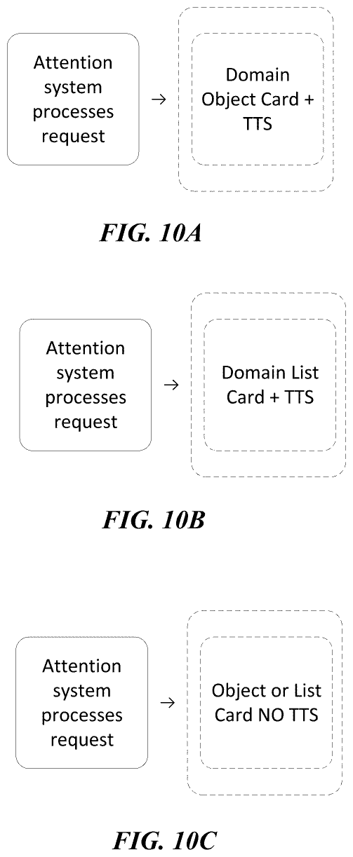

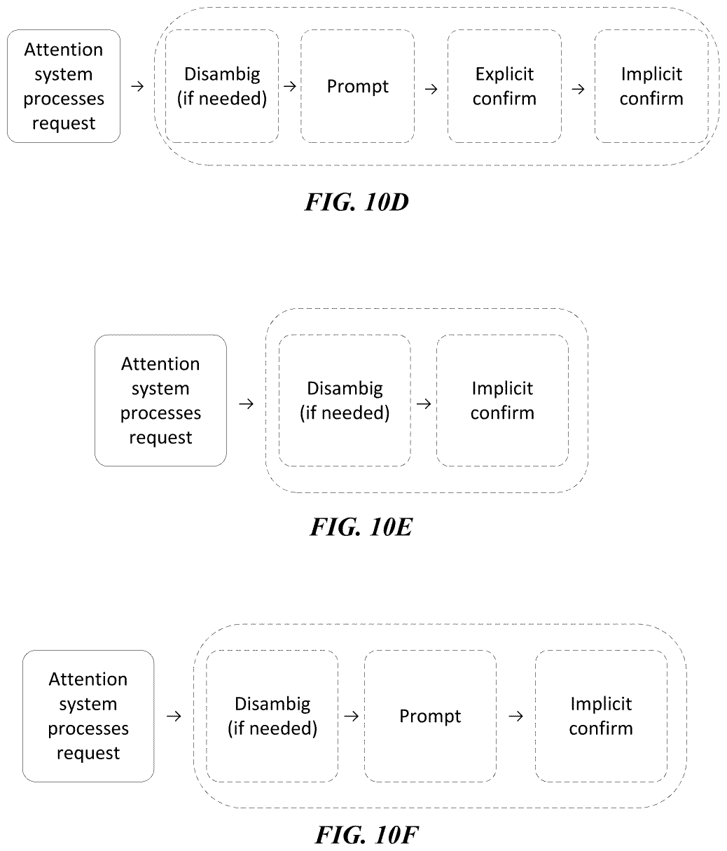

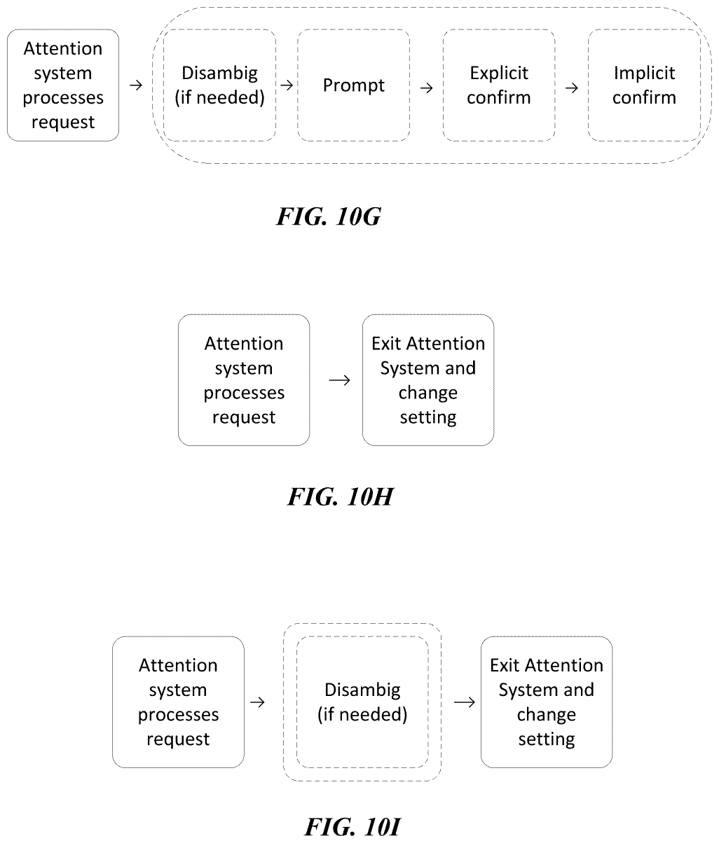

In particular embodiments, the assistant design system may use an interaction pattern map as the order and behavior of state rendering within each pattern is important. FIGS. 10A-10I illustrate example guide on how to sequence each pattern. States outlined in dotted blue are rendered within assistant layer. FIG. 10A illustrates an example answer presentation pattern. FIG. 10B illustrates an example summary presentation pattern. FIG. 10C illustrates an example object recall pattern. FIG. 10D illustrates an example creation (multi-turn) pattern. FIG. 10E illustrates an example creation (one-shot) pattern. FIG. 10F illustrates an example change pattern. FIG. 10G illustrates an example detection pattern. FIG. 10H illustrates an example control pattern. FIG. 10I illustrates an example navigate pattern.

Sometimes the assistant system 140 may be unable to help the user complete a task or find a piece of information. This can be due to system failure, ASR error, or a lack of supported functionality. In particular embodiments, the assistant design system may communicate to the user how the assistant system 140 reached a conclusion or failed based on the following error states. One error state may be latency when the assistant system 140 is taking longer than expected to process the request. Another error state may be misrecognition when the assistant system 140 fails to confidently understand the request. Another error state may be intent disambiguation when the assistant system 140 needs clarification on the intent of the request. Another error state may be unsupported when the assistant system 140 lacks functionality to complete the request on a device.

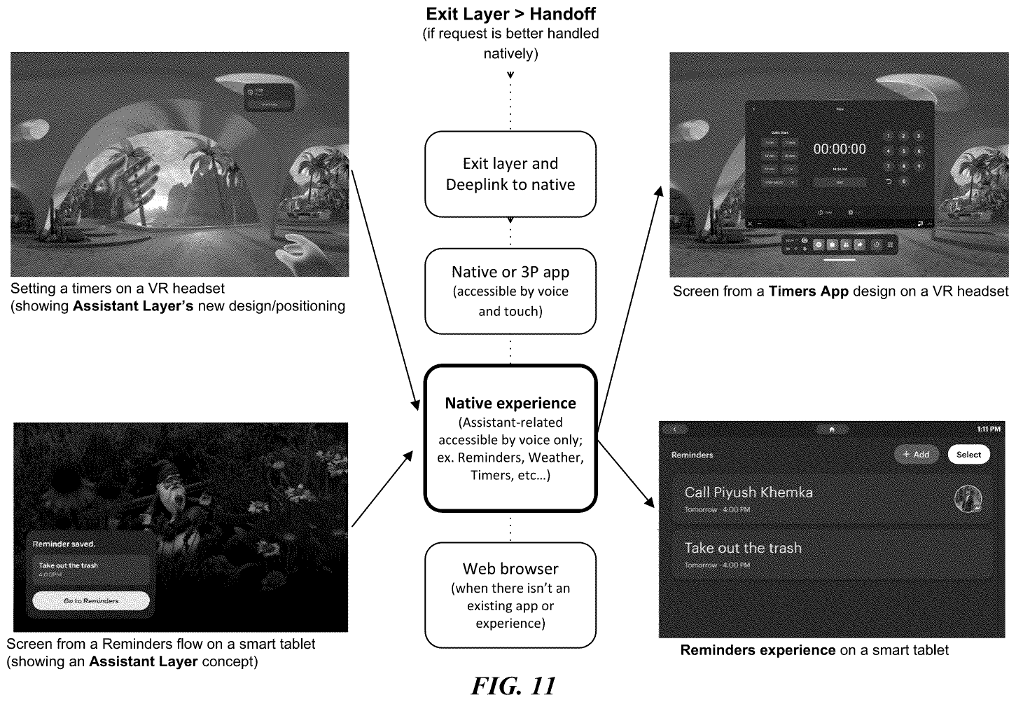

Based on the assistant design system, assistant-related native experiences may be as follows. Depending on the scenario, the assistant system 140 may either try to complete the task in the assistant layer, or hand the user off to one of the following channels. One channel may be native or third-party app that is represented on the device UI and is accessible via touch (though an app icon) and voice. Another channel may be native “experience” that is accessible only through voice and exists to fulfill user requests to the assistant system (e.g., reminders, weather, timers, alarms, communities). Another channel may be web browser of the content source when no native app or experience exists, i.e., a user is taken to the web browser of the content source. FIG. 11 illustrates example assistant-related native experiences.

With the assistant design system, there may be an assistant HUD space in VR. In a VR experience (and possibly an AR experience), the assistant system 140 may manage where in the user's field of view it presents content. In particular embodiments, there may be a dedicated “HUD” space, where assistant-related interfaces and content are displayed. The goal of the HUD space is to keep relevant information at an easy glance without overwhelming a user's vision while they're engaged in an activity. HUD space may adapt to the user's context. For example, if a user is actively engaged with the assistant system 140, HUD content may move back to center. But if the user is doing something else, HUD content may move to the side. The assistant's attention system indicators may appear in the HUD space whenever the user engages with the assistant system 140. Cards and content may then be moved into/around the HUD space responsive to the user's follow-up requests. In other words, the assistant system 140 may use the HUD space to dynamically bring content into and out of focus for the user based on the user's requests and context.

In particular embodiments, the attention system may leverage new colors, materiality, and motion. For example, the attention system may use earcon only for smart glasses, earcon, avatar, and line for VR devices, earcon and ring for smart watches, earcon, avatar, and line for smart tablets, and earcon and avatar for a VR headset. Based on the form factor and capabilities of the assistant-enabled device, the container for rendering the attention system may change. The attention system container may inherit motion patterns for interactions such as easing, transitions, and dynamic scaling for containers/cards.

In particular embodiments, the attention system may be based on a variety of activities disruption matrices. Table 2 lists example VR activities. Table 3 lists an example disruption matrix. Table 4 list example activities on a smart table. Table 5 lists an example disruption matrix on a smart table associated with assistant-layer question.

TABLE 2
Example VR activities.
VR Activities

| | LEAST DISRUPTABLE MOST DISRUPTABLE | | | | | |
|---|---|---|---|---|---|---|
| | | | | Co-presence | | |
| | | | | (when you're | | |
| | | | | embodied as | | |
| | | | | avatars with | | |
| Time | | Immersive | Immersive | other people | Immersive | Immersive |
| Sensitive? | | Loading | App | in home or | App | App |
| Activity | | Home (App | Destination | any other | Destination | Destination |
| Type | Home | Menu) | (Entertainment) | “destination”) | (Game Type 2) | (Game Type 1) |
| Description | An activity | An activity | A medium to | An activity | An activity | An activity |
| | that requires | that requires | long-running | that consumes | that consumes | that consumes |
| | some | directed | activity usually | almost all | moderate to | most or all |
| | attention, but | attention, | with a low | cognitive | almost all | cognitive |
| | leaves some | but may | cognitive load, | resources. | cognitive | resources. |
| | cognitive | leave some | that can be | Interruptions | resources. | Recovery from |
| | bandwidth for | cognitive | paused or | may affect | Recovery | interruptions |
| | multi-tasking | bandwidth | suspended at | not only the | from | can be very |
| | or | for multi- | any time. The | user but other | interruptions | costly. Games |
| | interruption. | tasking or | activity usually | users apart of | is not as | in this |
| | | interruption. | has a known, | the primary | costly as | category are |
| | | | discrete | user's party | Type 1. | either live- |
| | | | endpoint. | | Games in this | action or time- |
| | | | Entertainment | | category can | based and |
| | | | apps in this | | usually be | progressive or |
| | | | category can | | disrupted | lives can be |
| | | | typically be | | without the | lost with |
| | | | disrupted with | | loss of | disruption. |
| | | | little to | | progress or | |
| | | | moderate loss | | lives, | |
| | | | of focus, but | | however, | |
| | | | easily | | disruption | |
| | | | recoverable | | may cause a | |
| | | | after the | | loss of focus | |
| | | | disruption. | | and could be | |
| | | | | | equally | |
| | | | | | frustrating to | |
| | | | | | the user. | |
| Attention | Low to High | Medium to | Medium to | High | High | Very High |
| Required | | High | High | | | |
| Length | Indefinite | Indefinite or | Moderate to | Indefinite | Moderate to | Moderate to |
| | | short | long | | long | long |
| Time | No urgency | No urgency | Not really | Not really but | Not really | Not really |
| Sensitive? | | | | other people | | |
| | | | | may | | |
| | | | | determine the | | |
| | | | | time spent | | |
| How does | User ends it | User ends it | Has a discrete | User ends it | Has a discrete | Has a discrete |
| it end? | by choosing a | by choosing | endpoint | | endpoint | endpoint |
| | destination | a selection | | | | |
| Effort to | Easily | Easily | Might be easily | Might be easily | Might be easily | Might be |
| resume? | resumed by | resumed by | resumed, but | resumed, but | resumed, but | difficult to |
| | the user | the user | user may need | user may miss | user may | resume since |
| | | | to find where | some context | need to find | the moment |
| | | | they left off | while absent | where they | has been |
| | | | | | left off | missed |
| Questions | | | | How much | Is time the | Are these time |
| | | | | attention does | only factor | based games? |
| | | | | a user have | distinguishing | Are these only |
| | | | | when they are | Type 2 | action-based |
| | | | | in VR AND | from Type 1? | games? |
| | | | | are co-present | | |
| | | | | with other | | |
| | | | | players? | | |
| Activity | Browsing | Browsing | Watching a | Browsing | Horizon | Beat Saber |
| examples | app store | selections | movie | app store or | The Plank | Vader |
| | Browsing | (levels, | Watching a | loading menu | | Immortal |
| | app library | videos, etc.) | 3D immersive | Watching a | | |
| | Managing | Managing | experience | movie | | |
| | settings | options | Experiencing | together | | |
| | Setting up a | | a 3D immersive | Playing a | | |
| | party | | experience | game together | | |
| | Experiencing | | | Meeting in | | |
| | the virtual | | | Horizon | | |
| | environment | | | | | |

TABLE 3
Example VR disruption matrix.
VR matrix

| Device: VR | LEAST DISRUPTABLE MOST DISRUPTABLE | | | | | |
|---|---|---|---|---|---|---|
| headset | Current Foreground Activity Type | | | | | |
| Disruption | | | | | Immersive | Immersive |
| (GUI type: | | | | | App | App |
| headless, | | Immersive | Immersive App | | Destination | Destination |
| bodiless, or | | Loading Home | Destination | | (Type 1 | (Type 2 |
| modal) | Home | (App menu) | (Entertainment) | Co-Presence | Game) | Game) |
| Answer | Immersive | Bodiless | Bodiless | Bodiless | Bodiless | Bodiless |
| (Universal) | | (Minimal GUI > | (Minimal GUI > | (Minimal | (Minimal | (Minimal |
| “What's the | | Modal with | Modal with | GUI > | GUI > | GUI > |
| weather” | | progressive- | progressive- | Modal with | Modal with | Modal with |
| | | disclosure) | disclosure) | progressive- | progressive- | progressive- |
| | | | | disclosure) | disclosure) | disclosure) |
| Answer | Modal | Bodiless | Bodiless | Bodiless | Bodiless | Bodiless |
| (System: | | (Minimal GUI > | (Minimal GUI > | (Minimal | (Minimal | (Minimal |
| Surface | | Modal with | Modal with | GUI > | GUI > | GUI > |
| specific) | | progressive- | progressive- | Modal with | Modal with | Modal with |
| “Show me my | | disclosure) | disclosure) | progressive- | progressive- | progressive- |
| alarms?” | | | | disclosure) | disclosure) | disclosure) |
| Answer | Modal | Modal | Bodiless | Bodiless | Bodiless | Bodiless |
| (System: | | | (Minimal GUI > | (Minimal | (Minimal | (Minimal |
| Surface | | | Modal with | GUI > | GUI > | GUI > |
| agnostic) | | | progressive- | Modal with | Modal with | Modal with |
| “Show me | | | disclosure) | progressive- | progressive- | progressive- |
| Jeff's profile” | | | | disclosure) | disclosure) | disclosure) |
| NL Task | Bodiless | Bodiless | Bodiless | Bodiless | Bodiless | Bodiless |
| (Control) | (AS only) | (AS only) | (AS only) | (AS only) | (AS only) | (AS only) |
| “Turn up the | | | | | | |
| volume” | | | | | | |
| NL Task | Modal | Modal | Modal | Modal | Bodiless | Bodiless |
| (Navigation | | | | **Depending | (Minimal | (Minimal |
| with | | | | on current | GUI > | GUI > |
| disambiguation) | | | | Co-Presence | Modal with | Modal with |
| “Call Hilary” | | | | activity (or | progressive- | progressive- |
| (contact | | | | Destination) | disclosure) | disclosure) |
| disambiguation) | | | | | | |
| NL Task | Modal | Modal | Modal | Modal | Bodiless | Bodiless |
| (Navigation | | | | **Depending | (Minimal | (Minimal |
| with | | | | on current | GUI > | GUI > |
| disambiguation) | | | | Co-Presence | Modal with | Modal with |
| “Play Beat | | | | activity (or | progressive- | progressive- |
| Saber” (app | | | | Destination) | disclosure) | disclosure) |
| disambiguation) | | | | | | |
| NL Task | Modal | Bodiless | Bodiless | Bodiless | Bodiless | Bodiless |
| (End-to-end | | (Minimal GUI > | (Minimal GUI > | (Minimal | (Minimal | (Minimal |
| object | | Modal with | Modal with | GUI > | GUI > | GUI > |
| creation) | | progressive- | progressive- | Modal with | Modal with | Modal with |
| “Remind me | | disclosure) | disclosure) | progressive- | progressive- | progressive- |
| to call Mom | | | | disclosure) | disclosure) | disclosure) |
| tonight” | | | | | | |
| | Framework | | | | | |
| Definitions of | N/A | Headless | Bodiless | Modal | Immersive | |
| modes >> | | | | | | |
| | | No GUI | Little to no GUI | Includes | Includes an | |
| | | No Attention | Includes | more | immersive | |
| | | System (AS) | Attention | complete | GUI | |
| | | | System (AS) | GUI | Includes | |
| | | | **Bodiless often | (referring | Attention | |
| | | | might have the | Assistant | System | |
| | | | option for the | Layer | (AS) | |
| | | | user to switch to | Information | | |
| | | | a Modal GUI | Architecture) | | |
| | | | (with more | Includes | | |
| | | | complete | Attention | | |
| | | | information | System (AS) | | |
| | | | provided) | | | |

TABLE 4
Example activities on a smart tablet.
Example activities on a smart tablet

| Activity | | | | | | |
|---|---|---|---|---|---|---|
| Type | Passive | Sustained | Alerts | Discrete | Focused | Live |
| Description | Attention is | A long- | A short, | An activity | An activity that | A real- |
| | unfocused and | running | system- | that requires | consumes most or all | time |
| | not directed at | activity | initiated | directed | cognitive resources: | activity, |
| | a single device | usually | activity that | attention, but | from creating | like a |
| | or activity | with a low | may or may | may leave | something to driving a | phone |
| | | cognitive | not require | some | car. Recovery from | call. |
| | | load, that | immediate | cognitive | interruptions is costly. | (Almost) |
| | | is often | attention | bandwidth | | full |
| | | without a | | for multi- | | attention |
| | | known | | tasking or | | is required |
| | | endpoint. | | interruption. | | and any |
| | | It can | | The activity | | distraction |
| | | usually be | | usually has a | | will cause |
| | | paused, | | known, | | loss of |
| | | suspended, | | discrete | | context. |
| | | or even | | endpoint. | | |
| | | run in | | | | |
| | | parallel | | | | |
| | | with other | | | | |
| | | tasks | | | | |
| | | without | | | | |
| | | loss of | | | | |
| | | detail | | | | |
| Attention | (Almost) none | Low | Low to | Moderate | High | Full |
| Required | | | High | | | |
| Length | Indefinite | Indefinite | Short | Short | Moderate to Long | Long |
| Time | No urgency | Not really | Yes | Somewhat | Not really | Yes, since |
| Sensitive? | | | | | | they're not |
| | | | | | | available |
| | | | | | | at another |
| | | | | | | time |
| How does | Continue until | Generally | User | Has a | User ends it | Not pre- |
| it end? | interrupted, | persist | ignores or | discrete | | determined |
| | they rarely | unless | dismisses | endpoint | | |
| | have a natural | ended by a | | since it's | | |
| | endpoint | customer | | short in | | |
| | | action, or | | duration | | |
| | | by the end | | | | |
| | | of media | | | | |
| | | being | | | | |
| | | consumed | | | | |
| Effort to | Resumes | Easily | Once | If context is | Can be interrupted, | Hard to go |
| resume? | automatically | resumed | dismissed, | lost, user | but hard to recapture | back since |
| | (but takes time) | by the | can't be | may need to | once lost | the live |
| | | user | resumed | restart or | | moment |
| | | | | repeat the | | has been |
| | | | | activity | | missed |
| | | | | (which may be | | |
| | | | | frustrating) | | |
| Real world | Sleeping | Listening | Incoming | Checking | Playing a game | Video |
| examples | | to an | call | the weather | Responding with a | call |
| | | audiobook, | Incoming | or time | long message | |
| | | podcast, | message | Creating a | Dictation | |
| | | or music | Amazon | reminder or | | |
| | | Watching | package | calendar | | |
| | | TV or | deliveries | event | | |
| | | videos | Timer, | Responding | | |
| | | | Alarm, | with a short | | |
| | | | Reminder | message or | | |
| | | | going off | smart comm | | |
| Potential | Ambient | Long | Urgent | Wake word | | |
| Sub-types | Home (Active) | running | (incoming | WW + | | |
| | | video | call, system | error | | |
| | | Short | issue) | | | |
| | | running | Scheduled | | | |
| | | video | (Timer, | | | |
| | | Mixable | Alarm, | | | |
| | | audio | Reminder | | | |
| | | Non- | Non- | | | |
| | | mixable | urgent | | | |
| | | audio (e- | (async | | | |
| | | book or | comms, | | | |
| | | podcasts) | package) | | | |
| Activities | Hombient/Sleep | Music and | Notifications | Alexa | In Call Capture | In call |
| | | podcasts | | Experience | | |
| | | Video | Pre-call | Weather | Story Time | Live |
| | | | (incoming | | | streaming |
| | | | call) | | | |
| | | Audio | Timer, | Device | AR effects | Calling |
| | | | Alarm, | control | | |
| | | | Reminder | | | |
| | | | Delivery | | | |
| | | What's | | Help | Photo booth | Chat |
| | | New/ | | | | Rooms |
| | | Social | | | | |
| | | Digest | | | | |
| | | | | Messaging | Mask | Watch |
| | | | | | | Together |
| | | | | Time | Routine | |
| | | | | Create/View | Posting - Feed/Stories | |
| | | | | Timer, | | |
| | | | | Alarm, | | |
| | | | | Reminder | | |
| | | | | Informational | Voice | |
| | | | | Q&A | Dictation/Transcription | |
| | | | | Social/ | Browser | |
| | | | | Community | | |
| | | | | Q&A | | |
| | | | | Wake word | | |
| | | | | Photos/ | | |
| | | | | Photos | | |
| | | | | search | | |
| | | | | App store | | |
| | | | | Settings | | |

TABLE 5
Example disruption matrix on a smart table associated with assistant-layer question.
Example of AL matrix

| | AL Question: When to do full screen vs. overlay a card? | | | | | | |
|---|---|---|---|---|---|---|---|
| | Current Foreground Activity Type (from full-screen) | | | | | | |
| Device: smart | | [Nearfield - | | | | | |
| tablet | | Sustained: | Fairfield - | | | | |
| Disruption | | Mixable | Sustained: | | | | |
| (to Answer or | | A/V] | Mixable | Sustained: | | | |
| NL Task, type | | (user is | A/V | Non- | Fairfield/ | | |
| of Answer or | | listening | (user is | Mixable | discrete | Nearfield/ | |
| NL Task, | | to music | listening | A/V | (user is | focused | Live |
| Immersive, | Passive or | and up- | to music | (user is | engaged in an | (user is | (user is |
| Modal, or no | Inactive | close to | and across | watching | app across the | engaged in an | in a |
| GUI) | (Home) | screen) | the room) | videos) | room) | app up-close) | call) |
| Answer | Immersive | Modal | Immersive | Modal | Immersive | Modal | Modal |
| (Universal) | Layer | Layer | Layer | Layer | Layer | Layer | Layer |
| “What's the | | | | | | | |
| weather” | | | | | | | |
| Answer | Immersive | Modal | Immersive | Modal | Immersive | Modal | Modal |
| (System: | Layer | Layer | Layer | Layer | Layer | Layer | Layer |
| Surface | | | | | | | |
| specific) | | | | | | | |
| “Show me | | | | | | | |
| my alarms?” | | | | | | | |
| Answer | Modal | Modal | Modal | Modal | Modal | Modal | Modal |
| (System: | Layer | Layer | Layer | Layer | Layer | Layer | Layer |
| Surface | | | | | | | |
| agnostic) | | | | | | | |
| “Show me | | | | | | | |
| Jeff's profile” | | | | | | | |
| NL Task | No GUI | No GUI | No GUI | No GUI | No GUI | No GUI | No GUI |
| (Control) | Attention | Attention | Attention | Attention | Attention | Attention | Attention |
| “Turn up the | system | system | system | system | system | system | system |
| volume” | only | only | only | only | only | only | only |
| NL Task | Immersive | Immersive | Immersive | Immersive | Immersive | Immersive | Modal |
| (Navigation | Layer | Layer | Layer | Layer | Layer | Layer | Layer |
| with | | | | | | | |
| disambiguation) | | | | | | | |
| “Call Hilary” | | | | | | | |
| (contact | | | | | | | |
| disambiguation | | | | | | | |
| NL Task | Immersive | Modal | Immersive | Modal | Immersive | Modal | Modal |
| (Navigation | Layer | Layer | Layer | Layer | Layer | Layer | Layer |
| with | | | | | | | |
| disambiguation) | | | | | | | |
| “Play Madonna” | | | | | | | |
| (app | | | | | | | |
| disambiguation) | | | | | | | |
| NL Task | Immersive | Modal | Immersive | Modal | Immersive | Modal | Modal |
| (End-to-end | Layer | Layer | Layer | Layer | Layer | Layer | Layer |
| object | | | | | | | |
| creation) | | | | | | | |
| “Remind me | | | | | | | |
| to call Mom | | | | | | | |
| tonight” | | | | | | | |
| | Framework | | | | | | |
| | N/A | Immersive | Modal | No GUI | | | |
| | | Layer | Layer | Attention | | | |
| | | Full | Assistant | No GUI | | | |
| | | screen | Layer | | | | |
| | | | card | | | | |

Assistant-Aided Diet Management with Smart Glasses

In particular embodiments, the assistant system 140 may use smart glasses to help users eat healthy food while achieving their calorie and nutrient goals. Smart glasses may have cameras in them and the assistant system 140 may build OCR (optical character recognition) and CV (computer vision) functionality into the cameras. The smart glasses may also have speakers and/or displays (e.g., AR glasses) for providing feedback and suggestions. When a user sees a menu at a restaurant, smart glasses may conduct OCR on the menu text and read the contents of the menu. For each of the items in the menu, the smart glasses may then search for the food item across a food/recipe database and predict the estimated calorie and nutrient of the food item, thereby helping the user manage their diet by selecting and eating healthy food. However, a menu may be not necessary. In another embodiment, when the user sees some food item, the smart glasses may run a basic computer-vision algorithm to determine what the food item is. Then the smart glasses may similarly query the food/recipe database and predict the calories and nutrient of the food. Smart glasses may also keep track of the amount of calories a user has eaten throughout the day, helping the user track their consumption against their diet/nutrition goals and allowing the user to eat healthy for the entire day. After the user eats, the smart glasses may recommend follow-up actions to maintain health. As an example and not by way of limitation, if the smart glasses detect that a diabetic user is eating ice cream or other high-sugar food items, they may recommend the user to do something to subsequently manage their blood sugar levels (e.g., exercise, take insulin, etc.). Or if the user needs to take medication before eating, the smart glasses may remind the user about taking this medication if they determine the user is about to sit down for a meal. Although this disclosure describes particular diet management by particular systems in a particular manner, this disclosure contemplates any suitable diet management by any suitable system in any suitable manner.

Nearly 40% of American adults aged 20 and over are obese. 71.6% of adults aged 20 and over are overweight, including obesity. This may be a real problem and may be tied to unhealthy eating habits. The assistant system 140 may be implemented on smart glasses. When implemented on smart glasses, the assistant system 140 may have the following system components. One component may be camera(s) used to view the user's environment. Another component may be an OCR module to scan menus/labels to identify food items. Another component may be a CV module to identify food items. Another component may be an ingredient database comprising information about all the food and ingredients the user has at home. This ingredient database may be personal to the user. Another component may be a menu database comprising queryable general database to look up calorie and nutrition information about food. The menu database may be generic to all users. Another component may be a question and answering (Q&A) module, which allows the user to query about information in the databases. Another component may be a user input component. As an example and not by way of limitation, the user input component may comprise a microphone for voice input. Another component may be output/display. As an example and not by way of limitation, the output/display may comprise a speaker for synthetic speech or video display on AR glasses.

When a user wearing smart glasses is at a restaurant and looks at the menu, the assistant system 140 may scan menu items and determine nutritional information. If the restaurant provides buffet, the assistant system 140 may also identify unusual food at the buffet when the user doesn't recognize what the food is. For menus that use pictures, the assistant system 140 may identify food from the pictures. In particular embodiments, the assistant system 140 may determine allergy issues for menu items. The assistant system 140 may then overlay an AR warning over those menu items. For any other dietary restrictions (e.g., vegetarian, vegan, etc.), the assistant system 140 may show warnings over items that are not suitable for the user's diet. The assistant system 140 may further provide suggestions of what to eat or avoid, helping the user meet their diet targets. As an example and not by way of limitation, the assistant system 140 may display green AR highlight over items that are good to eat for meeting the user's diet targets. In particular embodiments, the assistant system 140 may also provide suggestions for what the user can eat. As an example and not by way of limitation, the assistant system 140 may determine what is okay for the user to eat based on what the user has already eaten that day and provide an AR overlay to highlight the food items.

When a user wearing smart glasses is making their own food at home, the assistant system 140 may use the CV module to track ingredients and determine nutritional information of the final food product. In particular embodiments, the assistant system 140 may maintain an inventory of what the user has at home (e.g., from CV analysis of cupboards) and provide suggestions for what to prepare based on available ingredients. The assistant system 140 may dynamically provide suggestions for modifying the recipe to meet the user's diet targets (e.g., nutrition, calories). As an example and not by way of limitation, while the user is cooking, the assistant system 140 may provide suggestions for adding/subtracting one or more ingredients from the meal to meet the user's diet targets. In particular embodiments, the assistant system 140 may provide AR guidance (e.g., arrows to show movement, highlights to show what to pick up, etc.) to help the user make their food correctly and follow the recipe.

When a user wearing smart glasses is shopping for food at a grocery store, the assistant system 140 may identify food items based on labels, barcodes, or visual analysis. The assistant system 140 may access the user's shopping list. As the user is walking the isles of the grocery store, the assistant system 140 may display AR highlight on food items the user needs to pick up. The assistant system 140 may also help the user navigate the grocery store to the correct isles so the user doesn't get lost or waste time. When there are multiple versions of the same food item, the assistant system 140 may help the user select the best option (e.g., based on quality, nutrition, and price constraints, etc.).

In particular embodiments, a user may add food items to their personal database. The user may look at a food item via smart glasses and tell the assistant system 140 to remember it. Accordingly, the assistant system 140 may add it to a food index.

In particular embodiments, the assistant system 140 may automatically track a user's food intake without the need for the user to input anything. The assistant system 140 may automatically identify and track all food intake based on the visual signals collected by the smart glasses.

In particular embodiments, the assistant system 140 may also help a user wearing smart glasses identify what is edible in the wild. As an example and not by way of limitation, if the user is lost in the forest, the assistant system 140 may determine what the user could eat in the forest.

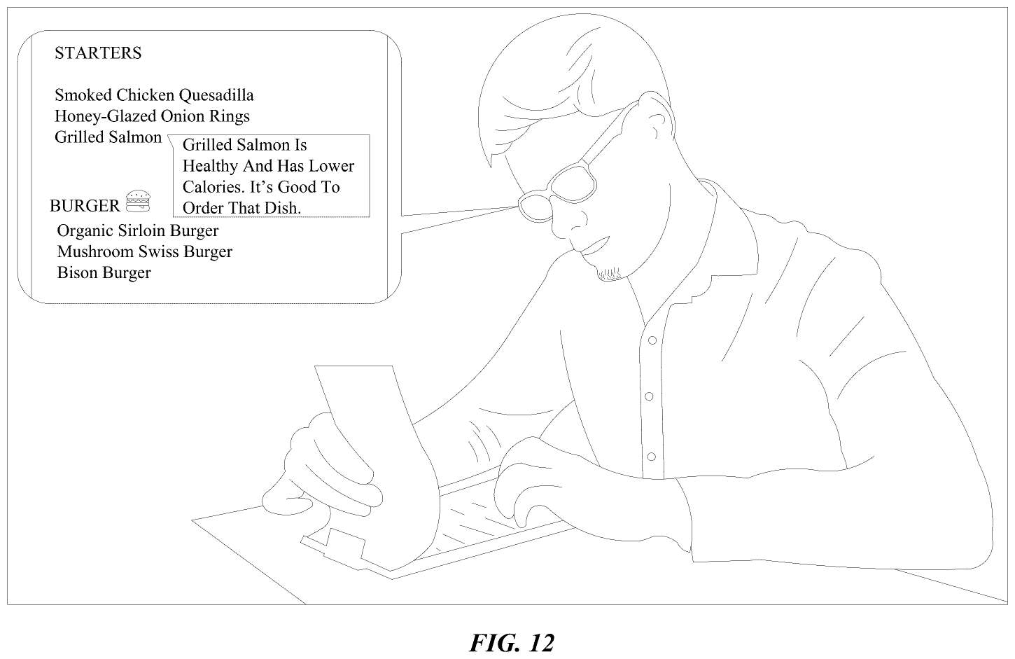

FIG. 12 illustrates an example AR overlay suggesting healthy food. As can be seen, a user wearing AR glasses may be at a restaurant. The user may be looking at a menu. Via the lens of the AR glasses, the user may see the content of the menu, which includes “starters” and “burger”. The “starters” may include “smoked chicken quesadilla,” “honey-glazed onion rings,” and “grilled salmon.” The “burger” may include “organic sirloin burger,” “mushroom Swiss burger,” and “bison burger.” The assistant system 140 may determine that “grilled salmon” is healthy for the users. Accordingly, the assistant system 140 may instruct the AR glasses to generate an AR overlay saying “grilled salmon is healthy and has lower calories. It's good to order that dish.”

### Continual Dialogue State Tracking Via Example-Guided Question Answering

In particular embodiments, the assistant system 140 may maximize task consistency between consecutive domains as a new under-explored pillar of continual learning (CL) for dialog state tracking (DST). The assistant system 140 may maximize task consistency by reformulating DST as separate question answering tasks. Answering questions based on examples may further improve task consistency as the model is encouraged to learn a domain-agnostic skill of learning to use instructions and examples to answer a question. Although this disclosure describes maximizing task consistency by particular systems in a particular manner, this disclosure contemplates maximizing task consistency by any suitable system in any suitable manner.

Dialogue systems are frequently updated to accommodate new services, but naively updating them by continually training with data for new services in diminishing performance on previously learnt services. Motivated by the insight that dialogue state tracking (DST), a crucial component of dialogue systems that estimates the user's goal as a conversation proceeds, may be a simple natural language understanding task, the embodiments disclosed herein may reformulate it as a bundle of granular example-guided question answering tasks to minimize the task shift between services and thus benefit continual learning. Our approach may alleviate service-specific memorization and teach a model to contextualize the given question and example to extract the necessary information from the conversation. The embodiments disclosed herein find that a model with just 60 M parameters may achieve a significant boost by learning to learn from in-context examples retrieved by a retriever trained to identify turns with similar dialogue state changes. Combining our method with dialogue-level memory replay, our approach may attain state of the art performance on DST continual learning metrics without relying on any complex regularization or parameter expansion methods.

Introduction

As conversational digital assistants are becoming increasingly popular and versatile, it may be important to continuously update their underlying models to accommodate more services. In this disclosure, we use services and domains interchangeably to denote high-level services supported by digital assistants, e.g., setting an alarm or booking a restaurant. Task refers to lower-level functions, e.g., question answering, sentiment classification, and dialogue state tracking. One of these models may be a dialogue state tracking (DST) model, which may estimate the user's goal, i.e., the dialogue state, as dialogue progresses. DST may be important to task-oriented dialogue as the dialogue state serves as parameters for queries sent to application programming interfaces to retrieve necessary information, such as a list of restaurant names with a cuisine type, that is used to ground the dialogue model's response.

Yet, training an existing model further with only the new data may cause catastrophic forgetting (McCloskey and Cohen, 1989; French, 1999), the drop in performance for previous services not covered by the new data. To mitigate this issue while also avoiding the impracticality of training a model from scratch with data from all services each time new data becomes available, three main approaches may have been established as approaches to effective continual learning (CL): memory replay, regularization, and parameter expansion. Various variants of the three may have been applied for CL in DST as well to some degree of success (Liu et al., 2021; Madotto et al., 2021; Zhu et al., 2022).

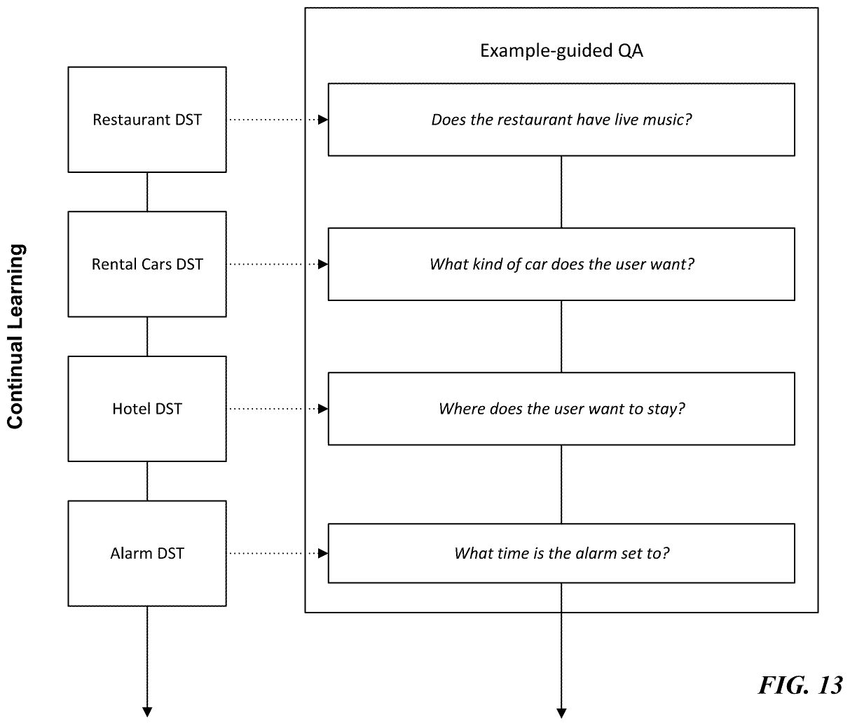

FIG. 13 illustrates an example comparison between previous work and the embodiments disclosed herein for continual learning for DST. The left part indicates that previous work sought to enhance continual learning for DST while treating it as a structured text generation task, which may enforce memorization of service-specific outputs that is not conducive to continual learning. The right part shows that, instead, we may reformulate DST into a bundle of granular example-guided question answering tasks such that data from new services effectively becomes additional training data for learning general example-guided question answering.

Most previous work may have focused on improving CL performance with domain-specific inputs or outputs, a paradigm illustrated on the left side of FIG. 13. This approach may introduce a large distribution shift from one domain to another as at each domain the model may need to memorize which domain-specific slots to predict values for. However, DST may become a significantly more consistent task across domains by simply reformulating the DST dataset as a bundle of example-guided question answering task. The outcome of the reformulation, which we denote as Dialogue State Tracking as Example-Guided Question Answering (DST-EGQA) may be that the DST task becomes more granular, easy, and consistent across domains as the training becomes about learning to learn how to use examples to answer questions for a single slot at a time (right side of FIG. 13), rather than trying to predict domain-specific structured outputs all at once without any explicit guidance (left side of FIG. 13). Motivated by this insight, we hypothesize that DST-EGQA may benefit continual learning because it promotes generalizability while performing DST.

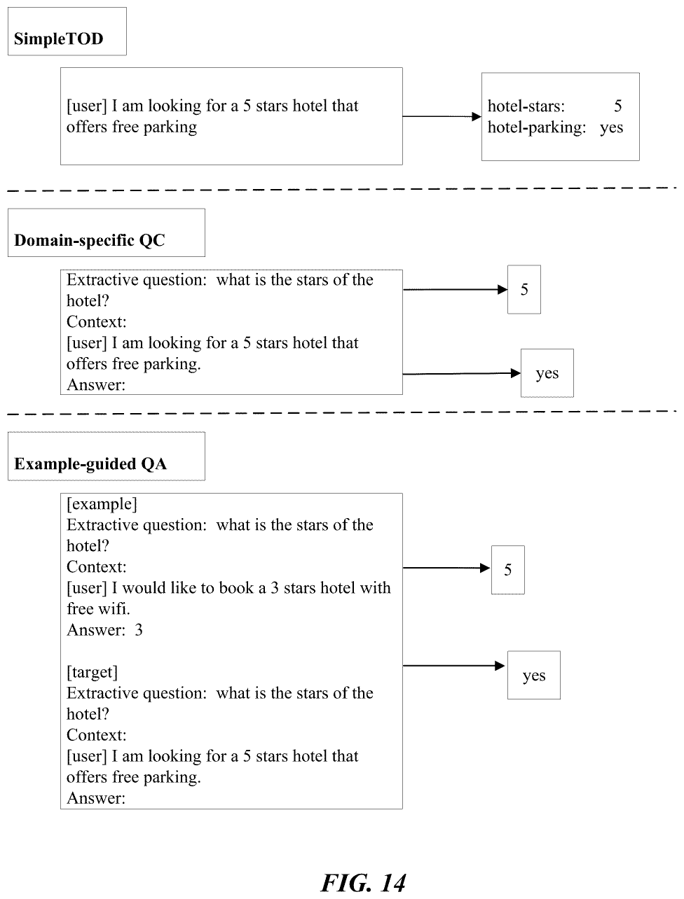

We demonstrate that this may be indeed the case, as it may lead to significant gains in CL performance without using any of the aforementioned approaches or data augmentation methods. Specifically, we may transform DST into the TransferQA (Lin et al., 2021a) format and add examples retrieved by a retriever that is trained to identify turns that result in similar dialogue state updates (Hu et al., 2022). Our approach may obviate complex partitioning of the training set to target samples and retrieval samples, as we find that we can double dip on the train set as both target samples and retrieval database. FIG. 14 illustrates an example comparison for task consistency between previous work and the embodiments disclosed herein. We maximize task consistency by reformulating DST as separate question answering tasks. As illustrated in FIG. 14, answering questions based on examples further improves task consistency as the model may be encouraged to learn a domain-agnostic skill of learning to use instructions and examples to answer a question.

In addition, we experiment with a wide array of retrievers and find that models trained to perform DST-EGQA can be effective even with lower quality retrievers by intentionally training it with subpar examples such that it can learn when to leverage good examples and ignore bad ones. Lastly, we may simply tweak the sampling approach for memory replay to sample at the dialogue-level instead of the turn-level and achieve significant gains to CL performance even with a single dialogue sample, resulting in state-of-the-art performance on the Schema Guided Dialogue (SGD) dataset (Zhu et al., 2022).

In summary, our main contributions may include the followings. We show that refactoring the DST as granular example-guided question answering task (DST-EGQA) alone may significantly improve continual learning performance by simply enhancing task consistency across domains. We propose a simple but highly effective dialogue-level sampling strategy for choosing memory samples that leads to state-of-the-art performance when combined with DST-EGQA. We share a thorough analysis on the parameters relevant to DST-EGQA to establish its effectiveness, robustness, and limitations as a method for continual learning.

Dialogue State Tracking as Example-Guided Question Answering (DST-EGQA)

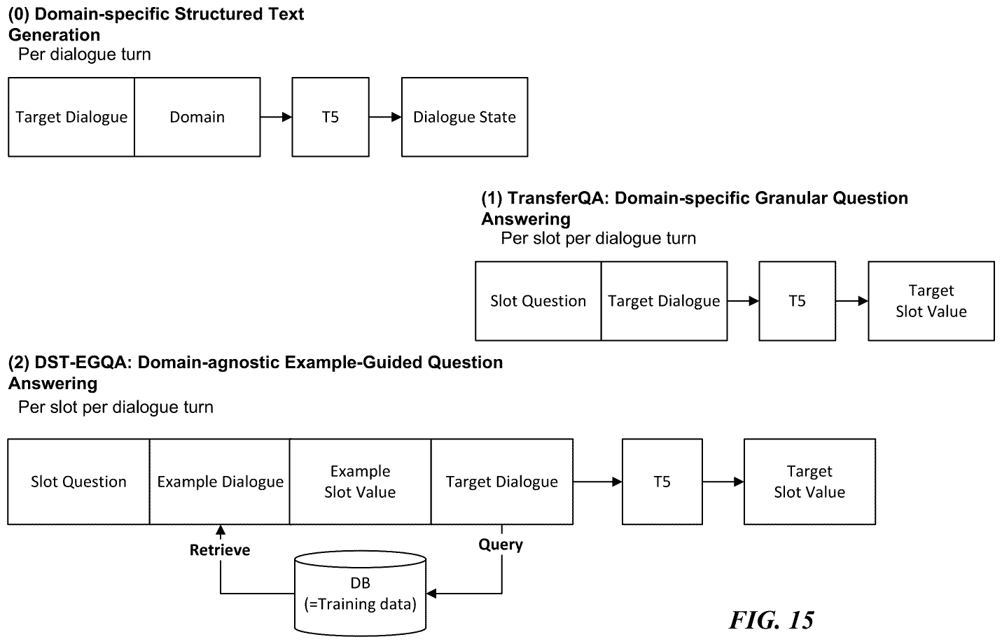

FIG. 15 illustrates an example overview of DST-EGQA. We factor (0) the original dialogue state tracking task into a (1) granular question answering task with the TransferQA format (Lin et al., 2021a) and make it (2) domain-agnostic by pairing with similarly formatted retrieved examples that are provided in-context such that the domain-shift is reduced further to an example-guided question answering task. In TransferQA, the original dialogue state may be mapped to templated questions that correspond to each slot key and value pair, which in aggregate request for the equivalent information. For DST-EGQA, we may build on TransferQA and use the target dialogue as the query to retrieve similar examples from the database, which may be the same as the training set excluding the target.

Dialogue state tracking (DST) is defined as estimating the beliefs of possible user's goals at every dialogue turn, and it was traditionally formulated as a slot-filling task (Wu et al., 2020; Heck et al., 2020), and more recently as a structured text generation task (Hosseini-Asl et al., 2020; Peng et al., 2021; Su et al., 2022), shown as (0) in FIG. 14. However, we may also achieve the same outcome as domain-specific structured outputs through natural text by reformulating DST as a bundle of per-slot questions (Gao et al., 2019; Lin et al., 2021a) to answer or sentences to complete using each slot description (Lin et al., 2021b), such as (1) in FIG. 15.

Further generalization may be achieved by transforming domain-specific question answering to domain-agnostic, example-guided question answering. This kind of task reformulation, as demonstrated by Wang et al. (2022); Min et al. (2022); Ouyang et al. (2022), may enable the development of models that achieve state-of-the-art zero-shot performance and generalizability even with much smaller models by explicitly fine-tuning with instructions and in-context examples. Since most recent work that focus on generalizability and zero-shot models may leverage generation models because of its open vocabulary, we also place our focus on generation models.

With DST-EGQA, we may apply these two main ideas to continual learning for DST: the process of sequentially training on a stream of n domains {T₁ . . . Tₙ} with the goal of minimal degradation, i.e., catastrophicforgetting, of peak performance that was achieved when training for each Tᵢ.

Here, we define our approach more formally and provide details on how we leverage the two main motivations to achieve our goal.

The first step of DST-EGQA may be to transform DST into question answering as shown in (1) in FIG. 14. Here, we may leverage the TransferQA (Lin et al., 2021a) format. Given a user's utterance of a turn uₜ in a dialogue {u₁, . . . , uₙ} of domain T and its corresponding dialogue state DS expressed as slot key value pairs {(s_{t,i}, v_{t,i})|i∈I} for I={1, . . . , N_{T}}, where N_{T} is the number of slots of interest for domain T, each s_{t,i} may be transformed to a question with a manually pre-defined template Q: sᵢ→qᵢ. The overhead of creating these templates may be minimal as it only has to be done once and is as simple as transforming the name slot in the hotel domain to a natural text question equivalent “What is the name of the hotel that the user wants?”. Thus, with dialogue history until turn t as Hₜ={u₁, . . . , uₜ}, the original single input output pair of

Hₜ⊕T→{(s_{t,i}=v_{t,i})|i∈I} (1)

may become NT granular question answer pairs:

{Q(_{st,i})⊕Hₜ→v_{t,i}∈I} (2)

where ⊕ denotes simple text concatenation. A difference with the original TransferQA approach may be that since we may be finetuning the model, we may skip the step of training with external question answering datasets and may not take any special measures to handle “none” slots, i.e., empty slots, because our models may learn to generate none as the answer for empty slots.

Then, motivated by the results from Tk-instruct Wang et al. (2022) and MetaICL (Min et al., 2022) that showed even relatively small models can generalize well if explicitly trained to follow instructions with examples, we explore whether we can prevent a model from overfitting to domain-specific questions and instead continually develop example-based question answering capabilities to enhance continual learning performance. Therefore, we may extend Equation 2 to include in-context examples that are retrieved from the training set, as shown in (2) in FIG. 14. To retrieve relevant examples, we may use Hₜ to form a query that retrieves top k samples {H′ᵣ^{j}|j≤k} to use as in-context examples. By inserting the retrieved examples and their relevant slot values for each slot question qᵢ, the final format may become:

Q(_{st,i})⊕{H′ₜ^{j}⊕v′_{t,i}^{j}|j≤k}⊕Hₜ→v_{t,i}|i∈I} (3)

Throughout this disclosure, we use k=1 unless otherwise specified.

The goal of the retrieval system may be to find an example turn H′ₜ′ that requires similar reasoning for answering the target sample Ht, such that fine-tuning with it as an in-context example will help enable the model to apply the same reasoning for answering the question for the target sample. In Hu et al. (2022), the authors found that instead of matching for dialogue state overlap, matching for similar dialogue state change ΔDS, i.e., state change similarity (SCS), that occurs at turn t returns more relevant examples. State changes may be simply a subset of DS that is different from the previous turn: ΔDS={(s_{t,i},V_{t,i})|i∈I,v_{t,i}≠v_{t-1,i}}.

We found that computing similarity with this definition of state change may result in many ties, so we may make minor modifications by including the ΔDS operations, e.g., INSERT, DELETE, and UPDATE, as part of the slot key: ΔDSₒᵤᵣₛ={(s₁⊕o₁, v₁), . . . (sₘ⊕oₘ,vₘ)}, where o is the slot operation. To resolve the remaining ties, we may compute similarity using the last user and bot utterance pair and BM25 (Robertson et al., 2009) as the second-level re-ranker. With our changes, we were able to observe a much better top k=1 match, which we verified manually with 100 random samples. We denote examples retrieved with this new SCS+BM25 score as the Oracle because getting ΔDS requires knowing the DS to predict ahead of time, and therefore cannot be used at test time. However, the Oracle score may be useful for training a retriever that can learn to identify similar ΔDS and for estimating the upper bound for DST-EGQA.

Using the Oracle score, for each sample in the training set, we may calculate its similarity with other training samples and select the top 200 samples. From the selected samples, we may pair the top ten and bottom ten as hard positive and hard negative samples, respectively, to train a SentenceBERT-based (Reimers and Gurevych, 2019) retriever using contrastive loss. We call the resulting retriever as IC-DST-ret. This may be the same configuration for creating the dataset that was used to train the original retriever used for IC-DST, but instead of using x % of the entire training data, we may use the entire training set of the first domain T₁ to train separate retrievers for each of the five domain orderings. We may impose this constraint such that we conduct our experiments under the practical assumption that we are only provided data for T₁ at the beginning, and we do not want to extend the continual learning problem for training the retriever.

We also experiment with simpler retrieval techniques as baselines to our IC-DST retriever: (i) BM25 (Robertson et al., 2009), (ii) GPT: OpenAI's text-embedding-ada-002 model (iii) SentenceBERT (Reimers and Gurevych, 2019): the all-mpnet-base-v2 model (iv) and original IC-DST retriever (orig. IC-DST-ret): the retriever from Hu et al. (2022) that was trained with the original SCS formulation and pairs created from the MultiWOZ2.1 dataset (Eric et al., 2020). We also evaluate with random retrieval as a control. With the exception of the orig. IC-DST-ret, which was trained to identify similarity with the last turn's dialogue state and last utterance pairs between the bot and user: {(s_{t-1,i}=v_{t-1,i})|i∈I}⊕uₜ₋₁⊕uₜ, the query and key of the database may use only the last utterance pairs: uₜ₋₁⊕uₜ. We found this approach to be better as it may diminish the undesirably high similarity assigned to examples from the same dialogue that have the same previous dialogue state.

Experimental Setup

We use the continual learning setup proposed by Zhu et al. (2022), which uses 15 single-domains from the Schema Guided Dialogue dataset (Ras-togi et al., 2020), and aggregate our results over the same five domain orders to make the most reliable comparisons with their results. Comparing results with the same order may be important as we may find that results can have significant variance depending on the chosen domains and their order. For multi-task training, there may be only a single permutation, and therefore we aggregate results over runs with three different seed values. Note that our formulation described previously shows that we are operating under the assumption that the domain of interest will be known ahead of time.

TABLE 6
CL metric results and reliance on other continual learning techniques. We compare models sequentially
trained on 15 tasks from the SGD dataset and aggregate results across five different domain
permutations. DST-EGQA achieves the best results without any additional parameters or regularization
methods. The last two rows provide the multi-tasking results, which serve as an upper bound.
In this table, results with retrievers are with a single in-context example and the indicated
retriever is used for training and test time while the Oracle retriever is used for the validation
step. All rows that use memory are with M = 50.

| Method | Retriever | Avg. JGA | FWT | BWT | +Memory | +Params | +Reg. |
|---|---|---|---|---|---|---|---|
| SimpleTOD (2020) | | 14.4_{2.7} | 7.1_{1.0} | −42.5_{2.4} | — | — | — |
| EWC (2017) | | 13.9_{1.1} | 8.4_{0.9} | −50.8_{4.3} | ✓ | ✓ | ✓ |
| Memory (2021) | — | 58.6_{3.5} | 10.9_{0.5} | −3.2_{2.3} | ✓ | — | — |
| Adapter (2021) | | 49.8_{1.7} | — | — | — | ✓ | — |
| CPT (2022) | | 61.2_{2.5} | 13.7_{0.8} | 0.5_{0.4}^{†} | ✓ | ✓ | ✓ |
| DST-EGQA | — | 43.2_{3.4} | 14.1_{1.9} | −31.0_{4.2} | — | — | — |
| + Memory | | 59.8_{1.6} | 15.6_{1.7} | −12.8_{2.0} | ✓ | | |
| + Dialogue Memory | | 64.2_{0.8} | 15.0_{2.1} | −7.4_{2.2} | | | |
| DST-EGQA | IC-DST-ret | 54.1_{3.3} | 22.8_{1.8} | −22.3_{4.5} | — | — | — |
| + Dialogue Memory | | 68.9_{0.3}^{†} | 21.2_{1.5} | −6.1_{1.7} | ✓ | | |
| DST-EGQA | Oracle | 55.5_{3.5} | 23.6_{2.1} | −19.1_{4.2} | — | — | — |
| + Dialogue Memory | | 69.3_{1.0} | 22.5_{1.8} | −5.9_{1.9} | ✓ | | |
| CPT Multi-task (2022) | — | 64.0_{1.9} | — | — | — | ✓ | ✓ |
| DST-EGQA Multi-task | — | 74.2_{1.8} | — | — | — | — | — |

^{†}indicates statistically significant at p < 0.05 with the next best comparable value.

DST performance may be mainly measured by joint goal accuracy (JGA), which measures the percentage of turns that all slot values were correctly predicted. For CL, given JGA for domain i after training up to the t^{th} domain a_{t,i} and the total number of domains T, we compare our approaches with three metrics from Zhu et al. (2022):

$$Average J G A = \frac{1}{T} {\sum }_{i = 1}^{T} {a}_{T , i} \qquad ( i )$$

the average of JGA on each domain after training on all domains in the continual learning setup,

$$Forward Transfer ( FW T ) = \frac{1}{T - 1} {\sum }_{i = 2}^{T} {a}_{i - 1 , i} \qquad ( ii )$$

how much training on the current domain boosts JGA on future unseen domains, and

$$Backward Transfer ( BW T ) = \frac{1}{T - 1} {\sum }_{i = 1}^{T - 1} {a}_{T , i} - {a}_{i , i} , \qquad ( iii )$$

how much the training on the current domain reduced JGA on previously seen domains. We place the most importance on Final JGA, while FWT and BWT provides additional signal on how different approaches provide more transferability, hence task consistency, between domains.

We replicate the baseline results from Zhu et al. (2022) using their implementation, which include approaches from Madotto et al. (2021):
SimpleTOD (Hosseini-Asl et al., 2020): performs DST as a structured text generation task, predicting the full state as a single sequence. As was done in Zhu et al. (2022), we modify the SimpleTOD format to append the domain name at the end of the dialogue history as described in Equation 1.
Memory: randomly selects M turns from the training data for each previous domain and includes it in the current domain's training data.
EWC: uses the same samples selected for memory replay to regularize with the Fisher information matrix (Kirkpatrick et al., 2017)
AdapterCL (Madotto et al., 2021): freezes the base model and trains parameter efficient adapters for each domain with number of weights that are equivalent to 2% of that of the pretrained model.
Continual Prompt Tuning (Zhu et al., 2022): freezes the base model and continually trains soft prompts after reformulating DST as a masked-span recovery task (Raffel et al., 2020).

We include their best results that takes advantage of a memory buffer for replay and for memory-guided backward transfer, a form of regularization that prevents updates if it would increase the current model's loss on the memory samples by computing gradients on them.

For DST-EGQA, we compare various configurations to better understand the strengths and weaknesses of our approach. We vary the retriever used during training and combine with other memory replay strategies. We also show CPT Multi-task and DST-EGQA Multi-task to show the multi-tasking upper bound performance for average JGA.

We conduct our experiments with the T5-small model (Raffel et al., 2020). We train with a single GPU using the AdamW optimizer, a learning rate of 1e-4, and a batch size of 16. We train on each domain for ten epochs without early stopping. We select the checkpoint with the best validation set performance when moving on to the next domain. Our experiments are run on V100, A40, and A100 GPUs, based on availability. Note that our preliminary experiments with different GPU types with otherwise same configurations showed that the choice of GPU in final performance may introduce minimal variability to the final result.

Experiments and Analysis

The main results are as follows. Firstly, TransferQA's format may be more CL-friendly. As shown in the first row after CPT in Table 6, transforming the DST task from prior work (Equation 1) to that of granular question answering using the TransferQA (Equation 2) format may already produce a dramatic improvement in CL performance, increasing average JGA from 14.4 to 43.2, and also improving on both FWT and BWT.

Secondly, example-guided question answering may further enhance CL performance. The subsequent rows for DST-EGQA shows that fine-tuning with in-context examples may further enhance all CL metrics by a large margin. Most notable may be the boosts that are seen in the FWT, which memory replay may have almost a negligible effect. Augmenting DST-EGQA with memory replay may lead to even larger boosts, even exceeding the CPT Multi-task model, with most gains coming from BWT, which may be expected with memory replay methods. Using the Oracle retriever at test time may only lead to statistically insignificant improvements, indicating that IC-DST-ret may retrieve examples that are on par with the Oracle examples. Lastly, we may see that the relative gains in average JGA and BWT from memory replay becomes less pronounced with models trained with in-context examples, indicating that memory replay and example-guided question answering have overlapping gains.

TABLE 7
Train-validation-test retrieval method comparison. Keeping the Training
and Test-time retrieval methods the same while keeping the development
set as the Oracle leads to the best results, except for the last
row, which requires knowing the correct answer ahead of time.

| Train | Dev | Test | Avg. JGA | FWT | BWT |
|---|---|---|---|---|---|
| — | — | — | 43.2_{3.4} | 14.1_{1.9} | −31.0_{4.2} |
| IC-DST-ret | IC-DST-ret | IC-DST-ret | 45.1_{3.0} | 21.4_{1.4} | −31.9_{3.4} |
| IC-DST-ret | Oracle | | 54.1_{3.3}^{†} | 22.8_{1.8} | −22.3_{4.5} |
| Oracle | Oracle | | 48.5_{3.2} | 19.6_{1.6} | −27.1_{1.4} |
| Oracle | Oracle | Oracle | 53.7_{4.4} | 24.1_{2.6} | −21.3_{4.1} |
| IC-DST-ret | | | 55.5_{3.5} | 23.6_{2.1} | −19.1_{4.2} |

^{†}indicates statistically significant at p < 0.05 with the next best value.

Thirdly, double-dipping the training set as a retrieval database may not lead to overfitting. It may be important to note that, because our retrieval methods are commutative, a target sample that is paired with an example may serve as an example when the example becomes the target sample. Therefore, the answers for all training samples may be seen as part of the context during training with our setup described previously. This may raise overfitting concerns where the model easily memorizes the answers for all samples and it doesn't learn generalizable question-answering. Interestingly, this does not seem to be the case, as training in this setup leads to improved or on-par final test set performance as training without any examples. This may imply that our approach does not impose additional data constraints of having to split the training set into dedicated training samples and retrieval samples for it to be effective.

However, not shown in Table 6 is that we find that DST-EGQA may be sensitive to the training dynamics and the quality of the retrieved examples.

In a practical setting without an ideal retriever and large enough database that allow us to find a perfect example for each case seen during test time, it may be important for the model to be able to leverage relevant examples and ignore irrelevant ones. To become more robust to these realistic circumstances, it may be useful to intentionally mix in irrelevant examples during training for DST-EGQA, and therefore we vary the combination of IC-DST-ret and Oracle used for training, validation, and test time. Results in Table 7 may support our hypothesis, showing that aligning the retrieval method from training time with test time leads to the best performance. Interestingly, best performance is achieved by using the Oracle retriever at validation time, shown by the large gap between IC-DST-ret→IC-DST-ret→IC-DST-ret and IC-DST-ret→Oracle→IC-DST-ret (second and third row). This is somewhat surprising given that one may expect selecting a checkpoint that performs the best in the same setting as test time would lead to better test time performance.

TABLE 8
Retrieval methods comparison. Although mixing in irrelevant examples
can boost performance, our results show that lacking a reliable
retrieval method at test time is critical to performance. Our IC-
DST-ret model may capture this balance the most effectively.

| Train, Test | Dev | Avg. JGA | FWT | BWT |
|---|---|---|---|---|
| — | — | 43.2_{3.4} | 14.1_{1.9} | −31.0_{4.2} |
| Random | Oracle | 45.5_{4.5} | 14.2_{2.2} | −31.4_{5.1} |
| BM25 | | 46.7_{3.3} | 21.6_{1.6} | −20.1_{5.0} |
| SentBERT | | 46.2_{6.0} | 17.3_{2.0} | −29.7_{6.9} |
| GPT | | 47.8_{7.9} | 17.5_{2.4} | −27.0_{8.7} |
| orig. IC-DST-ret | | 49.2_{4.7} | 19.9_{2.1} | −26.2_{5.2} |
| IC-DST-ret (ours) | | 54.1_{3.3}^{†} | 22.8_{1.8} | −22.3_{4.5} |

Previous findings may raise a question on whether training with other retrievers that may provide a different mixture of good and bad examples can lead to further boost performance with DST-EGQA. We apply all the retrievers previously defined and use the same training dynamics that led to best results previously to examine each of their effectiveness. Interestingly, our IC-DST-ret model seems to capture this balance the most effectively, as it is significantly better than all other retrieval methods.

As hinted by the results in Table 6, dialogue-level sampling seems to be a superior sampling strategy to turn-level sampling. We take a deeper dive into the relationship between the two sampling techniques and how both approaches scale with memory budgets by varying the memory budget sizes to 10, 50, and 100. Table 9 shows that dialogue-level sampling achieves a significantly better performance for all equivalent memory budget sizes for turn-level sampling and even on par with the next budget size used for turn-level sampling. This is likely due to dialogue-sampling leading to a more comprehensive set of samples that cover a wider diversity of dialogue state updates in these smaller sizes of the memory budget. As the memory budget becomes larger, however, the gap between turn-level sampling and dialogue-level sampling diminishes, since both methods may converge to multi-task training when the memory budget is unlimited.

TABLE 9
Memory analysis for the DST-EGQA. Sampling at the dialogue-
level may be much more effective than sampling at the turn-
level, especially for a constrained memory budget.

| Size | Method | Avg. JGA | FWT | BWT |
|---|---|---|---|---|
| — | — | 43.2_{3.4} | 14.1_{1.9} | −31.0_{4.2} |
| 10 | Turn | 50.1_{3.8} | 15.0_{1.4} | −23.7_{4.4} |
| | Dialogue | 59.1_{1.5} | 15.2_{2.7} | −14.7_{2.3} |
| 50 | Turn | 59.8_{1.6} | 15.6_{1.7} | −12.8_{2.0} |
| | Dialogue | 64.2_{0.8} | 15.0_{2.1} | −7.4_{2.2} |
| 100 | Turn | 63.9_{1.2} | 15.6_{1.7} | −8.7_{1.3} |
| | Dialogue | 66.8_{1.5} | 15.4_{2.1} | −3.3_{2.5} |

TABLE 10
Number of examples analysis. Small models may be unable to leverage
more than one example when training to do in-context learning.

| Train, Test | # Examples | Avg. JGA | FWT | BWT |
|---|---|---|---|---|
| — | — | 43.2_{3.4} | 14.1_{1.9} | −31.0_{4.2} |
| Random | 1 | 43.2_{6.8} | 14.5_{1.7} | −33.3_{5.7} |
| | 2 | 45.2_{4.5} | 15.5_{1.8} | −31.6_{6.2} |
| | 3 | 43.9_{6.2} | 16.9_{1.6} | −31.4_{6.7} |
| BM25 | 1 | 45.9_{4.5} | 20.3_{1.9} | −21.4_{6.2} |
| | 2 | 46.2_{6.1} | 23.3_{1.6} | −17.1_{7.5} |
| | 3 | 47.0_{5.3} | 20.8_{2.0} | −21.8_{5.5} |
| IC-DST-ret | 1 | 54.1_{3.3} | 22.8_{1.8} | −22.3_{4.5} |
| | 2 | 50.2_{3.7} | 22.0_{1.8} | −29.3_{5.2} |
| | 3 | 48.0_{4.4} | 21.8_{1.9} | −22.3_{4.1} |
| Oracle | 1 | 53.7_{4.4} | 24.1_{2.6} | −21.3_{4.1} |
| | 2 | 54.3_{3.0} | 28.7_{2.6} | −18.5_{3.6} |
| | 3 | 53.9_{3.8} | 30.5_{1.5} | −14.1_{2.6} |

Including only one example to learn from in-context may create a single point of failure, which may be especially risky for suboptimal retrieval methods. Thus, having additional examples to learn from may help mitigate this risk, and therefore we also repeat our experiments using multiple in-context examples. However, at least with small model sizes, the DST models may be not able to effectively leverage additional examples. This may be not surprising for the Oracle retriever, where in most cases the top example is the best example that can be leveraged from the training set.

Related Work

Continual learning may prolong the lifetime of a model by training it further with new incoming data without incurring the cost of catastrophicforgetting (McCloskey and Cohen, 1989; French, 1999). There may be three main branches of continual learning: architecture-based methods, replay-based methods, and regularization-based methods. Architecture-based methods may propose dynamically adding model weights when learning new data (Fernando et al., 2017; Shen et al., 2019). Replay-based methods may mitigate catastrophic forgetting by keeping a small sample of the previous data as part of a memory budget to train with the new data (Rebuffi et al., 2017; Hou et al., 2019). These methods may mainly experiment with sampling strategies and memory budget efficiency. Lastly, regularization-based methods may place constraints on how the model becomes updated during training with the new data such that its performance on previous data is maintained (Kirkpatrick et al., 2017; Li and Hoiem, 2018).

Continual learning for DST has been explored by a series of recent work that applied a combination of methods mentioned above. Liu et al. (2021) expanded on SOM-DST (Kim et al., 2020) with prototypical sample selection for the memory buffer and multi-level knowledge distillation as a regularization mechanism. Madotto et al. (2021) applied various continual learning methods to end-to-end task-oriented dialogue models and found that adapters are most effective for the intent classification and DST while memory is most effective for response generation. More recently, Zhu et al. (2022) proposed Continual Prompt Tuning (CPT), which may be related to our work. CPT may improve continual learning performance by finetuning soft prompts for each domain and reformulating DST to align with T5's masked-span recovery pretraining objective (Raffel et al., 2020). Compared to CPT, the embodiments disclosed herein suggest a more granular reformulation to facilitate the learning from examples and may not rely on any regularization nor additional weights.

Enhancing a model's generalizability to various tasks by reformulating their input/outputs to become more uniform has become an increasingly popular method for massive multi-task learning (Aghajanyan et al., 2021), even for tasks that were considered distant from one another. T5 (Raf-fel et al., 2020) accelerated this movement by providing dataset or task-specific labels or minimal instructions to the inputs and then doing multi-task training. Building on T5, Sanh et al. (2022) and Wei et al. (2021) used more elaborate and diverse set of instruction templates and showed that this can significantly boost zero-shot performance. Cho et al. (2022) applied a similar idea to a more selective set of pre-finetuning tasks before training on the target DST dataset to improve DST robustness. Tk-instruct (Wang et al., 2022) takes a step further by scaling up the amount of tasks included in TO and also provides positive and negative examples in the context in addition to the instructions. Similarly, Min et al. (2022) introduced MetaICL, which explicitly trains a model with the few-shot in-context learning format used for large language models (Brown et al., 2020), and showed that it showed better in-context learning performance than larger models. Task reformulation has also been recently explored to help the model better understand the task at hand and reduce domain-specific memorization and thus boost zero-shot DST performance (Li et al., 2021; Lin et al., 2021a; Gupta et al., 2022; Zhao et al., 2022).

Conclusion

The embodiments disclosed herein present Dialogue State Tracking as Example-Guided Question Answering as a method for enhancing continual learning performance that factors dialogue state tracking into granular question answering tasks and fine-tunes the model to leverage relevant in-context examples to answer these questions. Our method may be an effective alternative to existing continual learning approaches that does not rely on complex regularization, parameter expansion, or memory sampling techniques. Analysis of our approach finds that even models as small as 60 M parameters may be trained to perform in-context learning for continual learning and that complementing it with memory replay with samples randomly selected at the dialogue-level may achieve state-of-the-art results compared to strong baselines.

### REFERENCES

Armen Aghajanyan, Anchit Gupta, Akshat Shrivastava, Xilun Chen, Luke Zettlemoyer, and Sonal Gupta. 2021. Muppet: Massive multi-task representations with pre-finetuning. In Proceedings of the 2021 Conference on Empirical Methods in Natural Language Processing, pages 5799-5811, Online and Punta Cana, Dominican Republic. Association for Computational Linguistics.
Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al. 2020. Language models are few-shot learners. Advances in neural information processing systems, 33:1877-1901.
Hyundong Cho, Chinnadhurai Sankar, Christopher Lin, Kaushik Sadagopan, Shahin Shayandeh, Ash Celiky-ilmaz, Jonathan May, and Ahmad Beirami. 2022. Know thy strengths: Comprehensive dialogue state tracking diagnostics. In Findings of the Association for Computational Linguistics: EMNLP 2022, pages 5345-5359, Abu Dhabi, United Arab Emirates. Association for Computational Linguistics.
Mihail Eric, Rahul Goel, Shachi Paul, Abhishek Sethi, Sanchit Agarwal, Shuyang Gao, Adarsh Kumar, Anuj Goyal, Peter Ku, and Dilek Hakkani-Tur. 2020. MultiWOZ 2.1: A consolidated multi-domain dialogue dataset with state corrections and state tracking base-lines. In Proceedings of the 12th Language Resources and Evaluation Conference, pages 422-428, Marseille, France. European Language Resources Association.
Chrisantha Fernando, Dylan Banarse, Charles Blundell, Yori Zwols, David Ha, Andrei A Rusu, Alexander Pritzel, and Daan Wierstra. 2017. Pathnet: Evolution channels gradient descent in super neural networks. arXiv preprint arXiv:1701.08734.
Robert M French. 1999. Catastrophic forgetting in connectionist networks. Trends in cognitive sciences, 3(4):128-135.
Shuyang Gao, Abhishek Sethi, Sanchit Agarwal, Tagy-oung Chung, and Dilek Hakkani-Tur. 2019. Dialog state tracking: A neural reading comprehension approach. In Proceedings of the 20th Annual SIGdial Meeting on Discourse and Dialogue, pages 264-273, Stockholm, Sweden. Association for Computational Linguistics.
Raghav Gupta, Harrison Lee, Jeffrey Zhao, Yuan Cao, Abhinav Rastogi, and Yonghui Wu. 2022. Show, don't tell: Demonstrations outperform descriptions for schema-guided task-oriented dialogue. In Proceedings of the 2022 Conference of the North American Chapter of the Association for Computational Linguistics: Human Language Technologies, pages 4541-4549, Seattle, United States. Association for Computational Linguistics.
Michael Heck, Carel van Niekerk, Nurul Lubis, Christian Geishauser, Hsien-Chin Lin, Marco Moresi, and Milica Gasic. 2020. TripPy: A triple copy strategy for value independent neural dialog state tracking. In Proceedings of the 21th Annual Meeting of the Special Interest Group on Discourse and Dialogue, pages 35-44, 1st virtual meeting. Association for Computational Linguistics.
Ehsan Hosseini-Asl, Bryan McCann, Chien-Sheng Wu, Semih Yavuz, and Richard Socher. 2020. A simple language model for task-oriented dialogue. Advances in Neural Information Processing Systems, 33:20179-20191.
Saihui Hou, Xinyu Pan, Chen Change Loy, Zilei Wang, and Dahua Lin. 2019. Learning a unified classifier incrementally via rebalancing. In Proceedings of the IEEF/CVF conference on Computer Vision and Pattern Recognition, pages 831-839.

Yushi Hu, Chia-Hsuan Lee, Tianbao Xie, Tao Yu, Noah A. Smith, and Mari Ostendorf. 2022. In-context learning for few-shot dialogue state tracking. In Findings of the Association for Computational Linguistics: EMNLP 2022, pages 2627-2643, Abu Dhabi, United Arab Emirates. Association for Computational Linguistics.
Sungdong Kim, Sohee Yang, Gyuwan Kim, and Sang-Woo Lee. 2020. Efficient dialogue state tracking by selectively overwriting memory. In Proceedings of the 58th Annual Meeting of the Association for Computational Linguistics, pages 567-582, Online. Association for Computational Linguistics.
James Kirkpatrick, Razvan Pascanu, Neil Rabinowitz, Joel Veness, Guillaume Desjardins, Andrei A Rusu, Kieran Milan, John Quan, Tiago Ramalho, Ag-nieszka Grabska-Barwinska, et al. 2017. Overcoming catastrophic forgetting in neural networks. Proceedings of the national academy of sciences, 114(13):3521-3526.
Shuyang Li, Jin Cao, Mukund Sridhar, Henghui Zhu, Shang-Wen Li, Wael Hamza, and Julian McAuley. 2021. Zero-shot generalization in dialog state tracking through generative question answering. In Proceedings of the 16th Conference of the European Chapter of the Association for Computational Linguistics: Main Volume, pages 1063-1074, Online. Association for Computational Linguistics.
Zhizhong Li and Derek Hoiem. 2018. Learning without forgetting. IEEE Transactions on Pattern Analysis and Machine Intelligence, 40(12):2935-2947.
Zhaojiang Lin, Bing Liu, Andrea Madotto, Seungwhan Moon, Zhenpeng Zhou, Paul Crook, Zhiguang Wang, Zhou Yu, Eunjoon Cho, Rajen Subba, and Pascale Fung. 2021a. Zero-shot dialogue state tracking via cross-task transfer. In Proceedings of the 2021 Conference on Empirical Methods in Natural Language Processing, pages 7890-7900, Online and Punta Cana, Dominican Republic. Association for Computational Linguistics.
Zhaojiang Lin, Bing Liu, Seungwhan Moon, Paul Crook, Zhenpeng Zhou, Zhiguang Wang, Zhou Yu, Andrea Madotto, Eunjoon Cho, and Rajen Subba. 2021b. Leveraging slot descriptions for zero-shot cross-domain dialogue StateTracking. In Proceedings of the 2021 Conference of the North American Chapter of the Association for Computational Linguistics: Human Language Technologies, pages 5640-5648, Online. Association for Computational Linguistics.
Qingbin Liu, Pengfei Cao, Cao Liu, Jiansong Chen, Xunliang Cai, Fan Yang, Shizhu He, Kang Liu, and Jun Zhao. 2021. Domain-lifelong learning for dialogue state tracking via knowledge preservation networks. In Proceedings of the 2021 Conference on Empirical Methods in Natural Language Processing, pages 2301-2311, Online and Punta Cana, Dominican Republic. Association for Computational Linguistics.
Andrea Madotto, Zhaojiang Lin, Zhenpeng Zhou, Se-ungwhan Moon, Paul Crook, Bing Liu, Zhou Yu, Eu-njoon Cho, Pascale Fung, and Zhiguang Wang. 2021. Continual learning in task-oriented dialogue systems. In Proceedings of the 2021 Conference on Empirical Methods in Natural Language Processing, pages 7452-7467, Online and Punta Cana, Dominican Republic. Association for Computational Linguistics.
Michael McCloskey and Neal J Cohen. 1989. Catastrophic interference in connectionist networks: The sequential learning problem. In Psychology of learning and motivation, volume 24, pages 109-165. Elsevier.
Sewon Min, Mike Lewis, Luke Zettlemoyer, and Han-naneh Hajishirzi. 2022. MetaICL: Learning to learn in context. In Proceedings of the 2022 Conference of the North American Chapter of the Association for Computational Linguistics: Human Language Technologies, pages 2791-2809, Seattle, United States. Association for Computational Linguistics.
Long Ouyang, Jeff Wu, Xu Jiang, Diogo Almeida, Carroll L Wainwright, Pamela Mishkin, Chong Zhang, Sandhini Agarwal, Katarina Slama, Alex Ray, et al. 2022. Training language models to follow instructions with human feedback. arXiv preprint arXiv:2203.02155.
Baolin Peng, Chunyuan Li, Jinchao Li, Shahin Shayan-deh, Lars Liden, and Jianfeng Gao. 2021. Soloist: Building task bots at scale with transfer learning and machine teaching. Transactions of the Association for Computational Linguistics, 9:807-824.
Colin Raffel, Noam Shazeer, Adam Roberts, Katherine Lee, Sharan Narang, Michael Matena, Yanqi Zhou, Wei Li, Peter J Liu, et al. 2020. Exploring the limits of transfer learning with a unified text-to-text transformer. J. Mach. Learn. Res., 21(140):1-67.
Abhinav Rastogi, Xiaoxue Zang, Srinivas Sunkara, Raghav Gupta, and Pranav Khaitan. 2020. Towards scalable multi-domain conversational agents: The schema-guided dialogue dataset. In Proceedings of the AAAI Conference on Artifcial Intelligence, volume 34, pages 8689-8696.
Sylvestre-Alvise Rebuffi, Alexander Kolesnikov, Georg Sperl, and Christoph H Lampert. 2017. icarl: Incremental classifier and representation learning. In Proceedings of the IEEE conference on Computer Vision and Pattern Recognition, pages 2001-2010.
Nils Reimers and Iryna Gurevych. 2019. Sentence-BERT: Sentence embeddings using Siamese BERT-networks. In Proceedings of the 2019 Conference on Empirical Methods in Natural Language Processing and the 9th International Joint Conference on Natural Language Processing (EMNLP-IJCNLP), pages 3982-3992, Hong Kong, China. Association for Computational Linguistics.
Stephen Robertson, Hugo Zaragoza, et al. 2009. The probabilistic relevance framework: Bm25 and beyond. Foundations and Trends® in Information Retrieval, 3(4):333-389.
Victor Sanh, Albert Webson, Colin Raffel, Stephen Bach, Lintang Sutawika, Zaid Alyafeai, Antoine Chaffin, Arnaud Stiegler, Teven Le Scao, Arun Raja, et al. 2022. Multitask prompted training enables zero-shot task generalization. In The Tenth International Conference on Learning Representations.
Yilin Shen, Xiangyu Zeng, and Hongxia Jin. 2019. A progressive model to enable continual learning for semantic slot filling. In Proceedings of the 2019 Conference on Empirical Methods in Natural Language Processing and the 9th International Joint Conference on Natural Language Processing (EMNLP-IJCNLP), pages 1279-1284, Hong Kong, China. Association for Computational Linguistics.
Yixuan Su, Lei Shu, Elman Mansimov, Arshit Gupta, Deng Cai, Yi-An Lai, and Yi Zhang. 2022. Multi-task pre-training for plug-and-play task-oriented dialogue system. In Proceedings of the 60th Annual Meeting of the Association for Computational Linguistics (Volume 1: Long Papers), pages 4661-4676, Dublin, Ireland. Association for Computational Linguistics.
Yizhong Wang, Swaroop Mishra, Pegah Alipoor-molabashi, Yeganeh Kordi, Amirreza Mirzaei, Anjana Arunkumar, Arjun Ashok, Arut Selvan Dhanasekaran, Atharva Naik, David Stap, et al. 2022. Super-naturalinstructions: Generalization via declarative instructions on 1600+nlp tasks. URL https://arxiv.org/abs/2204.07705.
Jason Wei, Maarten Bosma, Vincent Y Zhao, Kelvin Guu, Adams Wei Yu, Brian Lester, Nan Du, Andrew M Dai, and Quoc V Le. 2021. Finetuned language models are zero-shot learners. arXiv preprint arXiv:2109.01652.
Chien-Sheng Wu, Steven C. H. Hoi, Richard Socher, and Caiming Xiong. 2020. TOD-BERT: Pre-trained natural language understanding for task-oriented dialogue. In Proceedings of the 2020 Conference on Empirical Methods in Natural Language Processing (EMNLP), pages 917-929, Online. Association for Computational Linguistics.
Jeffrey Zhao, Raghav Gupta, Yuan Cao, Dian Yu, Mingqiu Wang, Harrison Lee, Abhinav Rastogi, Izhak Shafran, and Yonghui Wu. 2022. Description-driven task-oriented dialog modeling. arXiv preprint arXiv:2201.08904.
Qi Zhu, Bing Li, Fei Mi, Xiaoyan Zhu, and Minlie Huang. 2022. Continual prompt tuning for dialog state tracking. In Proceedings of the 60th Annual Meeting of the Association for Computational Linguistics (Volume 1: Long Papers), pages 1124-1137, Dublin, Ireland. Association for Computational Linguistics.

### Appendix

This section discloses additional details of the embodiments disclosed herein. The additional details of state change similarity are as follows. Given two set of state changes represented as ΔDSₐ={(s₁, v₁), . . . (sₘvₘ)} and ΔDS_{b}={(s₁, v₁), . . . (sₙvₙ)} where s is the slot key and v is the slot value to update the slot to, Hu et al. (2022) defines state change similarity (SCS) as the average of the similarity between slot keys s, Fₛₗₒₜ and the similarity between key value pairs, Fₛₗₒₜ₋ᵥₐₗᵤₑ:

$$S C S ( Δ D {S}_{a} , Δ {DS}_{b} ) = \frac{1}{2} ( {F}_{slot} + {F}_{slot - value} )$$

Similarity F between the two sets may be measured by computing the average of two F₁ scores using each set as the target. We may use the standard calculation:

$${F}_{1} = \frac{2 P R}{P + R} ′ ,$$

where P is precision and R is recall.

The resulting ties with this formula may be not as critical for IC-DST (Hu et al., 2022), because top k examples, where k is a sizeable value that includes most ties, were all provided as in-context learning examples.

The additional details of IC-DST retriever are as follows. We use the same hyperparameter settings as orig. IC-DST-ret (Hu et al., 2022), which uses the learning rate of 2e⁻⁵, 1000 warm-up steps, and the contrastive loss objective. We experimented with the binary classification evaluator and the triplet evaluator at test time for selecting the best checkpoint to use. Given labels 1, 0 for similar and dissimilar samples, the binary classification evaluator may determine accuracy based on the cosine similarity between the paired examples and an automatically calculated similarity threshold that results in the best accuracy. The triplet evaluator may compare whether distance(q, p)>distance(q, n), where p is the similar pair, n is the negative pair, and q is the query that serves as the anchor between the similar and dissimilar samples. We find that the two evaluators yield statistically insignificant differences in the final performance for our approach and therefore we use the triplet evaluator for all the results included in this disclosure. We exclude the previous turn's dialogue state as the input query when fine-tuning SentBERT (Reimers and Gurevych, 2019).

### Personalizing Smart Replies Using Neural Text Style Transfer

In particular embodiments, the assistant system 140 may generate personalized smart replies on-device by using neural text style transfer. In particular embodiments, the assistant system 140 may generate customized smart reply candidates using text style transfer based on historical typing patterns of a user. An end-to-end user experience with this feature may look something like the following example. A user may receive a message from their friend, which may be “Are you on your way?” The assistant system 140 may then generate personalized smart-reply candidates such as “Dude I'm running late!”, “Yeah”, “You bet!”, etc. Although this disclosure describes personalizing particular replies by particular systems in a particular manner, this disclosure contemplates personalizing any suitable reply by any suitable system in any suitable manner.

In particular embodiments, smart reply may be a feature provided by the assistant system 140 on head-mounted devices, e.g., VR headsets and smart glasses. The smart reply feature may allow users to quickly send canned replies to messages they receive. In particular embodiments, the canned replies may include a predetermined set of candidates, representing most commonly typed replies for some most commonly typed incoming messages. As an example and not by way of limitation, a user may receive a message from their friend, which is “Are you on your way?” The assistant system 140 may generate some smart-reply candidates such as “Sorry running late!”, “Yes”, “I'm on my way.”

The smart-reply feature may improve the user experience in general. However, according to some studies, few users actually selected one of the smart-reply candidates the assistant system 140 surfaced in messaging apps. The reasons may be as follows. One reason may be that the smart-reply candidates were not relevant to the incoming messages. Another reason may be that the smart-reply candidates were not personalized to the style of typing that each user may have. For example, demographically different users may type in a different way. Millennials may have their own lingo. Gen-Z may have their own lingo. Different generations may use different words to express the same thing. Another reason may be that the smart-reply candidates were usually static and rigid.

As may be seen, smart replies may need to be served on a user-to-user basis and learned on-device in a privacy preserving way. In particular embodiments, the assistant system 140 may personalize the smart-reply candidates based on the user's past text inputs. The assistant system 140 may utilize neural style transfer. In particular embodiments, as the user types the assistant system 140 may store whatever the user has typed on device. The assistant system 140 may then perform internal matching mechanism to the smart replies and determine how the user could have typed. Once the assistant system 140 has this type of parallel corpora on the device, the assistant system 140 may learn one or more machine-learning models to adapt a global smart-reply model shared across all users to a particular user style. Then the new smart-apply candidates surfaced to the user may be more in line with what the user could potentially type.

In particular embodiments, the assistant system 140 may require one or more machine-learning models to be trained and deployed on-device. These machine-learning models may include one or more of a text classification model, a text style transfer model, or a smart reply model.

In particular embodiments, the step-by-step process may be as described below. The assistant system 140 may first store user typed data on-device with a text-to-language (TTL) of a period of days (e.g., 90 days). The assistant system 140 may then preprocess the text data by cleaning it and performing any necessary transformations, such as tokenization and stemming. The assistant system 140 may then use text classification model to classify the historical text into buckets that correspond to the static smart-reply candidates. This may create a parallel corpus of data that looks like, e.g., “Yeah!” to “yes”, “Dude I'm running late” to “Sorry! I'm running late”, “You bet!” to “For sure”, “No sweat!” to “Thank you”, etc. The assistant system 140 may then fine-tune the sequence-to-sequence text style transfer model on the parallel corpus on-device. The assistant system 140 may then use the trained model to convert the smart-reply candidates into typing style of the user. The assistant system 140 may further map the static reply to the newly generated style transfer replies if they are semantically similar. However, if they are not semantically similar, the assistant system 140 may not map.

In particular embodiments, there may be constraints associated with the training of the models. Since it's messaging data, the assistant system 140 may not leak any information on the server side to protect user privacy. As a result, every part of the training may occur on each client device.

The first step of training may be storing whatever keystrokes of the user on the device, e.g., as a look-up table. When the user gets an incoming message, the user may either click on a smart-reply candidate or type something themselves. If the user does click on the candidate, the assistant system 140 may store the candidate response as is or the assistant system 140 may choose not to store that at all for any purposes. But when the user ignores the smart reply but types by themselves. It may indicate that the smart-apply candidates are not relevant or the smart-reply candidates are relevant but they don't match the user's style.

The assistant system 140 may perform the most semantically similar matching with available smart-reply candidates, e.g., based on each of the explicitly typed keys. For example, the user typed “No sweat” so the assistant system 140 may find what is the best reply in a list of candidates which closely matches. After this step, the assistant system 140 may obtain a parallel corpora available on the device. On the device, there may be a small lightweight semantic similarity model which may just generate a score for the two sets of keystrokes or tasks and perform matching based on either cosine similarity or some other metric. For example, on a scale from 0 to 1, 1 may indicate being extremely similar whereas 0 may indicate being not similar at all. For a particular response which the user types, there may be several different matching candidates with different degrees of similarity. The assistant system 140 may store the one with the maximum similarity.

Based on candidate mapping, the assistant system 140 may learn a language model on the user typed keystrokes. The assistant system 140 may further use the learned model to generate new candidates. As the more a user uses the smart reply feature, the better it gets. This may be because the assistant system 140 may keep storing and update the model on the device.

### Optimizing Entity Resolution Using Query Expansion

In particular embodiments, the assistant system 140 may improve entity resolution based on query expansion. One problem with current solutions of public domain entity-resolution (ER) systems may be that they may only handle queries that contain exact matches, word-level partial matches, or a few rule-based matching cases. Because of latency issues (possibly matching against billions of entities), entity resolution may need exact matches, or it may fail. In reality, however, entity mentions in requests to smart assistants often contain noises, errors or ambiguities. Errors in transcription of voice inputs by ASR may then cause a cascading failure downstream in the NLU module, causing the query to be unresolvable by the assistant. As an example, let's say a user is querying for a VR game “Gorilla Tag”. If ASR transcribed the query as “Gorilla Tag” (exact match) or “Gorilla” (word-level partial match), the system may be able to resolve the query. But if the ASR has an error and transcribes the query as “Gorilla Mad” or “Monkey Tag”, these queries may not be resolvable. These variations in entity mentions may come from user errors, ambiguities, or ASR errors. To address the aforementioned problem, a solution developed in the embodiments disclosed herein may be an entity-resolution system that uses a trained RoBERTa encoder that leverages sub-word level resemblances, semantic similarities, and ASR error patterns in entity resolution. The entity-resolution system may comprise a data augmentation pipeline that generates training data, a training module that fine-tunes a RoBERTa encoder, and a data pipeline that extracts entity pairs. Using the trained encoder, the embodiments disclosed herein may then develop a data pipeline that generates a list of entity pairs for lookup. When a query comes in, if the entity mention exists in the list of entity pairs, both the original mention and its resolved entity name may be used in entity resolution. The entity-resolution system may not need any human-annotated data as the query expansion can do this automatically. Although this disclosure describes improving particular entity resolution by particular systems in a particular manner, this disclosure contemplates improving any suitable entity resolution by any suitable system in any suitable manner.

Entity Resolution (ER) may play a critical role in voice-based dialog systems. It may be responsible for identifying and disambiguating entities, such as names of people, places, and apps, mentioned in a user's utterance. A significant challenge in building an ER module may be the requirement to handle noisy inputs from users and upstream components, such as Automatic Speech Recognition (ASR), while maintaining its scalability for processing a large quantity of entities in real-time. The embodiments disclosed herein introduce a neural query expansion system to improve the robustness of ER without compromising inference speed. Our system may employ a fine-tuned RoBERTa model to embed entity mentions and entity names into a common vector space. It may capture semantic similarities and may be robust to ASR noise that previous token-based matching solutions cannot handle. To meet latency requirements, query-entity pairs may be periodically computed and extracted offline and then integrated into the knowledge graph (KG) for runtime query expansion. Our experimental results demonstrate that the proposed approach significantly outperforms previous solutions in both offline and online settings.

Introduction

In a typical voice-based dialog system, voice commands may undergo transcription through an Automatic Speech Recognition (ASR) component. The Natural Language Understanding (NLU) component may then process the transcribed commands to extract structured information, such as intention and mentioned entities. Next, an Entity Resolution (ER) module may disambiguate these entities and connects them to an external knowledge base. The effectiveness of ER may substantially influence the performance of downstream components, such as Dialog Management (DM) and Natural Language Generation (NLG), ultimately exert a significant influence on the overall quality of the system.

Building modern on-device ER system in industry may be challenging for reasons centered around latency. On the one hand, large-scale knowledge graphs may be required to achieve high search quality bar. On the other hand, the system may have to be on edge devices to protect user privacy, and it may have to meet high latency requirements due to on-device resource constraints. Common approaches such as fuzzy match may be not viable due to sub-optimal latency. Therefore, token-based exact or partial matching methods may be often used as a pragmatic solution for ER. Although fast and lightweight, these methods may be not effective in resolving noisy or ambiguous entity mentions due to their heavy reliance on string matching. As an example, consider the entity “Gorilla Tag” (app name) in our knowledge graph. A token-based system may recognize its exact match and word-level partial matches (e.g. “Gorilla”). However, it may fall short of capturing semantic and phonetic similarities, hence may be unable to handle queries that contains errors or synonyms, such as “Granola Tab” or “Monkey Tag” (which contains a user error).

To optimize online inference latency, we build an entity pair extraction pipeline that performs the vector search and reranking offline on previously failed tasks on device. This may generate a list of query-entity pairs that are later injected into the knowledge graph. During online inference, an entity mention may be compared to this pre-populated list using exact token match. If the given entity mention is present in the list, the mention may be resolved. With this approach, the majority of the computationally demanding tasks may be executed offline. Only a streamlined lookup list may be needed for online use. This system may be refreshed periodically incorporating latest live traffic data to stay accurate. We have also considered apply query-entity pairs in runtime query expansion, however, expanding the query in runtime may increase the load on data transfer as well as latency.

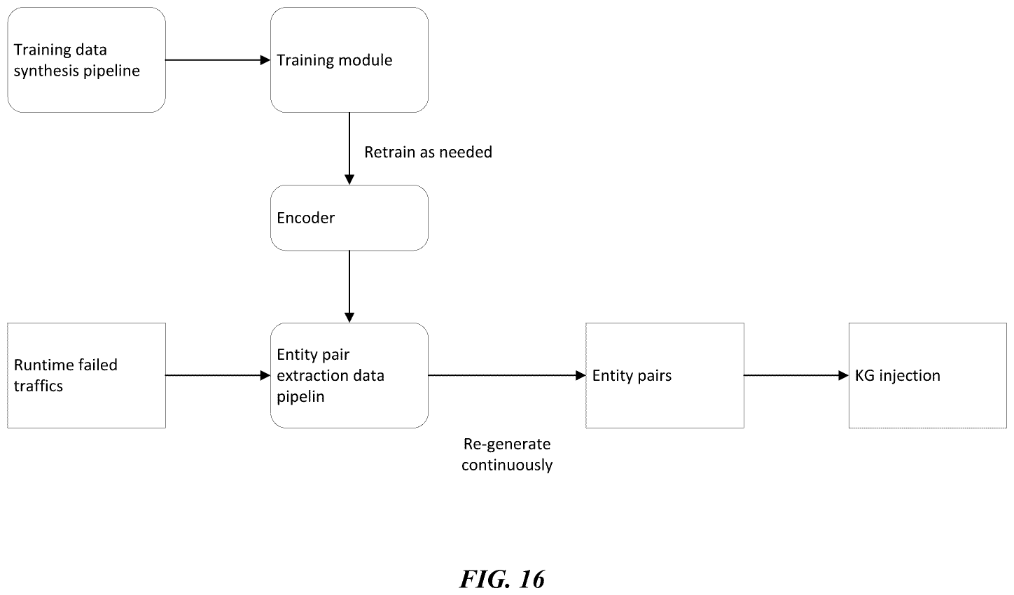

The embodiments disclosed herein introduce a novel query expansion system that may significantly improve ER accuracy over conventional methods while satisfying strict latency requirements on edge devices. FIG. 16 illustrates an example overview of the query expansion system. The system may consist of three main components: 1) A training data generation pipeline that automatically creates synthetic query-entity pairs by augmenting entity names. 2) A RoBERTa based encoder model that ranks and selects the best entity candidate based on vector similarities. 3) An offline entity pair extraction pipeline that runs vector search, extracts entity pairs, and inject them to KG.

The assistant system 140 may first use a RoBERTa-based (Liu et al., 2019) encoder model to embed both the entity mention (query) and entity names, then rank and select the best entity candidate based on distance in vector space. In this way, the matching may be robust to noise, as the fine-tuned encoder model may leverage semantic or phonetic similarities captured by embeddings. The training data of the encoder model may be generated automatically: synthetic entity mentions may be created by augmenting the entity names simulating the error patterns from live traffic, thereby removing the need for manual labeling.

Our main contributions may be as follows. First, we disclose an on-device novel query expansion system that may handle noisy and ambiguous user queries based on RoBERTa model. It may perform expensive vector search offline, therefore meeting the strict resource constraint on edge devices. Second, we disclose a novel synthetic training data generation strategy that may simulate the error patterns observed in live traffic. The data may be used to finetune the model and may be crucial for improving the quality of query-entity matching. Last but not least, we perform large-scale online experiments that demonstrate the effectiveness of our system.

Related Work

Neural networks have been used as encoder models for entity resolution tasks such as Neural Entity Linking (NEL) (Shang et al., 2021) and Entity Disambiguation (ED). Early works utilized fully-connected neural networks or Long Short-Term Memory networks to encode mentions and entity names (Kolitsas et al., 2018; Gillick et al., 2019). More recently, deep pre-trained models such as BERT (Devlin et al., 2018) and its fine-tuned variants have been heavily adopted for Entity Linking and Entity Resolution (Wu et al., 2019; Li et al., 2021). This line of work typically involves embedding both the entity mentions and the entity names into the same dense vector space, sometimes with a two-tower architecture (Gillick et al., 2019), and then producing similarity scores based on dot-product or other similarity measures.

Vector Search or Nearest Neighbor Search are commonly used to retrieve the best candidates selected by an encoder model. However, these methods have limited scalability, thus not ideal for applications with high latency requirements. Further research is required to avoid exhaustive search. A recent study that is closest to our work in this regard is (Li et al., 2021), where the authors employ a siamese structure with an improved alignment network to avoid exhaustive computation of tuple pairs. In contrast, we move the computationally expensive entity pairs extraction offline and only use the generated entity pairs for query expansion.

While the approaches proposed by (Wang et al., 2020) and (Wang et al., 2021) have demonstrated promising results in improving entity retrieval performance, they are focused on using ASR outputs to correct input query errors. In contrast, our work proposes a novel query expansion system that leverages a fined tuned encoder model to improve entity retrieval accuracy by expanding the set of candidate entities that can be retrieved for a given query.

The scarcity of labeled data is a prevalent issue, especially in industrial NLP applications where labeling heavily relies on manual annotation. There are two common solutions to this problem. One solution is to transfer the model from high-resource domains to low-resource domains (Kasai et al., 2019); another solution is to use data augmentation to generate synthetic entity mentions from real entity names. Compared to transfer learning, data augmentation is less costly and offers better control over training data distribution. For this reason, we use the data augmentation approach in our system.

Methodology

The task of our ER system may be as follows. Given an entity mention Q from the user, the goal may be to resolve the corresponding entity name among the entity candidates {Ci}ᵢ₌₁^{m}. The entity candidates may be extracted from a knowledge graph and their number may vary from tens to hundreds of thousands depending on the application setting.

We may train a deep encoder model to embed Q and {Ci}ᵢ₌₁^{m} in a vector space, and use their similarity scores to rank and select the candidates. In light of the latency constraint, the embedding and scoring may be conducted offline. Using the similarity scores, we may extract entity pairs with a two-stage filtering process. The extracted entity pairs may be then injected into the knowledge graph for query expansion.

One obstacle we face during the encoder model's training may be the scarcity of labeled training data. To tackle this issue, we may employ data generation techniques to create synthetic entity mentions that resemble the patterns in real user queries.

To sum up, our system may be made up of the following three modules: (1) A data synthesis pipeline that generates training data; (2) A training module that fine-tunes a RoBERTa encoder; (3) An offline data pipeline that extracts entity pairs.

We may use the RoBERTa model (Liu et al., 2019) to encode mentions and entities. RoBERTa is a pre-trained deep contextualized language model based on BERT (Devlin et al., 2018). By taking a string as input and returning a vector of length 768 as output, it may embed entity mentions and entity names into the vector space R⁷⁶⁸, in which the similarity of entity mention and the entity candidates may be measured by cosine similarity of their corresponding embeddings.

The RoBERTa model may be pre-trained on massive corpora. It may have already learned an inner representation of generic English text and may be powerful in capturing semantic meanings. Our experiments confirmed that pre-trained RoBERTa without fine-tuning is able to improve ER quality to some extent. However, the pre-trained model may be unable to recognize nuanced patterns in some specific domain ER, especially ASR (Automated Speech Recognition) noise. Thus, we may need to fine-tune the model over specific domain ER datasets.

The objective function may be defined as follows. Let Q be an entity mention. Let C₁, C₂, . . . , Cₙ be its entity candidates, where C₁ is the true target (positive candidate) and C₂, . . . , Cₙ are negative candidates. Let E_{Q}, E_{C}_{₁} denote the embedded vectors for Q and Cᵢ, respectively. Let ˜(E_{Q}, E_{C}_{ᵢ}):= [symbol] E, E_{C}_{ᵢ} [symbol] be the dot-product similarity of the embeddings of query Q and candidate Ci. The objective function may be the following cross entropy loss:

$$L ( {E}_{Q} , {E}_{{C}_{1}} , {E}_{{C}_{2}} , … , {E}_{{C}_{n}} ) = - log \frac{{e}^{\sim ( {E}_{Q} , {E}_{{C}_{1}} )}}{{e}^{\sim ( {E}_{Q} , {E}_{{C}_{1}} )} + … + {e}^{\sim ( {E}_{Q} , {E}_{{C}_{n}} )}} \qquad ( 1 )$$

Note that the similarity score ˜(E_{Q},E_{C}_{ᵢ}) may be dot-product similarity instead of cosine similarity. We experimented with both scores and found that the former results in faster training. The two scores may only differ by a normalization.

The main bottleneck in training may be that embedding a string with RoBERTa could take a long time. To reduce the computational burden, we may use a negative sampling strategy similar to Karpukhin et al. (Karpukhin et al., 2020). It may reuse positive candidates from other samples in the same batch as the negatives of the current sample. This strategy may help reuse embeddings, reduce training time, and save computational cost.

The training data for fine-tuning the RoBERTa model may be generated by data augmentation. Synthetic entity mentions may be generated solely from the entity names in the knowledge graph. In this way, the pipeline may be not constrained by the lack of human annotations, and may be free of data imbalance issues.

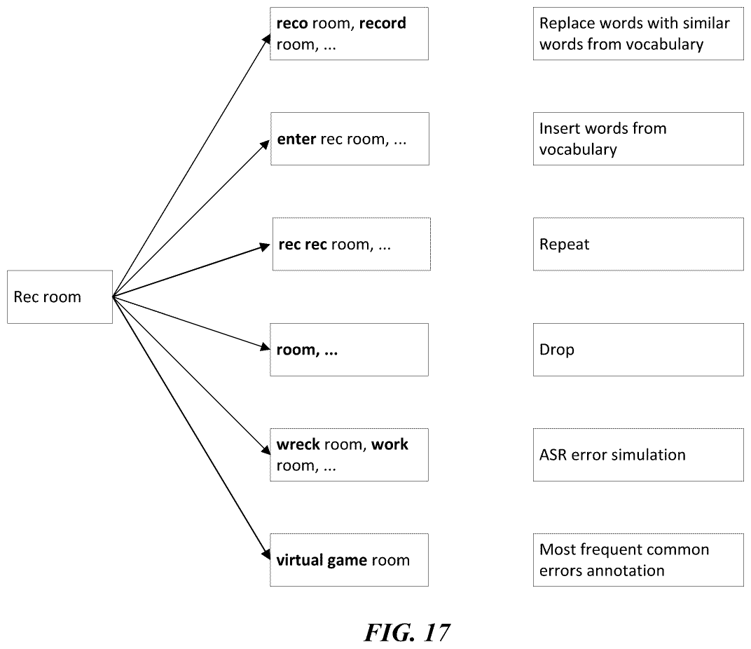

The strategy for data augmentation is inspired by the following observation: When comparing a user entity mention with its true entity name, the noise and errors in entity mentions often follow common patterns. Most of the time, it may be either the insertion of an extra word, the missing of a word, or a replacement of a word by another word that looks or sounds similar. We therefore design the data augmentation based on these common patterns surfaced from live traffic. FIG. 17 illustrates example types of synthetic mentions. For each entity name in the knowledge graph, we may generate synthetic mentions of the following six types: (1) Replacing a word with a similar word from the user mentioned vocabulary, where the similarity is determined by a pre-trained RoBERTa encoder (e.g., “rec room” to “record room”); (2) Randomly inserting common words from the query vocabulary (e.g., “rec room” to “enter rec room”); (3) Randomly repeating words (e.g., “rec room” to “rec rec room”); (4) Randomly dropping words (e.g., “rec room” to “room”); (5) Replacing words with common ASR confusing words (e.g., “rec room” to “wreck room”). This helps to train the model to learn phonetic similarities. (6) Most frequent common errors provided by annotators (e.g., “rec room” to “virtual game room”). Note that this dataset is only used in evaluation and testing.

Each generated synthetic mention and its original entity name may be then used as the mention Q and the true target C₁. The synthetic dataset we are using has been divided into two separate sets: the training set and the validation set. While the synthetic dataset may provide a good foundation for testing our model, we may also make use of a smaller, manually annotated test set comprised of historical real traffic data. This manually annotated dataset may be particularly useful because it may better represent real-world use cases and allow us to ensure the performance of our synthetic dataset more accurately. By combining both synthetic and real data, we may ensure that our model is robust and ready for deployment in real-world scenarios.

How we may use the fine-tuned encoder for ER is described as follows. In the offline stage, we may extract a list of entity pairs in the form of (entity mention, resolved entity name). The list may be injected into KG. In the online stage, when a query comes in, if the user mention exists in KG, we may look up its resolved entity name and use it for query expansion. That is, we may use both the original mention and the resolved entity name for ER.

We remark that a different way to use the fine-tuned encoder may be to encode each entity mention during runtime, and perform a vector search to select the best candidate. This may be however impractical for two reasons: first, vector search may cause significant latency when the number of candidates is large; second, the forward inference of a deep encoder model may be slow and increase latency. In contrast, our framework may offload most of the heavy computation to the offline stage and provides a solution to minimize latency.

The process of entity pair extraction may be as follows. We may gather the previously failed entity mentions, i.e., the entity mentions that the pre-existing ER system could not resolve. Using a pairing method, we may try to pair those mentions to entity names. We may then filter through the results and only retain the pairs with high confidence. See Algorithm 1 for detailed pseudo-code for the extraction process.

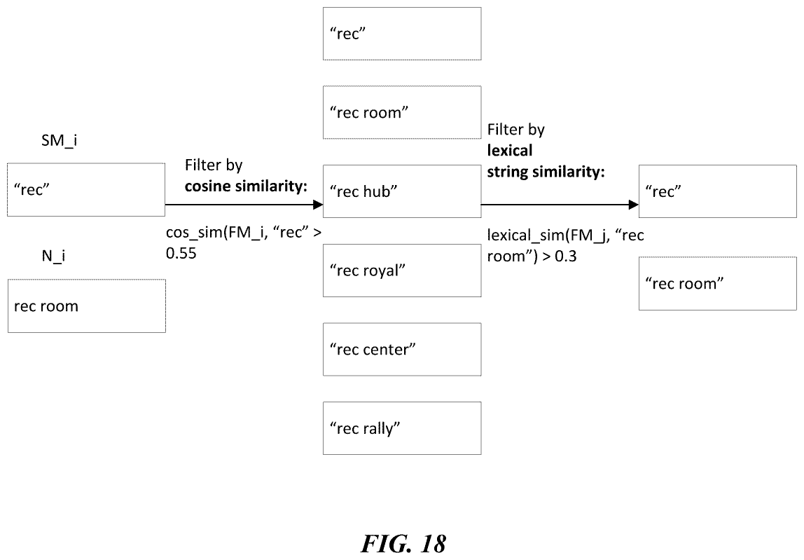

We may now expand on the pairing method part. We experimented with several different pairing methods and decided on the method that prioritizes low regression rate. Algorithm 2 gives a detailed description of the pairing method. We may use a two-stage filtering strategy: filtering by absolute thresholds on cosine similarity, then on lexical string similarity. FIG. 18 illustrates an example two-stage filtering strategy.

Algorithm 1 Entity pair extraction

| | Query data: |
|---|---|
| 1: | S ← task entity pairs from real traffic data |
| 2: | S1 ← failed task entity pairs in S |
| 3: | S2 ← successful task entity pairs in S |
| 4: | FM ← failed entity mentions set in S₁ |
| 5: | N ← resolved entity names in S₂ |
| 6: | SM ← resolved entity mentions in S₂ |
| | Load model and embed: |
| 7: | Load the RoBERTa model |
| 8: | Use the model to embed the sets FM, N, SM |
| | Pairing: |
| 9: | Use a pairing method (Algorithm 2) to pair mentions in FM to |
| | entities in N, obtaining a pairing dictionary D |
| 10: | Remove duplicates in D |
| 11: | Generate entity pairs from D |
| | (Optional) Filtering: |
| 12: | For each mention in the list of entity pairs, compute its ratio of |
| | historical failed/successful cases |
| 13: | If the ratio is below threshold, remove this mention from the list |

Algorithm 2 Pairing

| | |
|---|---|
| 1: | For each resolved mention SMi, filter the failed mentions in FM by |
| | cosine similarity: cos_sim(FM3, SMi) > emb_sim_threshold |
| 2: | Filter the remaining failed mentions by lexical string similarity: |
| | lexical_sim(FM3, Ni) > str_sim_threshold |

Experiments and Results

We implemented the RoBERTa model in PyTorch (Paszke et al., 2019). The model was initialized with pre-trained RoBERTa base (Liu et al., 2019). We use the Adam optimizer (Kingma and Ba, 2014) with weight decay (Loshchilov and Hutter, 2018). The learning rate is set to 10-5 with β1=0.9, β2=0.999. The batch size is set to 64.

First, we test the fine-tuned encoder on a small manually annotated dataset of 328 most popular entity names and about 1000 corresponding entity mentions. For each entity mention, we rank all entity name candidates according to their cosine similarity with the entity mention in the embedded space. We then calculate the recalls at 1, 3, and 6, as well as the mean reciprocal rank (MRR) metric. The process is conducted both for the pre-trained RoBERTa model (without fine-tuning) and the fine-tuned model.

Table 11 shows the relative improvement of the fine-tuned model over the pre-trained model. The fine-tuned model improves all four metrics by 45% or more. This may suggest that our fine-tuning strategy, combined with synthetic training data created by augmentation is significantly more effective in improving our ER system than the plain adoption of the pre-trained model.

TABLE 11
Evaluation of fine-tuned encoder model versus pre-trained

| Metric | Relative Improvement (%) |
|---|---|
| Recall@1 | 50.20 |
| Recall@3 | 45.94 |
| Recall@6 | 45.15 |
| MRR | 45.69 |

Next, we test the ER system which comprises of both the trained encoder and the entity pair extraction pipeline. The system is tested offline with historical real traffic data. Entity pairs are extracted according to Algorithm 1 using the fine-tuned encoder. After the entity pairs are extracted, we compute the ratio of previously failed queries that are now resolvable by the new system (“fixed ratio”), and the ratio of previously successfully resolved queries that might be wrongly resolved by the new system (“regression ratio”). Higher fixed ratio and lower regression ratio is considered better.

Table 12 shows the result of offline testing without the optional filtering step in Algorithm 1, while Table 13 shows the result with the optional filtering step. It is observed that the fine-tuned encoder model achieves significant improvement both over the baseline and the pre-trained model without fine-tuning. By adding an optional filtering step, regression ratio can be further reduced at the price of a lower fixed ratio. Whether to include the filtering step may depend on the specific needs and constraints of the application setting.

TABLE 12
Offline testing of fine-tuned model versus pre-trained (no filtering)

| Method | Metric | Result (%) |
|---|---|---|
| Pre-trained | Fixed ratio | 33.12 |
| (no filtering) | Regression ratio | 1.38 |
| Fine-tuned | Fixed ratio | 37.48 |
| (no filtering) | Regression ratio | 0.65 |

TABLE 13
Offline testing of fine-tuned model
versus pre-trained (with filtering)

| Method | Metric | Result (%) |
|---|---|---|
| Pre-trained | Fixed ratio | 19.06 |
| | Regression ratio | 0.11 |
| Fine-tuned | Fixed ratio | 26.59 |
| | Regression ratio | 0.52 |

Finally, we evaluate the ER system with two large-scale AB experiments on live traffic. The experiment results are mainly for two top domains in voice assistant scenarios. We measure the results in three metrics: task success rate, failed task count, and end-to-end latency.

The first AB test was conducted with the following setting: the test group uses the pre-trained query expansion solution in ER; the control group shows default prod behavior without query expansion. The second AB test was conducted with the following setting: the test group uses the fine-tuned query expansion solution in ER; the control group uses the pre-trained query expansion solution in ER.

TABLE 14
First online AB testing: pre-trained
model versus no query expansion ER

| Task | Metric | Result |
|---|---|---|
| All Device | Task success rate | +1.23% |
| Target tasks | Task success rate | +2.41% |
| All Device | Failed task count | −10.06% |
| Target tasks | Failed task count | −13.51% |
| E2E | Latency | +0.4 ms |

TABLE 15
Second online AB testing: fine-tuned
model versus pre-trained model

| Task | Metric | Result |
|---|---|---|
| All Device | Task success rate | +1.19% |
| Target tasks | Task success rate | +2.33% |
| All Device | Failed task count | −10.3% |
| Target tasks | Failed task count | −13.9% |
| E2E | Latency | +0.07 ms |

Tables 14 and 15 show the relative improvement of the pre-trained model versus no query expansion ER and fine-tuned model versus pre-trained model. The improvement may be seen from two aspects: (1) fewer instances of failed tasks, which means we were able to resolve entities more frequently instead of sending the failed resolved strings as a store search; (2) an increase in user confirmation that task is successfully resolved. The results may indicate that the new treatment has a significant positive impact on the task success rate without much sacrifice in end-to-end latency.

Table 16 gives some illustrative examples comparing the ER results with and without using the proposed query expansion. It may be observed that our approach can effectively resolve noisy entity mentions by capturing semantic or phonetic similarities that the default matching-based ER system cannot handle.

TABLE 16
Examples of entity mentions that the new ER system (with
the proposed query expansion) can resolve while the
former token-matching based ER fail to resolve.

| Entity Mentions | Groundtruth | Former ER | New ER |
|---|---|---|---|
| “super fly vr” | superfly | [ ] | [superfly] |
| “girl attack” | gorilla tag | [ ] | [gorilla tag, vr |
| | | | mummy girl] |
| “best saber” | beat saber | [ ] | [beat saber, beat |
| | | | saber - demo] |
| “president evil four” | resident evil 4 | [ ] | [resident evil 4] |

Conclusion

The embodiments disclosed herein presented an entity resolution (ER) system that may leverage a deep encoder model based on fine-tuned RoBERTa while meeting the strict on-device latency requirements for production setting. By fine-tuning a RoBERTa encoder on a synthetic dataset created through data augmentation, the system may effectively handle semantic similarities and ASR noise, which may be often missed by traditional matching-based solutions. Moreover, the embodiments disclosed herein disclosed a novel entity pair extraction pipeline that may offload computationally heavy vector search process offline and only perform light-weight token-based matching online, so that the system may be optimized for fast ER on edge devices. Through offline and online experiments, we show that the proposed solution greatly outperforms the default prod model without query expansion with negligible extra latency.

### REFERENCES

The following list of references correspond to the citations above:
Jacob Devlin, Ming-Wei Chang, Kenton Lee, and Kristina Toutanova. 2018. Bert: Pre-training of deep bidirectional transformers for language understanding. arXiv preprint arXiv:1810.04805.
Daniel Gillick, Sayali Kulkarni, Larry Lansing, Alessandro Presta, Jason Baldridge, Eugene Ie, and Diego Garcia-Olano. 2019. Learning dense representations for entity retrieval. arXiv preprint arXiv:1909.10506.
Vladimir Karpukhin, Barlas Og ̆uz, Sewon Min, Patrick Lewis, Ledell Wu, Sergey Edunov, Danqi Chen, and Wen-tau Yih. 2020. Dense passage retrieval for open-domain question answering. arXiv preprint arXiv:2004.04906.
Jungo Kasai, Kun Qian, Sairam Gurajada, Yunyao Li, and Lucian Popa. 2019. Low-resource deep entity resolution with transfer and active learning. arXiv preprint arXiv:1906.08042.
Diederik P Kingma and Jimmy Ba. 2014. Adam: A method for stochastic optimization. arXiv preprint arXiv:1412.6980.
Nikolaos Kolitsas, Octavian-Eugen Ganea, and Thomas Hofmann. 2018. End-to-end neural entity linking. arXiv preprint arXiv:1808.07699.
Bing Li, Yukai Miao, Yaoshu Wang, Yifang Sun, and Wei Wang. 2021. Improving the efficiency and effectiveness for bert-based entity resolution. In Proceedings of the AAAI Conference on Artificial Intelligence, volume 35, pages 13226-13233.
Yinhan Liu, Myle Ott, Naman Goyal, Jingfei Du, Man-dar Joshi, Danqi Chen, Omer Levy, Mike Lewis, Luke Zettlemoyer, and Veselin Stoyanov. 2019. Roberta: A robustly optimized bert pretraining approach. arXiv preprint arXiv:1907.11692.
Ilya Loshchilov and Frank Hutter. 2018. Fixing weight decay regularization in adam.
Adam Paszke, Sam Gross, Francisco Massa, Adam Lerer, James Bradbury, Gregory Chanan, Trevor Killeen, Zeming Lin, Natalia Gimelshein, Luca Antiga, et al. 2019. Pytorch: An imperative style, high-performance deep learning library. Advances in neural information processing systems, 32.
Mingyue Shang, Tong Wang, Mihail Eric, Jiangning Chen, Jiyang Wang, Matthew Welch, Tiantong Deng, Akshay Grewal, Han Wang, Yue Liu, et al. 2021. Entity resolution in open-domain conversations. In Proceedings of the 2021 Conference of the North American Chapter of the Association for Computational Linguistics: Human Language Technologies: Industry Papers, pages 26-33.
Haoyu Wang, John Chen, Majid Laali, Jeff King, Kevin Durda, William M. Campbell, and Yang Liu. 2021. Leveraging asr n-best in deep entity retrieval. In Interspeech 2021.
Haoyu Wang, Shuyan Dong, Yue Liu, James Logan, Ashish Agrawal, and Yang Liu. 2020. Asr error correction with augmented transformer for entity retrieval. In Interspeech 2020.
Ledell Wu, Fabio Petroni, Martin Josifoski, Sebastian Riedel, and Luke Zettlemoyer. 2019. Scalable zero-shot entity linking with dense entity retrieval. arXiv preprint arXiv:1911.03814.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a client system 130, an assistant system 140, a third-party system 170, a social-networking application, an assistant application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or assistant system 140 or shared with other systems (e.g., a third-party system 170). Although this disclosure describes using particular privacy settings in a particular manner, this disclosure contemplates using any suitable privacy settings in any suitable manner.

In particular embodiments, the social-networking system 160 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a client system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or assistant system 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or assistant system 140 may access such information in order to provide a particular function or service to the first user, without the social-networking system 160 or assistant system 140 having access to that information for any other purposes. Before accessing, storing, or using such objects or information, the social-networking system 160 or assistant system 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or assistant system 140.

In particular embodiments, a user may specify whether particular types of objects or information associated with the first user may be accessed, stored, or used by the social-networking system 160 or assistant system 140. As an example and not by way of limitation, the first user may specify that images sent by the first user through the social-networking system 160 or assistant system 140 may not be stored by the social-networking system 160 or assistant system 140. As another example and not by way of limitation, a first user may specify that messages sent from the first user to a particular second user may not be stored by the social-networking system 160 or assistant system 140. As yet another example and not by way of limitation, a first user may specify that all objects sent via a particular application may be saved by the social-networking system 160 or assistant system 140.

In particular embodiments, privacy settings may allow a first user to specify whether particular objects or information associated with the first user may be accessed from particular client systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or assistant system 140 may provide default privacy settings with respect to each device, system, or application, and/or the first user may be prompted to specify a particular privacy setting for each context. As an example and not by way of limitation, the first user may utilize a location-services feature of the social-networking system 160 or assistant system 140 to provide recommendations for restaurants or other places in proximity to the user. The first user's default privacy settings may specify that the social-networking system 160 or assistant system 140 may use location information provided from a client system 130 of the first user to provide the location-based services, but that the social-networking system 160 or assistant system 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or assistant system 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or assistant system 140. The user's privacy settings may specify that such information may be used only for particular processes, such as authentication, and further specify that such information may not be shared with any third-party system 170 or used for other processes or applications associated with the social-networking system 160 or assistant system 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Systems and Methods

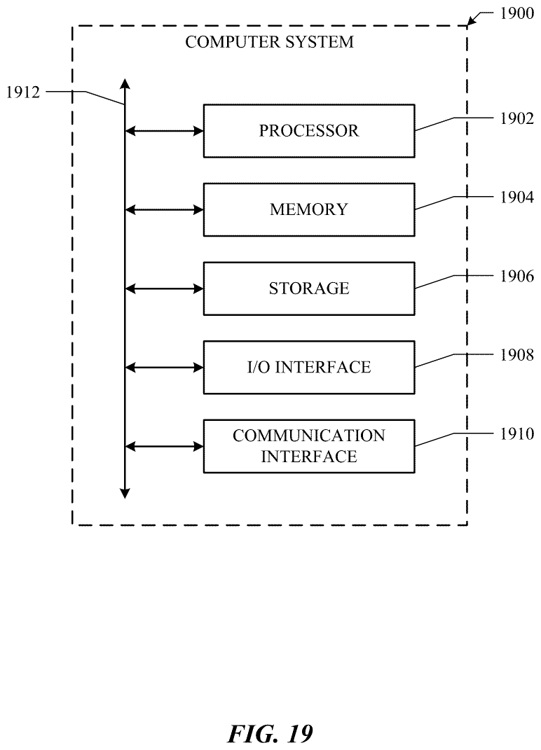

FIG. 19 illustrates an example computer system 1900. In particular embodiments, one or more computer systems 1900 perform one or more steps of one or more methods described or illustrated herein. In particular embodiments, one or more computer systems 1900 provide functionality described or illustrated herein. In particular embodiments, software running on one or more computer systems 1900 performs one or more steps of one or more methods described or illustrated herein or provides functionality described or illustrated herein. Particular embodiments include one or more portions of one or more computer systems 1900. Herein, reference to a computer system may encompass a computing device, and vice versa, where appropriate. Moreover, reference to a computer system may encompass one or more computer systems, where appropriate.

This disclosure contemplates any suitable number of computer systems 1900. This disclosure contemplates computer system 1900 taking any suitable physical form. As example and not by way of limitation, computer system 1900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1900 may include one or more computer systems 1900; be unitary or distributed; span multiple locations; span multiple machines; span multiple data centers; or reside in a cloud, which may include one or more cloud components in one or more networks. Where appropriate, one or more computer systems 1900 may perform without substantial spatial or temporal limitation one or more steps of one or more methods described or illustrated herein. As an example and not by way of limitation, one or more computer systems 1900 may perform in real time or in batch mode one or more steps of one or more methods described or illustrated herein. One or more computer systems 1900 may perform at different times or at different locations one or more steps of one or more methods described or illustrated herein, where appropriate.

In particular embodiments, computer system 1900 includes a processor 1902, memory 1904, storage 1906, an input/output (I/O) interface 1908, a communication interface 1910, and a bus 1912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1902 includes hardware for executing instructions, such as those making up a computer program. As an example and not by way of limitation, to execute instructions, processor 1902 may retrieve (or fetch) the instructions from an internal register, an internal cache, memory 1904, or storage 1906; decode and execute them; and then write one or more results to an internal register, an internal cache, memory 1904, or storage 1906. In particular embodiments, processor 1902 may include one or more internal caches for data, instructions, or addresses. This disclosure contemplates processor 1902 including any suitable number of any suitable internal caches, where appropriate. As an example and not by way of limitation, processor 1902 may include one or more instruction caches, one or more data caches, and one or more translation lookaside buffers (TLBs). Instructions in the instruction caches may be copies of instructions in memory 1904 or storage 1906, and the instruction caches may speed up retrieval of those instructions by processor 1902. Data in the data caches may be copies of data in memory 1904 or storage 1906 for instructions executing at processor 1902 to operate on; the results of previous instructions executed at processor 1902 for access by subsequent instructions executing at processor 1902 or for writing to memory 1904 or storage 1906; or other suitable data. The data caches may speed up read or write operations by processor 1902. The TLBs may speed up virtual-address translation for processor 1902. In particular embodiments, processor 1902 may include one or more internal registers for data, instructions, or addresses. This disclosure contemplates processor 1902 including any suitable number of any suitable internal registers, where appropriate. Where appropriate, processor 1902 may include one or more arithmetic logic units (ALUs); be a multi-core processor; or include one or more processors 1902. Although this disclosure describes and illustrates a particular processor, this disclosure contemplates any suitable processor.

In particular embodiments, memory 1904 includes main memory for storing instructions for processor 1902 to execute or data for processor 1902 to operate on. As an example and not by way of limitation, computer system 1900 may load instructions from storage 1906 or another source (such as, for example, another computer system 1900) to memory 1904. Processor 1902 may then load the instructions from memory 1904 to an internal register or internal cache. To execute the instructions, processor 1902 may retrieve the instructions from the internal register or internal cache and decode them. During or after execution of the instructions, processor 1902 may write one or more results (which may be intermediate or final results) to the internal register or internal cache. Processor 1902 may then write one or more of those results to memory 1904. In particular embodiments, processor 1902 executes only instructions in one or more internal registers or internal caches or in memory 1904 (as opposed to storage 1906 or elsewhere) and operates only on data in one or more internal registers or internal caches or in memory 1904 (as opposed to storage 1906 or elsewhere). One or more memory buses (which may each include an address bus and a data bus) may couple processor 1902 to memory 1904. Bus 1912 may include one or more memory buses, as described below. In particular embodiments, one or more memory management units (MMUs) reside between processor 1902 and memory 1904 and facilitate accesses to memory 1904 requested by processor 1902. In particular embodiments, memory 1904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1904 may include one or more memories 1904, where appropriate. Although this disclosure describes and illustrates particular memory, this disclosure contemplates any suitable memory.

In particular embodiments, storage 1906 includes mass storage for data or instructions. As an example and not by way of limitation, storage 1906 may include a hard disk drive (HDD), a floppy disk drive, flash memory, an optical disc, a magneto-optical disc, magnetic tape, or a Universal Serial Bus (USB) drive or a combination of two or more of these. Storage 1906 may include removable or non-removable (or fixed) media, where appropriate. Storage 1906 may be internal or external to computer system 1900, where appropriate. In particular embodiments, storage 1906 is non-volatile, solid-state memory. In particular embodiments, storage 1906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1906 taking any suitable physical form. Storage 1906 may include one or more storage control units facilitating communication between processor 1902 and storage 1906, where appropriate. Where appropriate, storage 1906 may include one or more storages 1906. Although this disclosure describes and illustrates particular storage, this disclosure contemplates any suitable storage.

In particular embodiments, I/O interface 1908 includes hardware, software, or both, providing one or more interfaces for communication between computer system 1900 and one or more I/O devices. Computer system 1900 may include one or more of these I/O devices, where appropriate. One or more of these I/O devices may enable communication between a person and computer system 1900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1908 for them. Where appropriate, I/O interface 1908 may include one or more device or software drivers enabling processor 1902 to drive one or more of these I/O devices. I/O interface 1908 may include one or more I/O interfaces 1908, where appropriate. Although this disclosure describes and illustrates a particular I/O interface, this disclosure contemplates any suitable I/O interface.

In particular embodiments, communication interface 1910 includes hardware, software, or both providing one or more interfaces for communication (such as, for example, packet-based communication) between computer system 1900 and one or more other computer systems 1900 or one or more networks. As an example and not by way of limitation, communication interface 1910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1910 for it. As an example and not by way of limitation, computer system 1900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1900 may include any suitable communication interface 1910 for any of these networks, where appropriate. Communication interface 1910 may include one or more communication interfaces 1910, where appropriate. Although this disclosure describes and illustrates a particular communication interface, this disclosure contemplates any suitable communication interface.

In particular embodiments, bus 1912 includes hardware, software, or both coupling components of computer system 1900 to each other. As an example and not by way of limitation, bus 1912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1912 may include one or more buses 1912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
receiving, from a first client system associated with a user, a user input;
executing a task corresponding to the user input;
generating a user interface for delivering executing results of the task based on a meta design system, wherein the meta design system is based on at least an attention system and an assistant layer; and
sending, to the first client system and one or more second client systems associated with the user, instructions for presenting the user interface.

2. A method comprising, by a client system:
capturing, by one or more cameras associated with the client system, visual signals associated with a field of view of a user;
identifying one or more food items based on the visual signals;
determining calorie and nutrient information associated with the one or more food items;
selecting one or more of the food items based on (a) the calorie and nutrient information and (b) knowledge about the user; and
presenting, at the client system, recommendations for the selected food items.

3. A method comprising, by one or more computing systems:
receiving, from a client system associated with a first user, a first user utterance at a first turn associated with a first dialog session in a first domain;
determining a first dialog state associated with the first user utterance based on one or more slots associated with first user utterance;
transforming, based on the first dialog state, the one or more slots in the first domain to one or more questions, respectively;
retrieving, from a database based on the one or more questions, one or more example dialogs; and
generating, based on the one or more questions and the one or more example dialogs, a dialog-state-tracking model.

4. A method comprising, by a client system:
receiving, at the client system, an incoming message for a first user;
determining, based on the incoming message by one or more machine-learning models, one or more candidate responses for the first user, wherein the one or more machine-learning models are trained based on a plurality of prior user-typed keystrokes in response to a plurality of prior incoming messages; and
presenting, at the client system, the one or more candidate responses.

5. A method comprising, by one or more computing systems:
receiving, from a client system associated with a user, a user utterance comprising an entity mention;
accessing a knowledge graph comprising a plurality of entity pairs, wherein at least one of the entity pairs comprises a resolved entity name and a prior entity mention failed to be resolved, and wherein the at least one entity pair is generated based on one or more of cosine similarity or lexical string similarity between the resolved entity name and the prior entity mention failed to be resolved;
resolving an entity name to the entity mention in the user utterance;
executing one or more tasks associated with the entity name resolved to the entity mention in the user utterance; and
sending, to the client system responsive to the user utterance, instructions for presenting a response generated based on execution results of one or more of the tasks.
